(19) United States
(12) Patent Application Publication
(10) Pub. No.: US 2024/0305829 A1
(43) Pub. Date: Sep. 12, 2024

(54) SYSTEMS AND METHODS FOR SIGNALING NEURAL NETWORK-BASED IN-LOOP FILTER PARAMETER INFORMATION IN VIDEO CODING

(71) Applicant: SHARP KABUSHIKI KAISHA, Sakai City (JP)

(72) Inventor: Sachin G. Deshpande, Vancouver, WA (US)

(21) Appl. No.: 18/664,284

(22) Filed: May 15, 2024

Related U.S. Application Data
(63) Continuation of application No. 17/697,613, filed on Mar. 17, 2022.
(60) Provisional application No. 63/167,543, filed on Mar. 29, 2021.
(60) Provisional application No. 63/167,550, filed on Mar. 29, 2021.
(60) Provisional application No. 63/166,209, filed on Mar. 25, 2021.
(60) Provisional application No. 63/165,092, filed on Mar. 23, 2021.

(51) Int. Cl. H04N 19/70; H04N 19/117; H04N 19/187; H04N 19/42; H04N 19/82

(52) U.S. Cl. CPC H04N 19/70; H04N 19/117; H04N 19/187; H04N 19/42; H04N 19/82

(57) ABSTRACT

A method of signaling neural network in-loop filter information for video data includes: signaling one or more syntax elements providing neural network in-loop filter information in an adaptation parameter set syntax structure.

### CROSS-REFERENCE TO RELATED APPLICATION

This application is a continuation of U.S. patent application Ser. No. 17/697,613, filed on Mar. 17, 2022, which claims priority from Provisional Application Nos. 63/166,209, 63/165,092, 63/167,550 and 63/167,543, the contents of which are hereby incorporated by reference into this application.

### TECHNICAL FIELD

This disclosure relates to video coding and more particularly to techniques for signaling neural network-based in-loop filter parameter information for coded video.

### BACKGROUND

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards define the format of a compliant bitstream encapsulating coded video data. A compliant bitstream is a data structure that may be received and decoded by a video decoding device to generate reconstructed video data. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265, December 2016, which is incorporated by reference, and referred to herein as ITU-T H.265. Extensions and improvements for ITU-T H.265 are currently being considered for the development of next generation video coding standards. For example, the ITU-T Video Coding Experts Group (VCEG) and ISO/IEC (Moving Picture Experts Group (MPEG) (collectively referred to as the Joint Video Exploration Team (JVET)) are working to standardized video coding technology with a compression capability that significantly exceeds that of the current HEVC standard. The Joint Exploration Model 7 (JEM 7), Algorithm Description of Joint Exploration Test Model 7 (JEM 7), ISO/IEC JTC1/SC29/WG11 Document: JVET-G1001, July 2017, Torino, IT, which is incorporated by reference herein, describes the coding features that were under coordinated test model study by the JVET as potentially enhancing video coding technology beyond the capabilities of ITU-T H.265. It should be noted that the coding features of JEM 7 are implemented in JEM reference software. As used herein, the term JEM may collectively refer to algorithms included in JEM 7 and implementations of JEM reference software. Further, in response to a “Joint Call for Proposals on Video Compression with Capabilities beyond HEVC,” jointly issued by VCEG and MPEG, multiple descriptions of video coding tools were proposed by various groups at the 10^{th} Meeting of ISO/IEC JTC1/SC29/WG11 16-20 Apr. 2018, San Diego, CA. From the multiple descriptions of video coding tools, a resulting initial draft text of a video coding specification is described in “Versatile Video Coding (Draft 1),” 10^{th} Meeting of ISO/IEC JTC1/SC29/WG11 16-20 Apr. 2018, San Diego, CA, document JVET-J1001-v2, which is incorporated by reference herein, and referred to as JVET-J1001. The current development of a next generation video coding standard by the VCEG and MPEG is referred to as the Versatile Video Coding (VVC) project. “Versatile Video Coding (Draft 10),” 20th Meeting of ISO/IEC JTC1/SC29/WG11 7-16 Oct. 2020, Teleconference, document JVET-T2001-v2, which is incorporated by reference herein, and referred to as JVET-T2001, represents the current iteration of the draft text of a video coding specification corresponding to the VVC project.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of pictures within a video sequence, a picture within a group of pictures, regions within a picture, sub-regions within regions, etc.). Intra prediction coding techniques (e.g., spatial prediction techniques within a picture) and inter prediction techniques (i.e., inter-picture techniques (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, and motion information). Residual data and syntax elements may be entropy coded. Entropy encoded residual data and syntax elements may be included in data structures forming a compliant bitstream.

### SUMMARY

In general, this disclosure describes various techniques for coding video data. In particular, this disclosure describes techniques for signaling neural network-based in-loop filter parameter information for coded video data. It should be noted that although techniques of this disclosure are described with respect to ITU-T H.264, ITU-T H.265, JEM, and JVET-T2001, the techniques of this disclosure are generally applicable to video coding. For example, the coding techniques described herein may be incorporated into video coding systems, (including video coding systems based on future video coding standards) including video block structures, intra prediction techniques, inter prediction techniques, transform techniques, filtering techniques, and/or entropy coding techniques other than those included in ITU-T H.265, JEM, and JVET-T2001. Thus, reference to ITU-T H.264, ITU-T H.265, JEM, and/or JVET-T2001 is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a method of signaling neural network in-loop filter information for video data comprises: signaling one or more syntax elements providing neural network in-loop filter information in an adaptation parameter set syntax structure.

In one example, a method of applying a neural network in-loop filter to reconstructed video comprises: receiving an adaptation parameter set syntax structure; parsing one or more syntax elements providing neural network in-loop filter information from the adaptation parameter set syntax structure; determining one or more neural network in-loop filter parameters based on the parsed syntax element; and applying a neural network in-loop filter based on the determined neural network in-loop filter parameters.

In one example, a device comprises one or more processors configured to: receive an adaptation parameter set syntax structure; parse one or more syntax elements providing neural network in-loop filter information from the adaptation parameter set syntax structure; determine one or more neural network in-loop filter parameters based on the parsed syntax element; and apply a neural network in-loop filter based on the determined neural network in-loop filter parameters.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may be configured to encode and decode video data according to one or more techniques of this disclosure.

FIG. 2 is a conceptual diagram illustrating coded video data and corresponding data structures according to one or more techniques of this disclosure.

FIG. 3 is a conceptual diagram illustrating a data structure encapsulating coded video data and corresponding metadata according to one or more techniques of this disclosure.

FIG. 4 is a conceptual drawing illustrating an example of components that may be included in an implementation of a system that may be configured to encode and decode video data according to one or more techniques of this disclosure.

FIG. 5 is a block diagram illustrating an example of a video encoder that may be configured to encode video data according to one or more techniques of this disclosure.

FIG. 6 is a block diagram illustrating an example of a video decoder that may be configured to decode video data according to one or more techniques of this disclosure.

### DETAILED DESCRIPTION

Video content includes video sequences comprised of a series of frames (or pictures). A series of frames may also be referred to as a group of pictures (GOP). Each video frame or picture may divided into one or more regions. Regions may be defined according to a base unit (e.g., a video block) and sets of rules defining a region. For example, a rule defining a region may be that a region must be an integer number of video blocks arranged in a rectangle. Further, video blocks in a region may be ordered according to a scan pattern (e.g., a raster scan). As used herein, the term video block may generally refer to an area of a picture or may more specifically refer to the largest array of sample values that may be predictively coded, sub-divisions thereof, and/or corresponding structures. Further, the term current video block may refer to an area of a picture being encoded or decoded. A video block may be defined as an array of sample values. It should be noted that in some cases pixel values may be described as including sample values for respective components of video data, which may also be referred to as color components, (e.g., luma (Y) and chroma (Cb and Cr) components or red, green, and blue components). It should be noted that in some cases, the terms pixel value and sample value are used interchangeably. Further, in some cases, a pixel or sample may be referred to as a pel. A video sampling format, which may also be referred to as a chroma format, may define the number of chroma samples included in a video block with respect to the number of luma samples included in a video block. For example, for the 4:2:0 sampling format, the sampling rate for the luma component is twice that of the chroma components for both the horizontal and vertical directions.

A video encoder may perform predictive encoding on video blocks and sub-divisions thereof. Video blocks and sub-divisions thereof may be referred to as nodes. ITU-T H.264 specifies a macroblock including 16×16 luma samples. That is, in ITU-T H.264, a picture is segmented into macroblocks. ITU-T H.265 specifies an analogous Coding Tree Unit (CTU) structure (which may be referred to as a largest coding unit (LCU)). In ITU-T H.265, pictures are segmented into CTUs. In ITU-T H.265, for a picture, a CTU size may be set as including 16×16, 32×32, or 64×64 luma samples. In ITU-T H.265, a CTU is composed of respective Coding Tree Blocks (CTB) for each component of video data (e.g., luma (Y) and chroma (Cb and Cr). It should be noted that video having one luma component and the two corresponding chroma components may be described as having two channels, i.e., a luma channel and a chroma channel. Further, in ITU-T H.265, a CTU may be partitioned according to a quadtree (QT) partitioning structure, which results in the CTBs of the CTU being partitioned into Coding Blocks (CB). That is, in ITU-T H.265, a CTU may be partitioned into quadtree leaf nodes. According to ITU-T H.265, one luma CB together with two corresponding chroma CBs and associated syntax elements are referred to as a coding unit (CU). In ITU-T H.265, a minimum allowed size of a CB may be signaled. In ITU-T H.265, the smallest minimum allowed size of a luma CB is 8×8 luma samples. In ITU-T H.265, the decision to code a picture area using intra prediction or inter prediction is made at the CU level.

In ITU-T H.265, a CU is associated with a prediction unit structure having its root at the CU. In ITU-T H.265, prediction unit structures allow luma and chroma CBs to be split for purposes of generating corresponding reference samples. That is, in ITU-T H.265, luma and chroma CBs may be split into respective luma and chroma prediction blocks (PBs), where a PB includes a block of sample values for which the same prediction is applied. In ITU-T H.265, a CB may be partitioned into 1, 2, or 4 PBs. ITU-T H.265 supports PB sizes from 64×64 samples down to 4×4 samples. In ITU-T H.265, square PBs are supported for intra prediction, where a CB may form the PB or the CB may be split into four square PBs. In ITU-T H.265, in addition to the square PBs, rectangular PBs are supported for inter prediction, where a CB may be halved vertically or horizontally to form PBs. Further, it should be noted that in ITU-T H.265, for inter prediction, four asymmetric PB partitions are supported, where the CB is partitioned into two PBs at one quarter of the height (at the top or the bottom) or width (at the left or the right) of the CB. Intra prediction data (e.g., intra prediction mode syntax elements) or inter prediction data (e.g., motion data syntax elements) corresponding to a PB is used to produce reference and/or predicted sample values for the PB.

JEM specifies a CTU having a maximum size of 256×256 luma samples. JEM specifies a quadtree plus binary tree (QTBT) block structure. In JEM, the QTBT structure enables quadtree leaf nodes to be further partitioned by a binary tree (BT) structure. That is, in JEM, the binary tree structure enables quadtree leaf nodes to be recursively divided vertically or horizontally. In JVET-T2001, CTUs are partitioned according a quadtree plus multi-type tree (QTMT or QT+MTT) structure. The QTMT in JVET-T2001 is similar to the QTBT in JEM. However, in JVET-T2001, in addition to indicating binary splits, the multi-type tree may indicate so-called ternary (or triple tree (TT)) splits. A ternary split divides a block vertically or horizontally into three blocks. In the case of a vertical TT split, a block is divided at one quarter of its width from the left edge and at one quarter its width from the right edge and in the case of a horizontal TT split a block is at one quarter of its height from the top edge and at one quarter of its height from the bottom edge.

As described above, each video frame or picture may be divided into one or more regions. For example, according to ITU-T H.265, each video frame or picture may be partitioned to include one or more slices and further partitioned to include one or more tiles, where each slice includes a sequence of CTUs (e.g., in raster scan order) and where a tile is a sequence of CTUs corresponding to a rectangular area of a picture. It should be noted that a slice, in ITU-T H.265, is a sequence of one or more slice segments starting with an independent slice segment and containing all subsequent dependent slice segments (if any) that precede the next independent slice segment (if any). A slice segment, like a slice, is a sequence of CTUs. Thus, in some cases, the terms slice and slice segment may be used interchangeably to indicate a sequence of CTUs arranged in a raster scan order. Further, it should be noted that in ITU-T H.265, a tile may consist of CTUs contained in more than one slice and a slice may consist of CTUs contained in more than one tile. However, ITU-T H.265 provides that one or both of the following conditions shall be fulfilled: (1) All CTUs in a slice belong to the same tile; and (2) All CTUs in a tile belong to the same slice.

With respect to JVET-T2001, slices are required to consist of an integer number of complete tiles or an integer number of consecutive complete CTU rows within a tile, instead of only being required to consist of an integer number of CTUs. It should be noted that in JVET-T2001, the slice design does not include slice segments (i.e., no independent/dependent slice segments). Thus, in JVET-T2001, a picture may include a single tile, where the single tile is contained within a single slice or a picture may include multiple tiles where the multiple tiles (or CTU rows thereof) may be contained within one or more slices. In JVET-T2001, the partitioning of a picture into tiles is specified by specifying respective heights for tile rows and respective widths for tile columns. Thus, in JVET-T2001 a tile is a rectangular region of CTUs within a particular tile row and a particular tile column position. Further, it should be noted that JVET-T2001 provides where a picture may be partitioned into subpictures, where a subpicture is a rectangular region of a CTUs within a picture. The top-left CTU of a subpicture may be located at any CTU position within a picture with subpictures being constrained to include one or more slices Thus, unlike a tile, a subpicture is not necessarily limited to a particular row and column position. It should be noted that subpictures may be useful for encapsulating regions of interest within a picture and a sub-bitstream extraction process may be used to only decode and display a particular region of interest. That is, as described in further detail below, a bitstream of coded video data includes a sequence of network abstraction layer (NAL) units, where a NAL unit encapsulates coded video data, (i.e., video data corresponding to a slice of picture) or a NAL unit encapsulates metadata used for decoding video data (e.g., a parameter set) and a sub-bitstream extraction process forms a new bitstream by removing one or more NAL units from a bitstream.

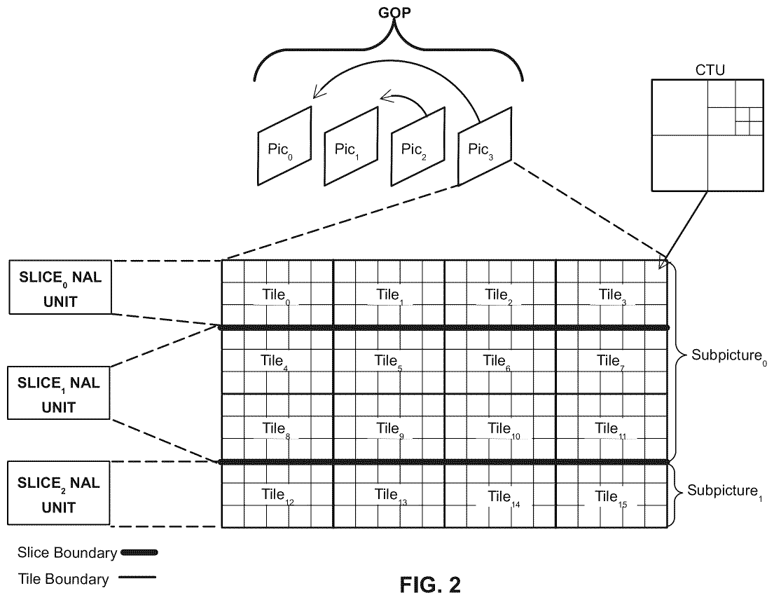

FIG. 2 is a conceptual diagram illustrating an example of a picture within a group of pictures partitioned according to tiles, slices, and subpictures. It should be noted that the techniques described herein may be applicable to tiles, slices, subpictures, sub-divisions thereof and/or equivalent structures thereto. That is, the techniques described herein may be generally applicable regardless of how a picture is partitioned into regions. For example, in some cases, the techniques described herein may be applicable in cases where a tile may be partitioned into so-called bricks, where a brick is a rectangular region of CTU rows within a particular tile. Further, for example, in some cases, the techniques described herein may be applicable in cases where one or more tiles may be included in so-called tile groups, where a tile group includes an integer number of adjacent tiles. In the example illustrated in FIG. 2, Pic₃ is illustrated as including 16 tiles (i.e., Tile₀ to Tile₁₅) and three slices (i.e., Slice₀ to Slice₂). In the example illustrated in FIG. 2, Slice₀ includes four tiles (i.e., Tile₀ to Tile₃), Slice₁ includes eight tiles (i.e., Tile₄ to Tile₁₁), and Slice₂ includes four tiles (i.e., Tile₁₂ to Tile₁₅). Further, as illustrated in the example of FIG. 2, Pic₃ is illustrated as including two subpictures (i.e., Subpicture₀ and Subpicture₁), where Subpicture₀ includes Slice₀ and Slice₁ and where Subpicture₁ includes Slice₂. As described above, subpictures may be useful for encapsulating regions of interest within a picture and a sub-bitstream extraction process may be used in order to selectively decode (and display) a region interest. For example, referring to FIG. 2, Subpicture₀ may corresponding to an action portion of a sporting event presentation (e.g., a view of the field) and Subpicture₁ may corresponding to a scrolling banner displayed during the sporting event presentation. By using organizing a picture into subpictures in this manner, a viewer may be able to disable the display of the scrolling banner. That is, through a sub-bitstream extraction process Slice₂ NAL unit may be removed from a bitstream (and thus not decoded and/or displayed) and Slice₀ NAL unit and Slice₁ NAL unit may be decoded and displayed. The encapsulation of slices of a picture into respective NAL unit data structures and sub-bitstream extraction are described in further detail below.

For intra prediction coding, an intra prediction mode may specify the location of reference samples within a picture. In ITU-T H.265, defined possible intra prediction modes include a planar (i.e., surface fitting) prediction mode, a DC (i.e., flat overall averaging) prediction mode, and 33 angular prediction modes (predMode: 2-34). In JEM, defined possible intra-prediction modes include a planar prediction mode, a DC prediction mode, and 65 angular prediction modes. It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes.

For inter prediction coding, a reference picture is determined and a motion vector (MV) identifies samples in the reference picture that are used to generate a prediction for a current video block. For example, a current video block may be predicted using reference sample values located in one or more previously coded picture(s) and a motion vector is used to indicate the location of the reference block relative to the current video block. A motion vector may describe, for example, a horizontal displacement component of the motion vector (i.e., MVₓ), a vertical displacement component of the motion vector (i.e., MV_{y}), and a resolution for the motion vector (e.g., one-quarter pixel precision, one-half pixel precision, one-pixel precision, two-pixel precision, four-pixel precision). Previously decoded pictures, which may include pictures output before or after a current picture, may be organized into one or more to reference pictures lists and identified using a reference picture index value. Further, in inter prediction coding, uni-prediction refers to generating a prediction using sample values from a single reference picture and bi-prediction refers to generating a prediction using respective sample values from two reference pictures. That is, in uni-prediction, a single reference picture and corresponding motion vector are used to generate a prediction for a current video block and in bi-prediction, a first reference picture and corresponding first motion vector and a second reference picture and corresponding second motion vector are used to generate a prediction for a current video block. In bi-prediction, respective sample values are combined (e.g., added, rounded, and clipped, or averaged according to weights) to generate a prediction. Pictures and regions thereof may be classified based on which types of prediction modes may be utilized for encoding video blocks thereof. That is, for regions having a B type (e.g., a B slice), bi-prediction, uni-prediction, and intra prediction modes may be utilized, for regions having a P type (e.g., a P slice), uni-prediction, and intra prediction modes may be utilized, and for regions having an I type (e.g., an I slice), only intra prediction modes may be utilized. As described above, reference pictures are identified through reference indices. For example, for a P slice, there may be a single reference picture list, RefPicList0 and for a B slice, there may be a second independent reference picture list, RefPicList1, in addition to RefPicList0. It should be noted that for uni-prediction in a B slice, one of RefPicList0 or RefPicList1 may be used to generate a prediction. Further, it should be noted that during the decoding process, at the onset of decoding a picture, reference picture list(s) are generated from previously decoded pictures stored in a decoded picture buffer (DPB).

Further, a coding standard may support various modes of motion vector prediction. Motion vector prediction enables the value of a motion vector for a current video block to be derived based on another motion vector. For example, a set of candidate blocks having associated motion information may be derived from spatial neighboring blocks and temporal neighboring blocks to the current video block. Further, generated (or default) motion information may be used for motion vector prediction. Examples of motion vector prediction include advanced motion vector prediction (AMVP), temporal motion vector prediction (TMVP), so-called “merge” mode, and “skip” and “direct” motion inference. Further, other examples of motion vector prediction include advanced temporal motion vector prediction (ATMVP) and Spatial-temporal motion vector prediction (STMVP). For motion vector prediction, both a video encoder and video decoder perform the same process to derive a set of candidates. Thus, for a current video block, the same set of candidates is generated during encoding and decoding.

As described above, for inter prediction coding, reference samples in a previously coded picture are used for coding video blocks in a current picture. Previously coded pictures which are available for use as reference when coding a current picture are referred as reference pictures. It should be noted that the decoding order does not necessary correspond with the picture output order, i.e., the temporal order of pictures in a video sequence. In ITU-T H.265, when a picture is decoded it is stored to a decoded picture buffer (DPB) (which may be referred to as frame buffer, a reference buffer, a reference picture buffer, or the like). In ITU-T H.265, pictures stored to the DPB are removed from the DPB when they been output and are no longer needed for coding subsequent pictures. In ITU-T H.265, a determination of whether pictures should be removed from the DPB is invoked once per picture, after decoding a slice header, i.e., at the onset of decoding a picture. For example, referring to FIG. 2, Pic₂ is illustrated as referencing Pic₁. Similarly, Pic₃ is illustrated as referencing Pic₀. With respect to FIG. 2, assuming the picture number corresponds to the decoding order, the DPB would be populated as follows: after decoding Pic₀, the DPB would include {Pic₀}; at the onset of decoding Pic₁, the DPB would include {Pic₀}; after decoding Pic₁, the DPB would include {Pic₀, Pic₁}; at the onset of decoding Pic₂, the DPB would include {Pic₀, Pic₁}. Pic₂ would then be decoded with reference to Pic₁ and after decoding Pic₂, the DPB would include {Pic₀, Pic₁, Pic₂}. At the onset of decoding Pic₃, pictures Pic₀ and Pic₁ would be marked for removal from the DPB, as they are not needed for decoding Pic₃ (or any subsequent pictures, not shown) and assuming Pic₁ and Pic₂ have been output, the DPB would be updated to include {Pic₀}. Pic₃ would then be decoded by referencing Pic₀. The process of marking pictures for removal from a DPB may be referred to as reference picture set (RPS) management.

As described above, intra prediction data or inter prediction data is used to produce reference sample values for a block of sample values. The difference between sample values included in a current PB, or another type of picture area structure, and associated reference samples (e.g., those generated using a prediction) may be referred to as residual data. Residual data may include respective arrays of difference values corresponding to each component of video data. Residual data may be in the pixel domain. A transform, such as, a discrete cosine transform (DCT), a discrete sine transform (DST), an integer transform, a wavelet transform, or a conceptually similar transform, may be applied to an array of difference values to generate transform coefficients. It should be noted that in ITU-T H.265 and JVET-T2001, a CU is associated with a transform tree structure having its root at the CU level. The transform tree is partitioned into one or more transform units (TUs). That is, an array of difference values may be partitioned for purposes of generating transform coefficients (e.g., four 8×8 transforms may be applied to a 16×16 array of residual values). For each component of video data, such sub-divisions of difference values may be referred to as Transform Blocks (TBs). It should be noted that in some cases, a core transform and subsequent secondary transforms may be applied (in the video encoder) to generate transform coefficients. For a video decoder, the order of transforms is reversed.

A quantization process may be performed on transform coefficients or residual sample values directly (e.g., in the case, of palette coding quantization). Quantization approximates transform coefficients by amplitudes restricted to a set of specified values. Quantization essentially scales transform coefficients in order to vary the amount of data required to represent a group of transform coefficients. Quantization may include division of transform coefficients (or values resulting from the addition of an offset value to transform coefficients) by a quantization scaling factor and any associated rounding functions (e.g., rounding to the nearest integer). Quantized transform coefficients may be referred to as coefficient level values. Inverse quantization (or “dequantization”) may include multiplication of coefficient level values by the quantization scaling factor, and any reciprocal rounding or offset addition operations. It should be noted that as used herein the term quantization process in some instances may refer to division by a scaling factor to generate level values and multiplication by a scaling factor to recover transform coefficients in some instances. That is, a quantization process may refer to quantization in some cases and inverse quantization in some cases. Further, it should be noted that although in some of the examples below quantization processes are described with respect to arithmetic operations associated with decimal notation, such descriptions are for illustrative purposes and should not be construed as limiting. For example, the techniques described herein may be implemented in a device using binary operations and the like. For example, multiplication and division operations described herein may be implemented using bit shifting operations and the like.

Quantized transform coefficients and syntax elements (e.g., syntax elements indicating a coding structure for a video block) may be entropy coded according to an entropy coding technique. An entropy coding process includes coding values of syntax elements using lossless data compression algorithms. Examples of entropy coding techniques include content adaptive variable length coding (CAVLC), context adaptive binary arithmetic coding (CABAC), probability interval partitioning entropy coding (PIPE), and the like. Entropy encoded quantized transform coefficients and corresponding entropy encoded syntax elements may form a compliant bitstream that can be used to reproduce video data at a video decoder. An entropy coding process, for example, CABAC, may include performing a binarization on syntax elements. Binarization refers to the process of converting a value of a syntax element into a series of one or more bits. These bits may be referred to as “bins.” Binarization may include one or a combination of the following coding techniques: fixed length coding, unary coding, truncated unary coding, truncated Rice coding, Golomb coding, k-th order exponential Golomb coding, and Golomb-Rice coding. For example, binarization may include representing the integer value of 5 for a syntax element as 00000101 using an 8-bit fixed length binarization technique or representing the integer value of 5 as 11110 using a unary coding binarization technique. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard. In the example of CABAC, for a particular bin, a context provides a most probable state (MPS) value for the bin (i.e., an MPS for a bin is one of 0 or 1) and a probability value of the bin being the MPS or the least probably state (LPS). For example, a context may indicate, that the MPS of a bin is 0 and the probability of the bin being 1 is 0.3. It should be noted that a context may be determined based on values of previously coded bins including bins in the current syntax element and previously coded syntax elements. For example, values of syntax elements associated with neighboring video blocks may be used to determine a context for a current bin.

As described above, the sample values of a reconstructed block may differ from the sample values of the current video block that is encoded. Further, it should be noted that in some cases, coding video data on a block-by-block basis may result in artifacts (e.g., so-called blocking artifacts, banding artifacts, etc.) For example, blocking artifacts may cause coding block boundaries of reconstructed video data to be visually perceptible to a user. In this manner, reconstructed sample values may be modified to minimize the difference between the sample values of the current video block that is encoded and the reconstructed block and/or minimize artifacts introduced by the video coding process. Such modifications may generally be referred to as filtering. It should be noted that filtering may occur as part of an in-loop filtering process or a post-loop filtering process. For an in-loop filtering process, the resulting sample values of a filtering process may be used for predictive video blocks (e.g., stored to a reference frame buffer for subsequent encoding at video encoder and subsequent decoding at a video decoder). For a post-loop filtering process the resulting sample values of a filtering process are merely output as part of the decoding process (e.g., not used for subsequent coding). For example, in the case of a video decoder, for an in-loop filtering process, the sample values resulting from filtering the reconstructed block would be used for subsequent decoding (e.g., stored to a reference buffer) and would be output (e.g., to a display). For a post-loop filtering process, the reconstructed block would be used for subsequent decoding and the sample values resulting from filtering the reconstructed block would be output.

Deblocking (or de-blocking), deblock filtering, or applying a deblocking filter refers to the process of smoothing the boundaries of neighboring reconstructed video blocks (i.e., making boundaries less perceptible to a viewer). Smoothing the boundaries of neighboring reconstructed video blocks may include modifying sample values included in rows or columns adjacent to a boundary. JVET-T2001 provides where a deblocking filter is applied to reconstructed sample values as part of an in-loop filtering process. In addition to applying a deblocking filter as part of an in-loop filtering process, JVET-T2001 provides where Sample Adaptive Offset (SAO) filtering may be applied in the in-loop filtering process. In general an SAO is a process that modifies the deblocked sample values in a region by conditionally adding an offset value. Another type of filtering process includes the so-called adaptive loop filter (ALF). An ALF with block-based adaption is specified in JEM. In JEM, the ALF is applied after the SAO filter. It should be noted that an ALF may be applied to reconstructed samples independently of other filtering techniques. The process for applying the ALF specified in JEM at a video encoder may be summarized as follows: (1) each 2×2 block of the luma component for a reconstructed picture is classified according to a classification index; (2) sets of filter coefficients are derived for each classification index; (3) filtering decisions are determined for the luma component; (4) a filtering decision is determined for the chroma components; and (5) filter parameters (e.g., coefficients and decisions) are signaled. JVET-T2001 specifies deblocking, SAO, and ALF filters which can be described as being generally based on the deblocking, SAO, and ALF filters provided in ITU-T H.265 and JEM.

It should be noted that JVET-T2001 is referred to as the pre-published version of ITU-T H.266 and thus, is the nearly finalized draft of the video coding standard resulting from the VVC project and as such, may be referred to as the first version of the VVC standard (or VVC or VVC version 1 or ITU-H.266). It should be noted that during the VVC project, Convolutional Neural Networks (CNN)-based techniques showing potential in artifact removal and objective quality improvement, were investigated, but it was decided not to include such techniques in the VVC. However, CNN based techniques are currently being considered for extensions and/or improvements for VVC. Some CNN based-techniques relate to in-loop filtering. For example, “AHG11: Neural Network-based In-Loop Filter,” 20th Meeting of ISO/IEC JTC1/SC29/WG11 7—16 Oct. 2020, Teleconference, document JVET-T0079-v3, describes, a Neural Network based in-loop filter as an additional in-loop filter stage for VVC; “EE: Tests on Neural Network-based In-Loop Filter,” 21th Meeting of ISO/IEC JTC1/SC29/WG11 6-15 Jan. 2021, Teleconference, document JVET-U0094-v2, describes test results corresponding to different aspects of the Neural Network-based In-Loop Filter described in JVET-T0094; and “AHG11: Neural Network-based In-Loop Filter Performance with No Deblocking Filtering stage,” 21th Meeting of ISO/IEC JTC1/SC29/WG11 6-15 Jan. 2021, Teleconference, document JVET-U0115-v2, describes a Neural Network-based in-loop filter implementation based on a subtest of JVET-U0094. It should be noted that a neural network based in-loop filter may be referred to as an NN ILF. Further, it should be noted that the NN in-loop filter described in JVET-U0115-v2 is incorporated in VVC test software (VTM-10.0) as an in-loop filter occurring prior to SAO which uses the deblocking boundary strength calculation to create corresponding additional input planes to the NN ILF, but the actual VVC deblocking filtering is not applied. Further, JVET-U0115-v2 describes where CTU level switching (on/off) flags are signaled to indicated whether a block is NN in-loop filtered or not, scaling of NN filter residues is also applied, four models are used to cover different QP ranges and picture types, and the model selection is done at picture level. Thus, in general, in order to implement a NN in-loop filter, at a video decoder, one or more of the following may be required to be signaled: whether an NN ILF is on or off (at various level of video); whether scaling of NN filter residues is applied, and/or a filter model selection which may be dependent on a picture type (or slice type) and a QP type. For example, for I-type pictures an NN ILF may be selected from one of four models and for P and B type pictures an NN ILF may be selected from one of three models. The techniques described herein, provide techniques for signaling of neural network parameters (e.g., NN ILF parameters) for use in extensions and improvements of VVC.

Some CNN based-techniques relate to so-called super resolution. In general, super resolution (or super-resolution (SR)), refers to reconstructing a high-resolution image from a low-resolution image. Typically, a high-resolution image is down-sampled, the down-sampled image is encoded according to a video coding standard (e.g., ITU-H.265 or VVC), the down-sampled image is recovered according to the video decoding process, and the recovered down-sampled image is up-sampled to reconstruct the high-resolution image. CNN based-techniques essentially, use training sets of video data and learn (i.e., e.g., correlate video properties and/or coding parameters) how to optimize the down-sampling, encoding, and/or up-sampling to maximize coding efficiency (e.g., reduce distortion at a particulate bit-rate). For example, “AHG9/AHG11: Neural Network based super resolution SEI,” 20th Meeting of ISO/IEC JTC1/SC29/WG11 7-16 October 2020, Teleconference, document JVET-T0092-v2, describes a Neural Network based super-resolution post-filter for up-sampling a recovered down-sampled image; “AHG11: Neural Network-based Super Resolution,” 21th Meeting of ISO/IEC JTC1/SC29/WG11 6-15 Jan. 2021, Teleconference, document JVET-U0099-v2, describes performance results corresponding to applying a Neural-Network based super-resolution used as an up-sampling filter in the context of VVC Reference Picture Resampling (RPR). That is, JVET-U0099-v2 describes where prior to encoding, a given picture is down-sampled by a factor of 2× (i.e., ScalingRatioHor and ScalingRatioVer are both set equal to 2) using the inbuilt RPR mechanism of VVC software, the difference between the original picture and the up-sampled version of the decoded picture are compared, and the up-sampled decoded picture is generated by a Neural Network-based up-sampling filter. Up-sampling a recovered down-sampled image to generate a reconstructed high-resolution image, in the context of super resolution, may be referred to as applying an NN SR filter. It should be noted, that in each of JVET-T0092-v2 and JVET-U0099-v2, and more generally, in the case of applying an NN SR filter, parameters for an up-sampling filter may be required to be signaled. JVET-T0092-v2 describes where an supplemental enhancement information SEI message (SEI messages are described in detail below) is used for signaling such parameters. Such an SEI message approach for signaling parameters for super resolution may be only appropriate when super resolution is used as a post filter (as opposed to it being used inside the coding loop). Thus, the signaling of such parameters in a SEI message may be less than ideal. The techniques described herein, provide techniques for signaling of neural network parameters (e.g., NN SR filter parameters) for use in extensions and improvements of VVC.

With respect to the equations used herein, the following arithmetic operators may be used:
+ Addition
− Subtraction
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.
x/y Used to denote division in mathematical equations where no truncation or rounding is intended.

Further, the following mathematical functions may be used:
Log2(x) the base-2 logarithm of x;

$$Min ( x , y ) = \{ \begin{matrix}x ; & x <= y \\ y ; & x > y\end{matrix} ;$$

$$Max ( x , y ) = \{ \begin{matrix}x ; & x >= y \\ y ; & x < y\end{matrix}$$

Ceil(x) the smallest integer greater than or equal to x.

With respect to the example syntax used herein, the following definitions of logical operators may be applied:
x && y Boolean logical “and” of x and y
x∥y Boolean logical “or” of x and y
! Boolean logical “not”
x?y:z If x is TRUE or not equal to 0, evaluates to the value of y; otherwise, evaluates to the value of z.

Further, the following relational operators may be applied:
> Greater than
>= Greater than or equal to
< Less than
<= Less than or equal to
== Equal to
!=Not equal to

Further, it should be noted that in the syntax descriptors used herein, the following descriptors may be applied:
b(8): byte having any pattern of bit string (8 bits). The parsing process for this descriptor is specified by the return value of the function read_bits(8).
f(n): fixed-pattern bit string using n bits written (from left to right) with the left bit first. The parsing process for this descriptor is specified by the return value of the function read_bits(n).
se(v): signed integer 0-th order Exp-Golomb-coded syntax element with the left bit first.
tb(v): truncated binary using up to maxVal bits with maxVal defined in the semantics of the syntax element.
tu(v): truncated unary using up to maxVal bits with maxVal defined in the semantics of the symtax element.
u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.
ue(v): unsigned integer 0-th order Exp-Golomb-coded syntax element with the left bit first.

As described above, video content includes video sequences comprised of a series of pictures and each picture may be divided into one or more regions. In JVET-T2001, a coded representation of a picture comprises VCL NAL units of a particular layer within an AU and contains all CTUs of the picture. For example, referring again to FIG. 2, the coded representation of Pic₃ is encapsulated in three coded slice NAL units (i.e., Slice₀ NAL unit, Slice₁ NAL unit, and Slice₂ NAL unit). It should be noted that the term video coding layer (VCL) NAL unit is used as a collective term for coded slice NAL units, i.e., VCL NAL is a collective term which includes all types of slice NAL units. As described above, and in further detail below, a NAL unit may encapsulate metadata used for decoding video data. A NAL unit encapsulating metadata used for decoding a video sequence is generally referred to as a non-VCL NAL unit. Thus, in JVET-T2001, a NAL unit may be a VCL NAL unit or a non-VCL NAL unit. It should be noted that a VCL NAL unit includes slice header data, which provides information used for decoding the particular slice. Thus, in JVET-T2001, information used for decoding video data, which may be referred to as metadata in some cases, is not limited to being included in non-VCL NAL units. JVET-T2001 provides where a picture unit (PU) is a set of NAL units that are associated with each other according to a specified classification rule, are consecutive in decoding order, and contain exactly one coded picture and where an access unit (AU) is a set of PUs that belong to different layers and contain coded pictures associated with the same time for output from the DPB. JVET-T2001 further provides where a layer is a set of VCL NAL units that all have a particular value of a layer identifier and the associated non-VCL NAL units. Further, in JVET-T2001, a PU consists of zero or one PH NAL units, one coded picture, which comprises of one or more VCL NAL units, and zero or more other non-VCL NAL units. Further, in JVET-T2001, a coded video sequence (CVS) is a sequence of AUs that consists, in decoding order, of a CVSS AU, followed by zero or more AUs that are not CVSS AUs, including all subsequent AUs up to but not including any subsequent AU that is a CVSS AU, where a coded video sequence start (CVSS) AU is an AU in which there is a PU for each layer in the CVS and the coded picture in each present picture unit is a coded layer video sequence start (CLVSS) picture. In JVET-T2001, a coded layer video sequence (CLVS) is a sequence of PUs within the same layer that consists, in decoding order, of a CLVSS PU, followed by zero or more PUs that are not CLVSS PUs, including all subsequent PUs up to but not including any subsequent PU that is a CLVSS PU. This is, in JVET-T2001, a bitstream may be described as including a sequence of AUs forming one or more CVSs.

Multi-layer video coding enables a video presentation to be decoded/displayed as a presentation corresponding to a base layer of video data and decoded/displayed one or more additional presentations corresponding to enhancement layers of video data. For example, a base layer may enable a video presentation having a basic level of quality (e.g., a High Definition rendering and/or a 30 Hz frame rate) to be presented and an enhancement layer may enable a video presentation having an enhanced level of quality (e.g., an Ultra High Definition rendering and/or a 60 Hz frame rate) to be presented. An enhancement layer may be coded by referencing a base layer. That is, for example, a picture in an enhancement layer may be coded (e.g., using inter-layer prediction techniques) by referencing one or more pictures (including scaled versions thereof) in a base layer. It should be noted that layers may also be coded independent of each other. In this case, there may not be inter-layer prediction between two layers. Each NAL unit may include an identifier indicating a layer of video data the NAL unit is associated with. As described above, a sub-bitstream extraction process may be used to only decode and display a particular region of interest of a picture. Further, a sub-bitstream extraction process may be used to only decode and display a particular layer of video. Sub-bitstream extraction may refer to a process where a device receiving a compliant or conforming bitstream forms a new compliant or conforming bitstream by discarding and/or modifying data in the received bitstream. For example, sub-bitstream extraction may be used to form a new compliant or conforming bitstream corresponding to a particular representation of video (e.g., a high quality representation).

In JVET-T2001, each of a video sequence, a GOP, a picture, a slice, and CTU may be associated with metadata that describes video coding properties and some types of metadata an encapsulated in non-VCL NAL units. JVET-T2001 defines parameters sets that may be used to describe video data and/or video coding properties. In particular, JVET-T2001 includes the following four types of parameter sets: video parameter set (VPS), sequence parameter set (SPS), picture parameter set (PPS), and adaption parameter set (APS), where a SPS applies to apply to zero or more entire CVSs, a PPS applies to zero or more entire coded pictures, an APS applies to zero or more slices, and a VPS may be optionally referenced by a SPS. A PPS applies to an individual coded picture that refers to it. In JVET-T2001, parameter sets may be encapsulated as a non-VCL NAL unit and/or may be signaled as a message. JVET-T2001 also includes a picture header (PH) which is encapsulated as a non-VCL NAL unit. In JVET-T2001, a picture header applies to all slices of a coded picture. JVET-T2001 further enables decoding capability information (DCI) and supplemental enhancement information (SEI) messages to be signaled. In JVET-T2001, DCI and SEI messages assist in processes related to decoding, display or other purposes, however, DCI and SEI messages may not be required for constructing the luma or chroma samples according to a decoding process. In JVET-T2001, DCI and SEI messages may be signaled in a bitstream using non-VCL NAL units. Further, DCI and SEI messages may be conveyed by some mechanism other than by being present in the bitstream (i.e., signaled out-of-band).

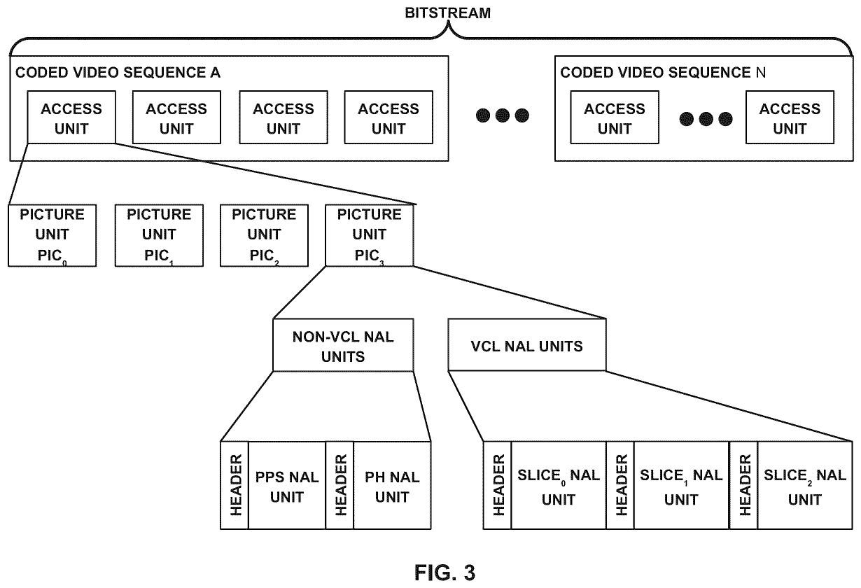

FIG. 3 illustrates an example of a bitstream including multiple CVSs, where a CVS includes AUs, and AUs include picture units. The example illustrated in FIG. 3 corresponds to an example of encapsulating the slice NAL units illustrated in the example of FIG. 2 in a bitstream. In the example illustrated in FIG. 3, the corresponding picture unit for Pic₃ includes the three VCL NAL coded slice NAL units, i.e., Slice₀ NAL unit, Slice₁ NAL unit, and Slice₂ NAL unit and two non-VCL NAL units, i.e., a PPS NAL Unit and a PH NAL unit. It should be noted that in FIG. 3, HEADER is a NAL unit header (i.e., not to be confused with a slice header). Further, it should be noted that in FIG. 3, other non-VCL NAL units, which are not illustrated may be included in the CVSs, e.g., SPS NAL units, VPS NAL units, SEI message NAL units, etc. Further, it should be noted that in other examples, a PPS NAL Unit used for decoding Pic₃ may be included elsewhere in the bitstream, e.g., in the picture unit corresponding to Pic₀ or may be provided by an external mechanism. As described in further detail below, in JVET-T2001, a PH syntax structure may be present in the slice header of a VCL NAL unit or in a PH NAL unit of the current PU.

As described above, the techniques described herein, provide techniques for signaling of neural network parameters for use in extensions and improvements of VVC. In particular, the techniques described herein, provide general high-level syntax compatible with JVET-T2001 for signaling NN ILF filter parameters. It should be noted that it is anticipated that typical NN ILF filter parameters may include several bits of data and may be content dependent (e.g., based on picture type and/or QP values). Further, it should be noted that signaling NN ILF filter parameters in an SPS or PPS (i.e., e.g., by modifying the SPS and/or PPS provided in JVET-T2001) may suffer from one or more of the following drawbacks: signaling the NN ILF filter parameters in a PPS would require signaling multiple PPSs in order to signal different NN ILF filter parameters at the picture level (e.g., picture level model selection) and various other PPS parameters (which may be identical) would need to be repeated leading to redundant signaling which can hurt coding efficiency; and signaling the NN ILF filter parameters in an SPS would require signaling multiple sets (e.g., all possible sets) of NN ILF filter parameters in SPS and thus, the size of SPS would increase, which may increase initial latency while an SPS is acquired and if the user only plays part of a CVS or CLVS, multiple sets of NN ILF filter parameters signaled in a SPS are unnecessarily received (i.e., may need to be parsed but not used). Further, the techniques described herein, provide general high-level syntax compatible with JVET-T2001 for signaling NN SR filter parameters. It should be noted that it is anticipated that typical NN SR filter parameters may include several bits of data and may be content dependent (e.g., based on picture type and/or QP values). For example, in some cases, super-resolution techniques may be applied only to picture having an I-type. Further, it should be noted that signaling NN SR filter parameters in an SPS or PPS (i.e., e.g., by modifying the SPS and/or PPS provided in JVET-T2001) may suffer from one or more of the following drawbacks: signaling the NN SR filter parameters in a PPS would require signaling multiple PPSs in order to signal different NN SR filter parameters at the picture level (e.g., picture level model selection) and various other PPS parameters (which may be identical) would need to be repeated leading to redundant signaling which can hurt coding efficiency; and signaling the NN SR filter parameters in an SPS would require signaling multiple sets of NN parameters in SPS and thus, the size of SPS would increase, which may increase initial latency while an SPS is acquired and if the user only plays part of a CVS, multiple sets of NN SR filter parameters signaled in a SPS are unnecessarily received (i.e., may need to be parsed but not used). Further, as provided above, SEI messages may not be required for constructing the luma or chroma samples according to a decoding process (e.g., JVET-T2001), thus, in some decoder implementations, these messages may be discarded (e.g., unintentionally).

JVET-T2001 defines NAL unit header semantics that specify the type of Raw Byte Sequence Payload (RBSP) data structure included in the NAL unit. Table 1 illustrates the syntax of the NAL unit header provided in JVET-T2001.

TABLE 1

| | Descriptor |
|---|---|
| nal_unit_header( ) { | |
| forbidden_zero_bit | f(1) |
| nuh_reserved_zero_bit | u(1) |
| nuh_layer_id | u(6) |
| nal_unit_type | u(5) |
| nuh_temporal_id_plus1 | u(3) |
| } | |

JVET-T2001 provides the following definitions for the respective syntax elements illustrated in Table 1.

forbidden_zero_bit shall be equal to 0.
nuh_reserved_zero_bit shall be equal to 0. The value 1 of nuh_reserved_zero_bit could be specified in the future by ITU-T|ISO/IEC. Although the value of nuh_reserved_zero_bit is required to be equal to 0 in this version of this Specification, decoders conforming to this version of this Specification shall allow the value of nuh_reserved_zero_bit equal to 1 to appear in the syntax and shall ignore (i.e. remove from the bitstream and discard) NAL units with nuh_reserved_zero_bit equal to 1.
nuh_layer_id specifies the identifier of the layer to which a VCL NAL unit belongs or the identifier of a layer to which a non-VCL NAL unit applies. The value of nuh_layer_id shall be in the range of 0 to 55, inclusive. Other values for nuh_layer_id are reserved for future use by ITU-T|ISO/IEC. Although the value of nuh_layer_id is required to be the range of 0 to 55, inclusive, in this version of this Specification, decoders conforming to this version of this Specification shall allow the value of nuh_layer_id to be greater than 55 to appear in the syntax and shall ignore (i.e. remove from the bitstream and discard) NAL units with nuh_layer_id greater than 55.
The value of nuh_layer_id shall be the same for all VCL NAL units of a coded picture. The value of nuh_layer_id of a coded picture or a PU is the value of the nuh_layer_id of the VCL NAL units of the coded picture or the PU.
When nal_unit_type is equal to PH_NUT, or FD_NUT, nuh_layer_id shall be equal to the nuh_layer_id of associated VCL NAL unit.
When nal_unit_type is equal to EOS_NUT, nuh_layer_id shall be equal to one of the nuh_layer_id values of the layers present in the CVS.
NOTE—The value of nuh_layer_id for DCI, OPI, VPS, AUD, and EOB NAL units is not constrained.
nuh_temporal_id_plus1 minus 1 specifies a temporal identifier for the NAL unit.
The value of nuh_temporal_id_plus1 shall not be equal to 0.
The variable TemporalId is derived as follows:

$$TemporalId = nuh\_temporal \_id \_plus1 - 1$$

When nal_unit_type is in the range of IDR_W_RADL to RSV_IRAP_11, inclusive, TemporalId shall be equal to 0.
When nal_unit_type is equal to STSA_NUT and
vps_independent_layer_flag[GeneralLayerIdx[nuh_layer_id] ] is equal to 1, TemporalId shall be greater than 0.
The value of TemporalId shall be the same for all VCL NAL units of an AU. The value of TemporalId of a coded picture, a PU, or an AU is the value of the TemporalId of the VCL NAL units of the coded picture, PU, or AU. The value of TemporalId of a sublayer representation is the greatest value of TemporalId of all VCL NAL units in the sublayer representation.
The value of TemporalId for non-VCL NAL units is constrained as follows:
If nal_unit_type is equal to DCI_NUT, OPI_NUT, VPS_NUT, or SPS_NUT, TemporalId shall be equal to 0 and the TemporalId of the AU containing the NAL unit shall be equal to 0.
Otherwise, if nal_unit_type is equal to PH_NUT, TemporalId shall be equal to the TemporalId of the PU containing the NAL unit.
Otherwise, if nal_unit_type is equal to EOS_NUT or EOB_NUT, TemporalId shall be equal to 0.
Otherwise, if nal_unit_type is equal to AUD_NUT, FD_NUT, PREFIX_SEI_NUT, or SUFFIX_SEI_NUT, TemporalId shall be equal to the TemporalId of the AU containing the NAL unit.
Otherwise, when nal_unit_type is equal to PPS_NUT, PREFIX_APS_NUT, or SUFFIX_APS_NUT, TemporalId shall be greater than or equal to the TemporalId of the PU containing the NAL unit.
   NOTE—When the NAL unit is a non-VCL NAL unit, the value of TemporalId is equal to the minimum value of the TemporalId values of all AUs to which the non-VCL NAL unit applies. When nal_unit_type is equal to PPS_NUT, PREFIX_APS_NUT, or SUFFIX_APS_NUT, TemporalId could be greater than or equal to the TemporalId of the containing AU, as all PPSs and APSs could be included in the beginning of the bitstream (e.g., when they are transported out-of-band, and the receiver places them at the beginning of the bitstream), wherein the first coded picture has TemporalId equal to 0.
   nal_unit_type specifies the NAL unit type, i.e., the type of RBSP data structure contained in the NAL unit as specified in Table 2.
   NAL units that have nal_unit_type in the range of UNSPEC28 . . . UNSPEC31, inclusive, for which semantics are not specified, shall not affect the decoding process specified in this Specification. NOTE—NAL unit types in the range of UNSPEC_28 . . . UNSPEC_31 could be used as determined by the application. No decoding process for these values of nal_unit_type is specified in this Specification. Since different applications might use these NAL unit types for different purposes, particular care is expected to be exercised in the design of encoders that generate NAL units with these nal_unit_type values, and in the design of decoders that interpret the content of NAL units with these nal_unit_type values. This Specification does not define any management for these values. These nal_unit_type values might only be suitable for use in contexts in which “collisions” of usage (i.e., different definitions of the meaning of the NAL unit content for the same nal_unit_type value) are unimportant, or not possible, or are managed—e.g., defined or managed in the controlling application or transport specification, or by controlling the environment in which bitstreams are distributed.
   For purposes other than determining the amount of data in the DUs of the bitstream, decoders shall ignore (remove from the bitstream and discard) the contents of all NAL units that use reserved values of nal_unit_type. NOTE—This requirement allows future definition of compatible extensions to this Specification.

| | | | NAL |
|---|---|---|---|
| | | | unit |
| | Name of | Content of NAL unit and RBSP syntax | type |
| nal_unit_type | nal_unit_type | structure | class |
| 0 | TRAIL_NUT | Coded slice of a trailing picture or | VCL |
| | | subpicture* | |
| | | slice_layer_rbsp( ) | |
| 1 | STSA_NUT | Coded slice of an STSA picture or | VCL |
| | | subpicture* | |
| | | slice_layer_rbsp( ) | |
| 2 | RADL_NUT | Coded slice of a RADL picture or | VCL |
| | | subpicture* | |
| | | slice_layer_rbsp( ) | |
| 3 | RASL_NUT | Coded slice of a RASL picture or | VCL |
| | | subpicture* | |
| | | slice_layer_rbsp( ) | |
| 4 . . . 6 | RSV_VCL_4 . . . | Reserved non-IRAP VCL NAL unit types | VCL |
| | RSV_VCL_6 | | |
| 7 | IDR_W_RADL | Coded slice of an IDR picture or | |
| | | subpicture* | |
| 8 | IDR_N_LP | slice_layer_rbsp( ) | VCL |
| 9 | CRA_NUT | Coded slice of a CRA picture or | VCL |
| | | subpicture* | |
| | | slice_layer_rbsp( ) | |
| 10 | GDR_NUT | Coded slice of a GDR picture or | VCL |
| | | subpicture* | |
| | | slice_layer_rbsp( ) | |
| 11 | RSV_IRAP_11 | Reserved IRAP VCL NAL unit type | VCL |
| 12 | OPI_NUT | Operating point information | non- |
| | | operating_point_information_rbsp( ) | VCL |
| 13 | DCI_NUT | Decoding capability information | non- |
| | | decoding_capability_information_rbsp( ) | VCL |
| 14 | VPS_NUT | Video parameter set | non- |
| | | video_parameter_set_rbsp( ) | VCL |
| 15 | SPS_NUT | Sequence parameter set | non- |
| | | seq_parameter_set_rbsp( ) | VCL |
| 16 | PPS_NUT | Picture parameter set | non- |
| | | pic_parameter_set_rbsp( ) | VCL |
| 17 | PREFIX_APS_NUT | Adaptation parameter set | non- |
| 18 | SUFFIX_APS_NUT | adaptation_parameter_set_rbsp( ) | VCL |
| 19 | PH_NUT | Picture header | non- |
| | | picture_header_rbsp( ) | VCL |
| 20 | AUD_NUT | AU delimiter | non- |
| | | access_unit_delimiter_rbsp( ) | VCL |
| 21 | EOS_NUT | End of sequence | non- |
| | | end_of_seq_rbsp( ) | VCL |
| 22 | EOB_NUT | End of bitstream | non- |
| | | end_of_bitstream_rbsp( ) | VCL |
| 23 | PREFIX_SEI_NUT | Supplemental enhancement information | non- |
| 24 | SUFFIX_SEI_NUT | sei_rbsp( ) | VCL |
| 25 | FD_NUT | Filler data | non- |
| | | filler_data_rbsp( ) | VCL |
| 26 | RSV_NVCL_26 | Reserved non-VCL NAL unit types | non- |
| 27 | RSV_NVCL_27 | | VCL |
| 28 . . . 31 | UNSPEC_28 . . . | Unspecified non-VCL NAL unit types | non- |
| | UNSPEC_31 | | VCL |

*indicates a property of a picture when pps_mixed_nalu_types_in_pic_flag is equal to 0 and a property of the subpicture when pps_mixed_nalu_types_in_pic_flag is equal to 1.

NOTE—A clean random access (CRA) picture may have associated RASL or RADL pictures present in the bitstream.
NOTE—An instantaneous decoding refresh (IDR) picture having nal_unit_type equal to IDR_N_LP does not have associated leading pictures present in the bitstream. An IDR picture having nal_unit_type equal to IDR_W_RADL does not have associated RASL pictures present in the bitstream, but may have associated RADL pictures in the bitstream.
The value of nal_unit_type shall be the same for all VCL NAL units of a subpicture. A subpicture is referred to as having the same NAL unit type as the VCL NAL units of the subpicture.
For VCL NAL units of any particular picture, the following applies:
If pps_mixed_nalu_types_in_pic_flag is equal to 0, the value of nal_unit_type shall be the same for all VCL NAL units of a picture, and a picture or a PU is referred to as having the same NAL unit type as the coded slice NAL units of the picture or PU.
Otherwise (pps_mixed_nalu_types_in_pic_flag is equal to 1), all of the following constraints apply:
   The picture shall have at least two subpictures.
   VCL NAL units of the picture shall have two or more different nal_unit_type values.
   There shall be no VCL NAL unit of the picture that has nal_unit_type equal to GDR_NUT.
   When a VCL NAL unit of the picture has nal_unit_type equal to nalUnitTypeA that is equal to IDR_W_RADL, IDR_N_LP, or CRA_NUT, other VCL NAL units of the picture shall all have nal_unit_type equal to nalUnitTypeA or TRAIL_NUT.
      The value of nal_unit_type shall be the same for all pictures in an IRAP or GDR AU.
      When sps_video_parameter_set_id is greater than 0, vps_max_tid_il_ref_pics_plus11[i][j] is equal to 0 for j equal to GeneralLayerIdx[nuh_layer_id] and any value of i in the range of j+1 to vps_max_layers_minus1, inclusive, and pps_mixed_nalu_types_in_pic_flag is equal to 1, the value of nal_unit_type shall not be equal to IDR_W_RADL, IDR_N_LP, or CRA_NUT.
      It is a requirement of bitstream conformance that the following constraints apply:
When a picture is a leading picture of an IRAP picture, it shall be a RADL or RASL picture.
When a subpicture is a leading subpicture of an IRAP subpicture, it shall be a RADL or RASL subpicture.
When a picture is not a leading picture of an IRAP picture, it shall not be a RADL or RASL picture.
When a subpicture is not a leading subpicture of an IRAP subpicture, it shall not be a RADL or RASL subpicture.
No RASL pictures shall be present in the bitstream that are associated with an IDR picture.
No RASL subpictures shall be present in the bitstream that are associated with an IDR subpicture.
No RADL pictures shall be present in the bitstream that are associated with an IDR picture having nal_unit_type equal to IDR_N_LP.
   NOTE—It is possible to perform random access at the position of an IRAP AU by discarding all PUs before the IRAP AU (and to correctly decode the non-RASL pictures in the IRAP AU and all the subsequent AUs in decoding order), provided each parameter set is available (either in the bitstream or by external means not specified in this Specification) when it is referenced.
No RADL subpictures shall be present in the bitstream that are associated with an IDR subpicture having nal_unit_type equal to IDR_N_LP.
Any picture, with nuh_layer_id equal to a particular value layerId, that precedes an IRAP picture with nuh_layer_id equal to layerId in decoding order shall precede the IRAP picture in output order and shall precede any RADL picture associated with the IRAP picture in output order.
Any subpicture, with nuh_layer_id equal to a particular value layerId and subpicture index equal to a particular value subpicIdx, that precedes, in decoding order, an IRAP subpicture with nuh_layer_id equal to layerId and subpicture index equal to subpicIdx shall precede, in output order, the IRAP subpicture and all its associated RADL subpictures.
Any picture, with nuh_layer_id equal to a particular value layerId, that precedes a recovery point picture with nuh_layer_id equal to layerId in decoding order shall precede the recovery point picture in output order.
Any subpicture, with nuh_layer_id equal to a particular value layerId and subpicture index equal to a particular value subpicIdx, that precedes, in decoding order, a subpicture with nuh_layer_id equal to layerId and subpicture index equal to subpicIdx in a recovery point picture shall precede that subpicture in the recovery point picture in output order.
Any RASL picture associated with a CRA picture shall precede any RADL picture associated with the CRA picture in output order.
Any RASL subpicture associated with a CRA subpicture shall precede any RADL subpicture associated with the CRA subpicture in output order.
Any RASL picture, with nuh_layer_id equal to a particular value layerId, associated with a CRA picture shall follow, in output order, any IRAP or GDR picture with nuh_layer_id equal to layerId that precedes the CRA picture in decoding order.
Any RASL subpicture, with nuh_layer_id equal to a particular value layerId and subpicture index equal to a particular value subpicIdx, associated with a CRA subpicture shall follow, in output order, any IRAP or GDR subpicture, with nuh_layer_id equal to layerId and subpicture index equal to subpicIdx, that precedes the CRA subpicture in decoding order.
If sps_field_seq_flag is equal to 0, the following applies: when the current picture, with nuh_layer_id equal to a particular value layerId, is a leading picture associated with an IRAP picture, it shall precede, in decoding order, all non-leading pictures that are associated with the same IRAP picture. Otherwise (sps_field_seq_flag is equal to 1), let picA and picB be the first and the last leading pictures, in decoding order, associated with an IRAP picture, respectively, there shall be at most one non-leading picture with nuh_layer_id equal to layerId preceding picA in decoding order, and there shall be no non-leading picture with nuh_layer_id equal to layerId between picA and picB in decoding order.
If sps_field_seq_flag is equal to 0, the following applies: when the current subpicture, with nuh_layer_id equal to a particular value layerId and subpicture index equal to a particular value subpicIdx, is a leading subpicture associated with an IRAP subpicture, it shall precede, in decoding order, all non-leading subpictures that are associated with the same IRAP subpicture. Otherwise (sps_field_seq_flag is equal to 1), let subpicA and subpicB be the first and the last leading subpictures, in decoding order, associated with an IRAP subpicture, respectively, there shall be at most one non-leading subpicture with nuh_layer_id equal to layerId and subpicture index equal to subpicIdx preceding subpicA in decoding order, and there shall be no non-leading picture with nuh_layer_id equal to layerId and subpicture index equal to subpicIdx between picA and picB in decoding order.

As provided in Table 2, a NAL unit may include a sequence parameter set (SPS) syntax structure. Table 3 illustrates the sequence parameter set (SPS) syntax structure provided in JVET-T2001.

TABLE 3

| | Descriptor |
|---|---|
| seq_parameter_set_rbsp( ) { | |
| sps_seq_parameter_set_id | u(4) |
| sps_video_parameter_set_id | u(4) |
| sps_max_sublayers_minus1 | u(3) |
| sps_chroma_format_idc | u(2) |
| sps_log2_ctu_size_minus5 | u(2) |
| sps_ptl_dpb_hrd_params_present_flag | u(1) |
| if( sps_ptl_dpb_hrd_params_present_flag ) | |
| profile_tier_level( 1, sps_max_sublayers_minus1 ) | |
| sps_gdr_enabled_flag | u(1) |
| sps_ref_pic_resampling_enabled_flag | u(1) |
| if( sps_ref_pic_resampling_enabled_flag ) | |
| sps_res_change_in_clvs_allowed_flag | u(1) |
| sps_pic_width_max_in_luma_samples | ue(v) |
| sps_pic_height_max_in_luma_samples | ue(v) |
| sps_conformance_window_flag | u(1) |
| if( sps_conformance_window_flag ) { | |
| sps_conf_win_left_offset | ue(v) |
| sps_conf_win_right_offset | ue(v) |
| sps_conf_win_top_offset | ue(v) |
| sps_conf_win_bottom_offset | ue(v) |
| } | |
| sps_subpic_info_present_flag | u(1) |
| if( sps_subpic_info_present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| } | |
| for( i = 0; sps_num_subpics_minus1 > 0 && i <= | |
| sps_num_subpics_minus1; i++ ) { | |
| if( !sps_subpic_same_size_flag \| \| i = = 0 ) { | |
| if( i > 0 && sps_pic_width_max_in_luma_samples > CtbSizeY ) | |
| sps_subpic_ctu_top_left_x[ i ] | u(v) |
| if( i > 0 && sps_pic_height_max_in_luma_samples > CtbSizeY ) | |
| sps_subpic_ctu_top_left_y[ i ] | u(v) |
| if( i < sps_num_subpics_minus1 && | |
| sps_pic_width_max_in_luma_samples > CtbSizeY ) | |
| sps_subpic_width_minus1[ i ] | u(v) |
| if( i < sps_num_subpics_minus1 && | |
| sps_pic_height_max_in_luma_samples > CtbSizeY ) | |
| sps_subpic_height_minus1[ i ] | u(v) |
| } | |
| if( !sps_independent_subpics_flag) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len_minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping_present_flag ) | |
| for( i = 0; i <= sps_num_subpics_minus1; i++ ) | |
| sps_subpic_id[ i ] | u(v) |
| } | |
| } | |
| sps_bitdepth_minus8 | ue(v) |
| sps_entropy_coding_sync_enabled_flag | u(1) |
| sps_entry_point_offsets_present_flag | u(1) |
| sps_log2_max_pic_order_cnt_lsb_minus4 | u(4) |
| sps_poc_msb_cycle_flag | u(1) |
| if( sps_poc_msb_cycle_flag ) | |
| sps_poc_msb_cycle_len_minus1 | ue(v) |
| sps_num_extra_ph_bytes | u(2) |
| for( i = 0; i < (sps_num_extra_ph_bytes * 8 ); i++ ) | |
| sps_extra_ph_bit_present_flag[ i ] | u(1) |
| sps_num_extra_sh_bytes | u(2) |
| for( i = 0; i < (sps_num_extra_sh_bytes * 8 ); i++ ) | |
| sps_extra_sh_bit_present_flag[ i ] | u(1) |
| if( sps_ptl_dpb_hrd_params_present_flag ) { | |
| if( sps_max_sublayers_minus1 > 0 ) | |
| sps_sublayer_dpb_params_flag | u(1) |
| dpb_parameters( sps_max_sublayers_minus1, | |
| sps_sublayer_dpb_params_flag ) | |
| } | |
| sps_log2_min_luma_coding_block_size_minus2 | ue(v) |
| sps_partition_constraints_override_enabled_flag | u(1) |
| sps_log2_diff_min_qt_min_cb_intra_slice_luma | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_chroma_format_idc != 0 ) | |
| sps_qtbtt_dual_tree_intra_flag | u(1) |
| if( sps_qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_log2_diff_min_qt_min_cb_inter_slice | ue(v) |
| sps_max_mtt_hierarchy_depth_inter_slice | ue(v) |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| if( CtbSizeY > 32 ) | |
| sps_max_luma_transform_size_64_flag | u(1) |
| sps_transform_skip_enabled_flag | u(1) |
| if( sps_transform_skip_enabled_flag ) { | |
| sps_log2_transform_skip_max_size_minus2 | ue(v) |
| sps_bdpcm_enabled_flag | u(1) |
| } | |
| sps_mts_enabled_flag | u(1) |
| if( sps_mts_enabled_flag ) { | |
| sps_explicit_mts_intra_enabled_flag | u(1) |
| sps_explicit_mts_inter_enabled_flag | u(1) |
| } | |
| sps_lfnst_enabled_flag | u(1) |
| if( sps_chroma_format_idc != 0 ) { | |
| sps_joint_cbcr_enabled_flag | u(1) |
| sps_same_qp_table_for_chroma_flag | u(1) |
| numQpTables = sps_same_qp_table_for_chroma_flag ? 1 : | |
| ( sps_joint_cbcr_enabled_flag ? 3 : 2 ) | |
| for( i = 0; i < numQpTables; i++ ) { | |
| sps_qp_table_start_minus26[ i ] | se(v) |
| sps_num_points_in_qp_table_minus1[ i ] | ue(v) |
| for( j = 0; j <= sps_num_points_in_qp_table_minus1[ i ]; j++ ) { | |
| sps_delta_qp_in_val_minus1[ i ][ j ] | ue(v) |
| sps_delta_qp_diff_val[ i ][ j ] | ue(v) |
| } | |
| } | |
| } | |
| sps_sao_enabled_flag | u(1) |
| sps_alf_enabled_flag | u(1) |
| if( sps_alf_enabled_flag && sps_chroma_format_idc != 0 ) | |
| sps_ccalf_enabled_flag | u(1) |
| sps_lmcs_enabled_flag | u(1) |
| sps_weighted_pred_flag | u(1) |
| sps_weighted_bipred_flag | u(1) |
| sps_long_term_ref_pics_flag | u(1) |
| if( sps_video_parameter_set_id > 0 ) | |
| sps_inter_layer_prediction_enabled_flag | u(1) |
| sps_idr_rpl_present_flag | u(1) |
| sps_rpl1_same_as_rpl0_flag | u(1) |
| for( i = 0; i < ( sps_rpl1_same_as_rpl0_flag ? 1 : 2 ); i++ ) { | |
| sps_num_ref_pic_lists[ i ] | ue(v) |
| for( j = 0; j < sps_num_ref_pic_lists[ i ]; j++) | |
| ref_pic_list_struct( i, j ) | |
| } | |
| sps_ref_wraparound_enabled_flag | u(1) |
| sps_temporal_mvp_enabled_flag | u(1) |
| if( sps_temporal_mvp_enabled_flag ) | |
| sps_sbtmvp_enabled_flag | u(1) |
| sps_amvr_enabled_flag | u(1) |
| sps_bdof_enabled_flag | u(1) |
| if( sps_bdof_enabled_flag ) | |
| sps_bdof_control_present_in_ph_flag | u(1) |
| sps_smvd_enabled_flag | u(1) |
| sps_dmvr_enabled_flag | u(1) |
| if( sps_dmvr_enabled_flag) | |
| sps_dmvr_control_present_in_ph_flag | u(1) |
| sps_mmvd_enabled_flag | u(1) |
| if( sps_mmvd_enabled_flag ) | |
| sps_mmvd_fullpel_only_enabled_flag | u(1) |
| sps_six_minus_max_num_merge_cand | ue(v) |
| sps_sbt_enabled_flag | u(1) |
| sps_affine_enabled_flag | u(1) |
| if( sps_affine_enabled_flag ) { | |
| sps_five_minus_max_num_subblock_merge_cand | ue(v) |
| sps_6param_affme_enabled_flag | u(1) |
| if( sps_amvr_enabled_flag ) | |
| sps_affine_amvr_enabled_flag | u(1) |
| sps_affine_prof_enabled_flag | u(1) |
| if( sps_affine_prof_enabled_flag ) | |
| sps_prof_control_present_in_ph_flag | u(1) |
| } | |
| sps_bcw_enabled_flag | u(1) |
| sps_ciip_enabled_flag | u(1) |
| if( MaxNumMergeCand >= 2 ) { | |
| sps_gpm_enabled_flag | u(1) |
| if( sps_gpm_enabled_flag && MaxNumMergeCand >= 3 ) | |
| sps_max_num_merge_cand_minus_max_num_gpm_cand | ue(v) |
| } | |
| sps_log2_parallel_merge_level_minus2 | ue(v) |
| sps_isp_enabled_flag | u(1) |
| sps_mrl_enabled_flag | u(1) |
| sps_mip_enabled_flag | u(1) |
| if( sps_chroma_format_idc != 0 ) | |
| sps_cclm_enabled_flag | u(1) |
| if( sps_chroma_format_idc = = 1 ) { | |
| sps_chroma_horizontal_collocated_flag | u(1) |
| sps_chroma_vertical_collocated_flag | u(1) |
| } | |
| sps_palette_enabled_flag | u(1) |
| if( sps_chroma_format_idc = = 3 | |
| && !sps_max_luma_transform_size_64_flag ) | |
| sps_act_enabled_flag | u(1) |
| if( sps_transform_skip_enabled_flag \| \| sps_palette_enabled_flag ) | |
| sps_min_qp_prime_ts | ue(v) |
| sps_ibc_enabled_flag | u(1) |
| if( sps_ibc_enabled_flag ) | |
| sps_six_minus_max_num_ibc_merge_cand | ue(v) |
| sps_ladf_enabled_flag | u(1) |
| if( sps_ladf_enabled_flag ) { | |
| sps_num_ladf_intervals_minus2 | u(2) |
| sps_ladf_lowest_interval_qp_offset | se(v) |
| for( i = 0; i < sps_num_ladf_intervals_minus2 + 1; i++ ) { | |
| sps_ladf_qp_offset[ i ] | se(v) |
| sps_ladf_delta_threshold_minus1[ i ] | ue(v) |
| } | |
| } | |
| sps_explicit_scaling_list_enabled_flag | u(1) |
| if( sps_lfnst_enabled_flag && sps_explicit_scaling_list_enabled_flag ) | |
| sps_scaling_matrix_for_lfnst_disabled_flag | u(1) |
| if( sps_act_enabled_flag && sps_explicit_scaling_list_enabled_flag ) | |
| sps_scaling_matrix_for_alternative_colour_space_disabled_flag | u(1) |
| if( sps_scaling_matrix_for_alternative_colour_space_disabled_flag ) | |
| sps_scaling_matrix_designated_colour_space_flag | u(1) |
| sps_dep_quant_enabled_flag | u(1) |
| sps_sign_data_hiding_enabled_flag | u(1) |
| sps_virtual_boundaries_enabled_flag | u(1) |
| if( sps_virtual_boundaries_enabled_flag ) { | |
| sps_virtual_boundaries_present_flag | u(1) |
| if( sps_virtual_boundaries_present_flag ) { | |
| sps_num_ver_virtual_boundaries | ue(v) |
| for( i = 0; i < sps_num_ver_virtual_boundaries; i++ ) | |
| sps_virtual_boundary_pos_x_minus1[ i ] | ue(v) |
| sps_num_hor_virtual_boundaries | ue(v) |
| for( i = 0; i < sps_num_hor_virtual_boundaries; i++ ) | |
| sps_virtual_boundary_pos_y_minus1[ i ] | ue(v) |
| } | |
| } | |
| if( sps_ptl_dpb_hrd_params_present_flag ) { | |
| sps_timing_hrd_params_present_flag | u(1) |
| if( sps_timing_hrd_params_present_flag ) { | |
| general_timing_hrd_parameters( ) | |
| if( sps_max_sublayers_minus1 > 0 ) | |
| sps_sublayer_cpb_params_present_flag | u(1) |
| firstSubLayer = sps_sublayer_cpb_params_present_flag ? 0 : | |
| sps_max_sublayers_minus1 | |
| ols_timing_hrd_parameters( firstSubLayer, | |
| sps_max_sublayers_minus1 ) | |
| } | |
| } | |
| sps_field_seq_flag | u(1) |
| sps_vui_parameters_present_flag | u(1) |
| if( sps_vui_parameters_present_flag ) { | |
| sps_vui_payload_size_minus1 | ue(v) |
| while( !byte_aligned( ) ) | |
| sps_vui_alignment_zero_bit | f(1) |
| vui_payload( sps_vui_payload_size_minus1 + 1 ) | |
| } | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

With respect to Table 3, JVET-T2001 provides the following semantics:

An SPS RBSP shall be available to the decoding process prior to it being referenced, included in at least one AU with TemporalId equal to 0 or provided through external means.

All SPS NAL units with a particular value of sps_seq_parameter_set_id in a CVS shall have the same content.

sps_seq_parameter_set_id provides an identifier for the SPS for reference by other syntax elements.

SPS NAL units, regardless of the nuh_layer_id values, share the same value space of sps_seq_parameter_set_id.

Let spsLayerId be the value of the nuh_layer_id of a particular SPS NAL unit, and vclLayerId be the value of the nuh_layer_id of a particular VCL NAL unit. The particular VCL NAL unit shall not refer to the particular SPS NAL unit unless spsLayerId is less than or equal to vclLayerId and all OLSs specified by the VPS that contain the layer with nuh_layer_id equal to vclLayerId also contain the layer with nuh_layer_id equal to spsLayerId.

NOTE—In a CVS that contains only one layer, the nuh_layer_id of referenced SPSs is equal to the nuh_layer_id of the VCL NAL units.
sps_video_parameter_set_id, when greater than 0, specifies the value of vps_video_parameter_set_id for the VPS referred to by the SPS.
When sps_video_parameter_set_id is equal to 0, the following applies:
The SPS does not refer to a VPS, and no VPS is referred to when decoding each CLVS referring to the SPS.
The value of vps_max_layers_minus1 is inferred to be equal to 0.
The CVS shall contain only one layer (i.e., all VCL NAL unit in the CVS shall have the same value of nuh_layer_id).
The value of GeneralLayerIdx[nuh_layer_id] is set equal to 0.
The value of vps_independent_layer_flag[GeneralLayerIdx[nuh_layer_id] ] is inferred to be equal to 1.
The value of TotalNumOlss is set equal to 1, the value of NumLayersInOls[0] is set equal to 1, and value of vps_layer_id[0] is inferred to be equal to the value of nuh_layer_id of all the VCL NAL units, and the value of LayerIdInOls[0][0] is set equal to vps_layer_id[0].
   NOTE—When sps_video_parameter_set_id is equal to 0, the phrase “layers specified by the VPS” used in the specification refers to the only present layer that has nuh_layer_id equal to vps_layer_id[0], and the phrase “OLSs specified by the VPS” used in the specification refers to the only present OLS that has OLS index equal to 0 and LayerIdInOls[0][0] equal to vps_layer_id[0].
      When vps_independent_layer_flag[GeneralLayerIdx[nuh_layer_id] ] is equal to 1, the SPS referred to by a CLVS with a particular nuh_layer_id value nuhLayerId shall have nuh_layer_id equal to nuhLayerId.
      The value of sps_video_parameter_set_id shall be the same in all SPSs that are referred to by CLVSs in a CVS.
      sps_max_sublayers_minus1 plus 1 specifies the maximum number of temporal sublayers that could be present in each CLVS referring to the SPS.
      If sps_video_parameter_set_id is greater than 0, the value of sps_max_sublayers_minus1 shall be in the range of 0 to vps_max_sublayers_minus1, inclusive.
      Otherwise (sps_video_parameter_set_id is equal to 0), the following applies:
The value of sps_max_sublayers_minus1 shall be in the range of 0 to 6, inclusive.
The value of vps_max_sublayers_minus1 is inferred to be equal to sps_max_sublayers_minus1.
The value of NumSubLayersInLayerInOLS[0][0] is inferred to be equal to sps_max_sublayers_minus1+1.
The value of vps_ols_ptl_idx[0] is inferred to be equal to 0, and the value of vps_ptl_max_tid[vps_ols_ptl_idx[0] ], i.e., vps_ptl_max_tid[0], is inferred to be equal to sps_max_sublayers_minus1.
   sps_chroma_format_idc specifies the chroma sampling relative to the luma sampling as specified in subclause 6.2.
   When sps_video_parameter_set_id is greater than 0 and the SPS is referenced by a layer that is included in the i-th multi-layer OLS specified by the VPS for any i in the range of 0 to NumMultiLayerOlss−1, inclusive, it is a requirement of bitstream conformance that the value of sps_chroma_format_idc shall be less than or equal to the value of vps_ols_dpb_chroma_format[i].
   sps_log2_ctu_size_minus5 plus 5 specifies the luma coding tree block size of each CTU. The value of sps_log2_ctu_size_minus5 shall be in the range of 0 to 2, inclusive. The value 3 for sps_log2_ctu_size_minus5 is reserved for future use by ITU-T|ISO/IEC. Decoders conforming to this version of this Specification shall ignore the CLVSs with sps_log2_ctu_size_minus5 equal to 3.
   he variables CtbLog2SizeY and CtbSizeY are derived as follows:

$$Ctb Log 2 SizeY = sps\_log2 \_ctu \_size \_minus5 + 5$$

$$CtbSizeY = 1 ≪ Ctb Log 2 SizeY$$

sps_ptl_dpb_hrd_params_present_flag equal to 1 specifies that a profile_tier_level( ) syntax structure and a dpb_parameters( ) syntax structure are present in the SPS, and a general_timing_hrd_parameters( ) syntax structure and an ols_timing_hrd_parameters( ) syntax structure could also be present in the SPS. sps_ptl_dpb_hrd_params_present_flag equal to 0 specifies that none of these four syntax structures is present in the SPS.
When sps_video_parameter_set_id is greater than 0 and there is an OLS that contains only one layer with nuh_layer_id equal to the nuh_layer_id of the SPS, or when sps_video_parameter_set_id is equal to 0, the value of sps_ptl_dpb_hrd_params_present_flag shall be equal to 1.
sps_gdr_enabled_flag equal to 1 specifies that GDR pictures are enabled and could be present in the CLVS. sps_gdr_enabled_flag equal to 0 specifies that GDR pictures are disabled and not present in the CLVS.
sps_ref_pic_resampling_enabled_flag equal to 1 specifies that reference picture resampling is enabled and a current picture referring to the SPS might have slices that refer to a reference picture in an active entry of an RPL that has one or more of the following seven parameters different than that of the current picture: 1) pps_pic_width_in_luma_samples, 2) pps_pic_height_in_luma_samples, 3) pps_scaling_win_left_offset, 4) pps_scaling_win_right_offset, 5) pps_scaling_win_top_offset, 6) pps_scaling_win_bottom_offset, and 7) sps_num_subpics_minus1. sps_ref_pic_resampling_enabled_flag equal to 0 specifies that reference picture resampling is disabled and no current picture referring to the SPS has slices that refer to a reference picture in an active entry of an RPL that has one or more of these seven parameters different than that of the current picture.
NOTE—When sps_ref_pic_resampling_enabled_flag is equal to 1, for a current picture the reference picture that has one or more of these seven parameters different than that of the current picture could either belong to the same layer or a different layer than the layer containing the current picture.
   sps_res_change_in_clvs_allowed_flag equal to 1 specifies that the picture spatial resolution might change within a CLVS referring to the SPS. sps_res_change_in_clvs_allowed_flag equal to 0 specifies that the picture spatial resolution does not change within any CLVS referring to the SPS. When not present, the value of sps_res_change_in_clvs_allowed_flag is inferred to be equal to 0.
   sps_pic_width_max_in_luma_samples specifies the maximum width, in units of luma samples, of each decoded picture referring to the SPS. sps_pic_width_max_in_luma_samples shall not be equal to 0 and shall be an integer multiple of Max(8, MinCbSizeY).
   When sps_video_parameter_set_id is greater than 0 and the SPS is referenced by a layer that is included in the i-th multi-layer OLS specified by the VPS for any i in the range of 0 to NumMultiLayerOlss−1, inclusive, it is a requirement of bitstream conformance that the value of sps_pic_width_max_in_luma_samples shall be less than or equal to the value of vps_ols_dpb_pic_width[i].
   sps_pic_height_max_in_luma_samples specifies the maximum height, in units of luma samples, of each decoded picture referring to the SPS. sps_pic_height_max_in_luma_samples shall not be equal to 0 and shall be an integer multiple of Max(8, MinCbSizeY).
   When sps_video_parameter_set_id is greater than 0 and the SPS is referenced by a layer that is included in the i-th multi-layer OLS specified by the VPS for any i in the range of 0 to NumMultiLayerOlss−1, inclusive, it is a requirement of bitstream conformance that the value of sps_pic_height_max_in_luma_samples shall be less than or equal to the value of vps_ols_dpb_pic_height[i].
   sps_conformance_window_flag equal to 1 indicates that the conformance cropping window offset parameters follow next in the SPS. sps_conformance_window_flag equal to 0 indicates that the conformance cropping window offset parameters are not present in the SPS.
   sps_conf_win_left_offset, sps_conf_win_right_offset, sps_conf_win_top_offset, and sps_conf_win_bottom_offset specify the cropping window that is applied to pictures with pps_pic_width_in_luma_samples equal to sps_pic_width_max_in_luma_samples and pps_pic_height_in_luma_samples equal to sps_pic_height_max_in_luma_samples. When sps_conformance_window_flag is equal to 0, the values of sps_conf_win_left_offset, sps_conf_win_right_offset, sps_conf_win_top_offset, and sps_conf_win_bottom_offset are inferred to be equal to 0.
   The conformance cropping window contains the luma samples with horizontal picture coordinates from SubWidthC*sps_conf_win_left_offset to sps_pic_width_max_in_luma_samples−(SubWidthC*sps_conf_win_right_offset+1) and vertical picture coordinates from SubHeightC*sps_conf_win_top_offset to sps_pic_height_max_in_luma_samples−(SubHeightC*sps_conf_win_bottom_offset+1), inclusive.
   The value of SubWidthC*(sps_conf_win_left_offset+sps_conf_win_right_offset) shall be less than sps_pic_width_max_in_luma_samples, and the value of SubHeightC*(sps_conf_win_top_offset+sps_conf_win_bottom_offset) shall be less than sps_pic_height_max_in_luma_samples.
   When sps_chroma_format_idc is not equal to 0, the corresponding specified samples of the two chroma arrays are the samples having picture coordinates (x/SubWidthC, y/SubHeightC), where (x, y) are the picture coordinates of the specified luma samples.
NOTE—The conformance cropping window offset parameters are only applied at the output. All internal decoding processes are applied to the uncropped picture size.
   sps_subpic_info_present_flag equal to 1 specifies that subpicture information is present for the CLVS and there might be one or more than one subpicture in each picture of the CLVS. sps_subpic_info_present_flag equal to 0 specifies that subpicture information is not present for the CLVS and there is only one subpicture in each picture of the CLVS.
   When sps_res_change_in_clvs_allowed_flag is equal to 1, the value of sps_subpic_info_present_flag shall be equal to 0.
NOTE—When a bitstream is the result of a subpicture sub-bitstream extraction process and contains only a subset of the subpictures of the input bitstream to the subpicture sub-bitstream extraction process, it might be required to set the value of sps_subpic_info_present_flag equal to 1 in the RBSP of the SPSs.
   sps_num_subpics_minus1 plus 1 specifies the number of subpictures in each picture in the CLVS. The value of sps_num_subpics_minus1 shall be in the range of 0 to MaxSlicesPerAu−1, inclusive, where MaxSlicesPerAu is specified. When not present, the value of sps_num_subpics_minus1 is inferred to be equal to 0.
   sps_independent_subpics_flag equal to 1 specifies that all subpicture boundaries in the CLVS are treated as picture boundaries and there is no loop filtering across the subpicture boundaries. sps_independent_subpics_flag equal to 0 does not impose such a constraint. When not present, the value of sps_independent_subpics_flag is inferred to be equal to 1.
   sps_subpic_same_size_flag equal to 1 specifies that all subpictures in the CLVS have the same width specified by sps_subpic_width_minus1 [0] and the same height specified by sps_subpic_height_minus1[0]. sps_subpic_same_size_flag equal to 0 does not impose such a constraint. When not present, the value of sps_subpic_same_size_flag is inferred to be equal to 0. Let the variable tmpWidthVal be set equal to (sps_pic_width_max_in_luma_samples+CtbSizeY−1)/CtbSizeY, and the variable tmpHeightVal be set equal to (sps_pic_height_max_in_luma_samples+CtbSizeY−1)/CtbSizeY.
   sps_subpic_ctu_top_left_x[i] specifies horizontal position of top-left CTU of i-th subpicture in unit of CtbSizeY. The length of the syntax element is Ceil(Log2(tmpWidthVal)) bits.
   When not present, the value of sps_subpic_ctu_top_left_x[i] is inferred as follows:
If sps_subpic_same_size_flag is equal to 0 or i is equal to 0, the value of sps_subpic_ctu_top_left_x[i] is inferred to be equal to 0.
Otherwise, the value of sps_subpic_ctu_top_left_x[i] is inferred to be equal to (i % numSubpicCols)*(sps_subpic_width_minus1[0]+1).
   When sps_subpic_same_size_flag is equal to 1, the variable numSubpicCols, specifying the number of subpicture columns in each picture in the CLVS, is derived as follows:

$$numSubpicCols = tmpWidthVal / ( sps\_subpic \_width \_minus1 [ 0 ] + 1 )$$

When sps_subpic_same_size_flag is equal to 1, the value of numSubpicCols*tmpHeightVal/(sps_subpic_height_minus1[0]+1)−1 shall be equal to sps_num_subpics_minus1.
sps_subpic_ctu_top_left_y[i] specifies vertical position of top-left CTU of i-th subpicture in unit of CtbSizeY. The length of the syntax element is Ceil(Log2(tmpHeightVal)) bits.
When not present, the value of sps_subpic_ctu_top_left_y[i] is inferred as follows:
If sps_subpic_same_size_flag is equal to 0 or i is equal to 0, the value of sps_subpic_ctu_top_left_y[i] is inferred to be equal to 0.
Otherwise, the value of sps_subpic_ctu_top_left_y[i] is inferred to be equal to (i/numSubpicCols)*(sps_subpic_height_minus1[0]+1).
   sps_subpic_width_minus1[i] plus 1 specifies the width of the i-th subpicture in units of CtbSizeY. The length of the syntax element is Ceil(Log2(tmpWidthVal)) bits.
   When not present, the value of sps_subpic_width_minus1[i] is inferred as follows:
If sps_subpic_same_size_flag is equal to 0 or i is equal to 0, the value of sps_subpic_width_minus1[i] is inferred to be equal to tmpWidthVal−sps_subpic_ctu_top_left_x[i]−1.
Otherwise, the value of sps_subpic_width_minus1 [i] is inferred to be equal to sps_subpic_width_minus1[0].
   When sps_subpic_same_size_flag is equal to 1, the value of tmpWidthVal % (sps_subpic_width_minus1[0]+1) shall be equal to 0.
   sps_subpic_height_minus1[i] plus 1 specifies the height of the i-th subpicture in units of CtbSizeY. The length of the syntax element is Ceil(Log2(tmpHeightVal)) bits.
   When not present, the value of sps_subpic_height_minus1[i] is inferred as follows:
If sps_subpic_same_size_flag is equal to 0 or i is equal to 0, the value of sps_subpic_height_minus1[i] is inferred to be equal to tmpHeightVal−sps_subpic_ctu_top_left_y[i]−1.
Otherwise, the value of sps_subpic_height_minus1[i] is inferred to be equal to sps_subpic_height_minus1[0].
   When sps_subpic_same_size_flag is equal to 1, the value of tmpHeightVal % (sps_subpic_height_minus1[0]+1) shall be equal to 0.
   It is a requirement of bitstream conformance that the shapes of the subpictures shall be such that each subpicture, when decoded, shall have its entire left boundary and entire top boundary consisting of picture boundaries or consisting of boundaries of previously decoded subpictures. For each subpicture with subpicture index i in the range of 0 to sps_num_subpics_minus1, inclusive, it is a requirement of bitstream conformance that all of the following conditions are true:
The value of (sps_subpic_ctu_top_left_x[i]*CtbSizeY) shall be less than (sps_pic_width_max_in_luma_samples−sps_conf_win_right_offset*SubWidthC).
The value of ((sps_subpic_ctu_top_left_x[i]+sps_subpic_width_minus1[i]+1)*CtbSizeY) shall be greater than (sps_conf_win_left_offset*SubWidthC).
The value of (sps_subpic_ctu_top_left_y[i]*CtbSizeY) shall be less than (sps_pic_height_max_in_luma_samples−sps_conf_win_bottom_offset*SubHeightC).
The value of ((sps_subpic_ctu_top_left_y[i]+sps_subpic_height_minus1[i]+1)*CtbSizeY) shall be greater than (sps_conf_win_top_offset*SubHeightC).
   sps_subpic_treated_as_pic_flag[i] equal to 1 specifies that the i-th subpicture of each coded picture in the CLVS is treated as a picture in the decoding process excluding in-loop filtering operations. sps_subpic_treated_as_pic_flag[i] equal to 0 specifies that the i-th subpicture of each coded picture in the CLVS is not treated as a picture in the decoding process excluding in-loop filtering operations. When not present, the value of sps_subpic_treated_as_pic_flag[i] is inferred to be equal to 1.
   sps_loop_filter_across_subpic_enabled_flag[i] equal to 1 specifies that in-loop filtering operations across subpicture boundaries is enabled and might be performed across the boundaries of the i-th subpicture in each coded picture in the CLVS. sps_loop_filter_across_subpic_enabled_flag[i] equal to 0 specifies that in-loop filtering operations across subpicture boundaries is disabled and are not performed across the boundaries of the i-th subpicture in each coded picture in the CLVS. When not present, the value of sps_loop_filter_across_subpic_enabled_pic_flag[i] is inferred to be equal to 0.
   sps_subpic_id_len_minus1 plus 1 specifies the number of bits used to represent the syntax element sps_subpic_id[i], the syntax elements pps_subpic_id[i], when present, and the syntax element sh_subpic_id, when present. The value of sps_subpic_id_len_minus1 shall be in the range of 0 to 15, inclusive. The value of 1<<(sps_subpic_id_len_minus1+1) shall be greater than or equal to sps_num_subpics_minus1+1.
   sps_subpic_id_mapping_explicitly_signalled_flag equal to 1 specifies that the subpicture ID mapping is explicitly signalled, either in the SPS or in the PPSs referred to by coded pictures of the CLVS. sps_subpic_id_mapping_explicitly_signalled_flag equal to 0 specifies that the subpicture ID mapping is not explicitly signalled for the CLVS. When not present, the value of sps_subpic_id_mapping_explicitly_signalled_flag is inferred to be equal to 0.
   sps_subpic_id_mapping_present_flag equal to 1 specifies that the subpicture ID mapping is signalled in the SPS when sps_subpic_id_mapping_explicitly_signalled_flag is equal to 1. sps_subpic_id_mapping_present_flag equal to 0 specifies that subpicture ID mapping is signalled in the PPSs referred to by coded pictures of the CLVS when sps_subpic_id_mapping_explicitly_signalled_flag is equal to 1.
   sps_subpic_id[i] specifies the subpicture ID of the i-th subpicture. The length of the sps_subpic_id[i] syntax element is sps_subpic_id_len_minus1+1 bits.
   sps_bitdepth_minus8 specifies the bit depth of the samples of the luma and chroma arrays, BitDepth, and the value of the luma and chroma quantization parameter range offset, QpBdOffset, as follows:

$$BitDepth = 8 + sps\_bitdepth \_minus8$$

$$QpBdOffset = 6 * sps\_bitdepth \_minus8$$

sps_bitdepth_minus8 shall be in the range of 0 to 2, inclusive.
When sps_video_parameter_set_id is greater than 0 and the SPS is referenced by a layer that is included in the i-th multi-layer OLS specified by the VPS for any i in the range of 0 to NumMultiLayerOlss−1, inclusive, it is a requirement of bitstream conformance that the value of sps_bitdepth_minus8 shall be less than or equal to the value of vps_ols_dpb_bitdepth_minus8[i].
sps_entropy_coding_sync_enabled_flag equal to 1 specifies that a specific synchronization process for context variables is invoked before decoding the CTU that includes the first CTB of a row of CTBs in each tile in each picture referring to the SPS, and a specific storage process for context variables is invoked after decoding the CTU that includes the first CTB of a row of CTBs in each tile in each picture referring to the SPS. sps_entropy_coding_sync_enabled_flag equal to 0 specifies that no specific synchronization process for context variables is required to be invoked before decoding the CTU that includes the first CTB of a row of CTBs in each tile in each picture referring to the SPS, and no specific storage process for context variables is required to be invoked after decoding the CTU that includes the first CTB of a row of CTBs in each tile in each picture referring to the SPS.
NOTE—When sps_entropy_coding_sync_enabled_flag is equal to 1, the so-called wavefront parallel processing (WPP) is enabled.
   sps_entry_point_offsets_present_flag equal to 1 specifies that signalling for entry point offsets for tiles or tile-specific CTU rows could be present in the slice headers of pictures referring to the SPS. sps_entry_point_offsets_present_flag equal to 0 specifies that signalling for entry point offsets for tiles or tile-specific CTU rows are not present in the slice headers of pictures referring to the SPS.
   sps_log2_max_pic_order_cnt_lsb_minus4 specifies the value of the variable MaxPicOrderCntLsb that is used in the decoding process for picture order count as follows:

$$Max PicOrderCntLsb = {2}^{( sps \_ log 2 \_ max \_ pic \_ order \_ cnt \_ lsb \_ minus 4 + 4 )}$$

The value of sps_log2_max_pic_order_cnt_lsb_minus4 shall be in the range of 0 to 12, inclusive.
sps_poc_msb_cycle_flag equal to 1 specifies that the ph_poc_msb_cycle_present_flag syntax element is present in PH syntax structures referring to the SPS. sps_poc_msb_cycle_flag equal to 0 specifies that the ph_poc_msb_cycle_present_flag syntax element is not present in PH syntax structures referring to the SPS.
sps_poc_msb_cycle_len_minus1 plus 1 specifies the length, in bits, of the ph_poc_msb_cycle_val syntax elements, when present in PH syntax structures referring to the SPS. The value of sps_poc_msb_cycle_len_minus1 shall be in the range of 0 to 32−sps_log2_max_pic_order_cnt_lsb_minus4−5, inclusive.
sps_num_extra_ph_bytes specifies the number of bytes of extra bits in the PH syntax structure for coded pictures referring to the SPS. The value of sps_num_extra_ph_bytes shall be equal to 0 in bitstreams conforming to this version of this Specification. Although the value of sps_num_extra_ph_bytes is required to be equal to 0 in this version of this Specification, decoders conforming to this version of this Specification shall allow the value of sps_num_extra_ph_bytes equal to 1 or 2 to appear in the syntax.
sps_extra_ph_bit_present_flag[i] equal to 1 specifies that the i-th extra bit is present in PH syntax structures referring to the SPS. sps_extra_ph_bit_present_flag[i] equal to 0 specifies that the i-th extra bit is not present in PH syntax structures referring to the SPS.
The variable NumExtraPhBits is derived as follows:

```
NumExtraPhBits = 0
for( i = 0; i < ( sps_num_extra_ph_bytes * 8 ); i++ )
  if( sps_extra_ph_bit_present_flag[ i ] )
    NumExtraPhBits++
```

sps_num_extra_sh_bytes specifies the number of bytes of extra bits in the slice headers for coded pictures referring to the SPS. The value of sps_num_extra_sh_bytes shall be equal to 0 in bitstreams conforming to this version of this Specification. Although the value of sps_num_extra_sh_bytes is required to be equal to 0 in this version of this Specification, decoders conforming to this version of this Specification shall allow the value of sps_num_extra_sh_bytes equal to 1 or 2 to appear in the syntax.
sps_extra_sh_bit_present_flag[i] equal to 1 specifies that the i-th extra bit is present in the slice headers of pictures referring to the SPS. sps_extra_sh_bit_present_flag[i] equal to 0 specifies that the i-th extra bit is not present in the slice headers of pictures referring to the SPS.
The variable NumExtraShBits is derived as follows:

```
NumExtraShBits = 0
for( i = 0; i < ( sps_num_extra_sh_bytes * 8 ); i++ )
  if( sps_extra_sh_bit_present_flag[ i ] )
    NumExtraShBits++
```

sps_sublayer_dpb_params_flag is used to control the presence of dpb_max_dec_pic_buffering_minus1[i], dpb_max_num_reorder_pics[i], and dpb_max_latency_increase_plus1[i] syntax elements in the dpb_parameters( ) syntax strucure in the SPS for i in range from 0 to sps_max_sublayers_minus1−1, inclusive, when sps_max_sublayers_minus1 is greater than 0. When not present, the value of sps_sublayer_dpb_params_flag is inferred to be equal to 0.
sps_log2_min_luma_coding_block_size_minus2 plus 2 specifies the minimum luma coding block size. The value range of sps_log2_min_luma_coding_block_size_minus2 shall be in the range of 0 to Min(4, sps_log2_ctu_size_minus5+3), inclusive.
The variables MinCbLog2SizeY, MinCbSizeY, IbcBufWidthY, IbcBufWidthC and Vsize are derived as follows:

$$Min Cb Log 2 SizeY = sps\_log2 \_min \_luma \_coding \_block \_size \_minus2 + 2$$

$$Min CbSizeY = 1 ≪ Min Cb Log 2 SizeY$$

$$IbcBufWidthY = 256 * 128 / CtbSizeY$$

$$IbcBufWidthC = IbcBufWidthY / SubWidthC$$

$$VSize = Min ( 64 , CtbSizeY )$$

The value of MinCbSizeY shall less than or equal to VSize.
The variables CtbWidthC and CtbHeightC, which specify the width and height, respectively, of the array for each chroma CTB, are derived as follows:
If sps_chroma_format_idc is equal to 0 (monochrome), CtbWidthC and CtbHeightC are both set equal to 0.
Otherwise, CtbWidthC and CtbHeightC are derived as follows:

$$CtbWidthC = CtbSizeY / SubWidthC$$

$$CtbHeightC = CtbSizeY / SubHeightC$$

For log2BlockWidth ranging from 0 to 4 and for log2BlockHeight ranging from 0 to 4, inclusive, the up-right diagonal scan order array initialization process as specified is invoked with 1<<log2BlockWidth and 1<<log2BlockHeight as inputs, and the output is assigned to DiagScanOrder[log2BlockWidth][log2BlockHeight].
For log2BlockWidth ranging from 0 to 6 and for log2BlockHeight ranging from 0 to 6, inclusive, the horizontal and vertical traverse scan order array initialization process as specified is invoked with 1<<log2BlockWidth and 1<<log2BlockHeight as inputs, and the output is assigned to HorTravScanOrder[log2BlockWidth][log2BlockHeight] and VerTravScanOrder[log2BlockWidth][log2BlockHeight].
sps_partition_constraints_override_enabled_flag equal to 1 specifies the presence of ph_partition_constraints_override_flag in PH syntax structures referring to the SPS. sps_partition_constraints_override_enabled_flag equal to 0 specifies the absence of ph_partition_constraints_override_flag in PH syntax structures referring to the SPS.
sps_log2_diff_min_qt_min_cb_intra_slice_luma specifies the default difference between the base 2 logarithm of the minimum size in luma samples of a luma leaf block resulting from quadtree splitting of a CTU and the base 2 logarithm of the minimum coding block size in luma samples for luma CUs in slices with sh_slice_type equal to 2 (I) referring to the SPS. When sps_partition_constraints_override_enabled_flag is equal to 1, the default difference can be overridden by ph_log2_diff_min_qt_min_cb_intra_slice_luma present in PH syntax structures referring to the SPS. The value of sps_log2_diff_min_qt_min_cb_intra_slice_luma shall be in the range of 0 to Min(6, CtbLog2SizeY)−MinCbLog2SizeY, inclusive. The base 2 logarithm of the minimum size in luma samples of a luma leaf block resulting from quadtree splitting of a CTU is derived as follows:

$$Min Qt Log 2 SizeIntraY = sps\_log2 \_diff \_min \_qt \_min \_cb \_intra \_slice \_luma + Min Cb Log 2 SizeY$$

sps_max_mtt_hierarchy_depth_intra_slice_luma specifies the default maximum hierarchy depth for coding units resulting from multi-type tree splitting of a quadtree leaf in slices with sh_slice_type equal to 2 (I) referring to the SPS. When sps_partition_constraints_override_enabled_flag is equal to 1, the default maximum hierarchy depth can be overridden by ph_max_mtt_hierarchy_depth_intra_slice_luma present in PH syntax structures referring to the SPS. The value of sps_max_mtt_hierarchy_depth_intra_slice_luma shall be in the range of 0 to 2*(CtbLog2SizeY−MinCbLog2SizeY), inclusive.
sps_log2_diff_max_bt_min_qt_intra_slice_luma specifies the default difference between the base 2 logarithm of the maximum size (width or height) in luma samples of a luma coding block that can be split using a binary split and the base 2 logarithm of the minimum size (width or height) in luma samples of a luma leaf block resulting from quadtree splitting of a CTU in slices with sh_slice_type equal to 2 (I) referring to the SPS. When sps_partition_constraints_override_enabled_flag is equal to 1, the default difference can be overridden by ph_log2_diff_max_bt_min_qt_luma present in PH syntax structures referring to the SPS. The value of sps_log2_diff_max_bt_min_qt_intra_slice_luma shall be in the range of 0 to CtbLog2SizeY−MinQtLog2SizeIntraY, inclusive. When sps_log2_diff_max_bt_min_qt_intra_slice_luma is not present, the value of sps_log2_diff_max_bt_min_qt_intra_slice_luma is inferred to be equal to 0.
sps_log2_diff_max_tt_min_qt_intra_slice_luma specifies the default difference between the base 2 logarithm of the maximum size (width or height) in luma samples of a luma coding block that can be split using a ternary split and the base 2 logarithm of the minimum size (width or height) in luma samples of a luma leaf block resulting from quadtree splitting of a CTU in slices with sh_slice_type equal to 2 (I) referring to the SPS. When sps_partition_constraints_override_enabled_flag is equal to 1, the default difference can be overridden by ph_log2_diff_max_tt_min_qt_luma present in PH syntax structures referring to the SPS. The value of sps_log2_diff_max_tt_min_qt_intra_slice_luma shall be in the range of 0 to Min(6, CtbLog2SizeY)−MinQtLog2SizeIntraY, inclusive. When sps_log2_diff_max_tt_min_qt_intra_slice_luma is not present, the value of sps_log2_diff_max_tt_min_qt_intra_slice_luma is inferred to be equal to 0.
sps_qtbtt_dual_tree_intra_flag equal to 1 specifies that, for I slices, each CTU is split into coding units with 64×64 luma samples using an implicit quadtree split, and these coding units are the root of two separate coding_tree syntax structure for luma and chroma. sps_qtbtt_dual_tree_intra_flag equal to 0 specifies separate coding_tree syntax structure is not used for I slices. When sps_qtbtt_dual_tree_intra_flag is not present, it is inferred to be equal to 0. When sps_log2_diff_max_bt_min_qt_intra_slice_luma is greater than Min(6, CtbLog2SizeY)−MinQtLog2SizeIntraY, the value of sps_qtbtt_dual_tree_intra_flag shall be equal to 0.
sps_log2_diff_min_qt_min_cb_intra_slice_chroma specifies the default difference between the base 2 logarithm of the minimum size in luma samples of a chroma leaf block resulting from quadtree splitting of a chroma CTU with treeType equal to DUAL_TREE_CHROMA and the base 2 logarithm of the minimum coding block size in luma samples for chroma CUs with treeType equal to DUAL_TREE_CHROMA in slices with sh_slice_type equal to 2 (I) referring to the SPS. When sps_partition_constraints_override_enabled_flag is equal to 1, the default difference can be overridden by ph_log2_diff_min_qt_min_cb_chroma present in PH syntax structures referring to the SPS. The value of sps_log2_diff_min_qt_min_cb_intra_slice_chroma shall be in the range of 0 to Min(6, CtbLog2SizeY)−MinCbLog2SizeY, inclusive. When not present, the value of sps_log2_diff_min_qt_min_cb_intra_slice_chroma is inferred to be equal to 0. The base 2 logarithm of the minimum size in luma samples of a chroma leaf block resulting from quadtree splitting of a CTU with treeType equal to DUAL_TREE_CHROMA is derived as follows:

$$Min Qt Log 2 SizeIntraC = sps\_log2 \_diff \_min \_qt \_min \_cb \_intra \_slice \_chroma + Min Cb Log 2 SizeY$$

sps_max_mtt_hierarchy_depth_intra_slice_chroma specifies the default maximum hierarchy depth for chroma coding units resulting from multi-type tree splitting of a chroma quadtree leaf with treeType equal to DUAL_TREE_CHROMA in slices with sh_slice_type equal to 2 (I) referring to the SPS. When sps_partition_constraints_override_enabled_flag is equal to 1, the default maximum hierarchy depth can be overridden by ph_max_mtt_hierarchy_depth_chroma present in PH syntax structures referring to the SPS. The value of sps_max_mtt_hierarchy_depth_intra_slice_chroma shall be in the range of 0 to 2*(CtbLog2SizeY−MinCbLog2SizeY), inclusive. When not present, the value of sps_max_mtt_hierarchy_depth_intra_slice_chroma is inferred to be equal to 0.
sps_log2_diff_max_bt_min_qt_intra_slice_chroma specifies the default difference between the base 2 logarithm of the maximum size (width or height) in luma samples of a chroma coding block that can be split using a binary split and the base 2 logarithm of the minimum size (width or height) in luma samples of a chroma leaf block resulting from quadtree splitting of a chroma CTU with treeType equal to DUAL_TREE_CHROMA in slices with sh_slice_type equal to 2 (I) referring to the SPS. When sps_partition_constraints_override_enabled_flag is equal to 1, the default difference can be overridden by ph_log2_diff_max_bt_min_qt_chroma present in PH syntax structures referring to the SPS. The value of sps_log2_diff_max_bt_min_qt_intra_slice_chroma shall be in the range of 0 to Min(6, CtbLog2SizeY)−MinQtLog2SizeIntraC, inclusive. When sps_log2_diff_max_bt_min_qt_intra_slice_chroma is not present, the value of sps_log2_diff_max_bt_min_qt_intra_slice_chroma is inferred to be equal to 0.
sps_log2_diff_max_tt_min_qt_intra_slice_chroma specifies the default difference between the base 2 logarithm of the maximum size (width or height) in luma samples of a chroma coding block that can be split using a ternary split and the base 2 logarithm of the minimum size (width or height) in luma samples of a chroma leaf block resulting from quadtree splitting of a chroma CTU with treeType equal to DUAL_TREE_CHROMA in slices with sh_slice_type equal to 2 (I) referring to the SPS. When sps_partition_constraints_override_enabled_flag is equal to 1, the default difference can be overridden by ph_log2_diff_max_tt_min_qt_chroma present in PH syntax structures referring to the SPS. The value of sps_log2_diff_max_tt_min_qt_intra_slice_chroma shall be in the range of 0 to Min(6, CtbLog2SizeY)−MinQtLog2SizeIntraC, inclusive. When sps_log2_diff_max_tt_min_qt_intra_slice_chroma is not present, the value of sps_log2_diff_max_tt_min_qt_intra_slice_chroma is inferred to be equal to 0.
sps_log2_diff_min_qt_min_cb_inter_slice specifies the default difference between the base 2 logarithm of the minimum size in luma samples of a luma leaf block resulting from quadtree splitting of a CTU and the base 2 logarithm of the minimum luma coding block size in luma samples for luma CUs in slices with sh_slice_type equal to 0 (B) or 1 (P) referring to the SPS. When sps_partition_constraints_override_enabled_flag is equal to 1, the default difference can be overridden by ph_log2_diff_min_qt_min_cb_inter_slice present in PH syntax structures referring to the SPS. The value of sps_log2_diff_min_qt_min_cb_inter_slice shall be in the range of 0 to Min(6, CtbLog2SizeY)−MinCbLog2SizeY, inclusive. The base 2 logarithm of the minimum size in luma samples of a luma leaf block resulting from quadtree splitting of a CTU is derived as follows:

$$Min Qt Log 2 SizeInterY = sps\_log2 \_diff \_min \_qt \_min \_cb \_inter \_slice + Min Cb Log 2 SizeY$$

sps_max_mtt_hierarchy_depth_inter_slice specifies the default maximum hierarchy depth for coding units resulting from multi-type tree splitting of a quadtree leaf in slices with sh_slice_type equal to 0 (B) or 1 (P) referring to the SPS. When sps_partition_constraints_override_enabled_flag is equal to 1, the default maximum hierarchy depth can be overridden by ph_max_mtt_hierarchy_depth_inter_slice present in PH syntax structures referring to the SPS. The value of sps_max_mtt_hierarchy_depth_inter_slice shall be in the range of 0 to 2*(CtbLog2SizeY−MinCbLog2SizeY), inclusive.
sps_log2_diff_max_bt_min_qt_inter_slice specifies the default difference between the base 2 logarithm of the maximum size (width or height) in luma samples of a luma coding block that can be split using a binary split and the base 2 logarithm of the minimum size (width or height) in luma samples of a luma leaf block resulting from quadtree splitting of a CTU in slices with sh_slice_type equal to 0 (B) or 1 (P) referring to the SPS. When sps_partition_constraints_override_enabled_flag is equal to 1, the default difference can be overridden by ph_log2_diff_max_bt_min_qt_luma present in PH syntax structures referring to the SPS. The value of sps_log2_diff_max_bt_min_qt_inter_slice shall be in the range of 0 to CtbLog2SizeY−MinQtLog2SizeInterY, inclusive. When sps_log2_diff_max_bt_min_qt_inter_slice is not present, the value of sps_log2_diff_max_bt_min_qt_inter_slice is inferred to be equal to 0.
sps_log2_diff_max_tt_min_qt_inter_slice specifies the default difference between the base 2 logarithm of the maximum size (width or height) in luma samples of a luma coding block that can be split using a ternary split and the base 2 logarithm of the minimum size (width or height) in luma samples of a luma leaf block resulting from quadtree splitting of a CTU in slices with sh_slice_type equal to 0 (B) or 1 (P) referring to the SPS. When sps_partition_constraints_override_enabled_flag is equal to 1, the default difference can be overridden by ph_log2_diff_max_tt_min_qt_luma present in PH syntax structures referring to the SPS. The value of sps_log2_diff_max_tt_min_qt_inter_slice shall be in the range of 0 to Min(6, CtbLog2SizeY)−MinQtLog2SizeInterY, inclusive. When sps_log2_diff_max_tt_min_qt_inter_slice is not present, the value of sps_log2_diff_max_tt_min_qt_inter_slice is inferred to be equal to 0.
sps_max_luma_transform_size_64_flag equal to 1 specifies that the maximum transform size in luma samples is equal to 64. sps_max_luma_transform_size_64_flag equal to 0 specifies that the maximum transform size in luma samples is equal to 32. When not present, the value of sps_max_luma_transform_size_64_flag is inferred to be equal to 0.
The variables MinTbLog2SizeY, MaxTbLog2SizeY, MinTbSizeY, and MaxTbSizeY are derived as follows:

$$Min Tb Log 2 SizeY = 2$$

$$Max Tb Log 2 SizeY = sps\_max \_luma \_transform \_size \_ 64 \_flag ? 6 : 5$$

$$Min TbSizeY = 1 ≪ Min Tb Log 2 SizeY$$

$$Max TbSizeY = 1 ≪ Max Tb Log 2 SizeY$$

sps_transform_skip_enabled_flag equal to 1 specifies that transform_skip_flag could be present in the transform unit syntax. sps_transform_skip_enabled_flag equal to 0 specifies that transform_skip_flag is not present in the transform unit syntax.
sps_log2_transform_skip_max_size_minus2 specifies the maximum block size used for transform skip, and shall be in the range of 0 to 3, inclusive.
The variable MaxTsSize is set equal to 1<<(sps_log2_transform_skip_max_size_minus2+2).
sps_bdpcm_enabled_flag equal to 1 specifies that intra_bdpcm_luma_flag and intra_bdpcm_chroma_flag could be present in the coding unit syntax for intra coding units. sps_bdpcm_enabled_flag equal to 0 specifies that intra_bdpcm_luma_flag and intra_bdpcm_chroma_flag are not present in the coding unit syntax for intra coding units. When not present, the value of sps_bdpcm_enabled_flag is inferred to be equal to 0.
sps_mts_enabled_flag equal to 1 specifies that sps_explicit_mts_intra_enabled_flag and sps_explicit_mts_inter_enabled_flag are present in the SPS. sps_mts_enabled_flag equal to 0 specifies that sps_explicit_mts_intra_enabled_flag and sps_explicit_mts_inter_enabled_flag are not present in the SPS.
sps_explicit_mts_intra_enabled_flag equal to 1 specifies that mts_idx could be present in the intra coding unit syntax of the CLVS. sps_explicit_mts_intra_enabled_flag equal to 0 specifies that mts_idx is not present in the intra coding unit syntax of the CLVS. When not present, the value of sps_explicit_mts_intra_enabled_flag is inferred to be equal to 0.
sps_explicit_mts_inter_enabled_flag equal to 1 specifies that mts_idx could be present in the inter coding unit syntax of the CLVS. sps_explicit_mts_inter_enabled_flag equal to 0 specifies that mts_idx is not present in the inter coding unit syntax of the CLVS. When not present, the value of sps_explicit_mts_inter_enabled_flag is inferred to be equal to 0.
sps_lfnst_enabled_flag equal to 1 specifies that lfnst_idx could be present in intra coding unit syntax. sps_lfnst_enabled_flag equal to 0 specifies that lfnst_idx is not present in intra coding unit syntax.
spsjoint_cbcr_enabled_flag equal to 1 specifies that the joint coding of chroma residuals is enabled for the CLVS. sps_joint_cbcr_enabled_flag equal to 0 specifies that the joint coding of chroma residuals is disabled for the CLVS. When not present, the value of sps_joint_cbcr_enabled_flag is inferred to be equal to 0.
sps_same_qp_table_for_chroma_flag equal to 1 specifies that only one chroma QP mapping table is signalled and this table applies to Cb and Cr residuals and additionally to joint Cb-Cr residuals when sps_joint_cbcr_enabled_flag is equal to 1. sps_same_qp_table_for_chroma_flag equal to 0 specifies that chroma QP mapping tables, two for Cb and Cr, and one additional for joint Cb-Cr when sps_joint_cbcr_enabled_flag is equal to 1, are signalled in the SPS. When not present, the value of sps_same_qp_table_for_chroma_flag is inferred to be equal to 1.
sps_qp_table_start_minus26[i] plus 26 specifies the starting luma and chroma QP used to describe the i-th chroma QP mapping table. The value of sps_qp_table_start_minus26[i] shall be in the range of −26−QpBdOffset to 36 inclusive. When not present, the value of sps_qp_table_start_minus26[i] is inferred to be equal to 0.
sps_num_points_in_qp_table_minus1[i] plus 1 specifies the number of points used to describe the i-th chroma QP mapping table. The value of sps_num_points_in_qp_table_minus1[i] shall be in the range of 0 to 36−sps_qp_table_start_minus26[i], inclusive. When not present, the value of sps_num_points_in_qp_table_minus1[0] is inferred to be equal to 0.
sps_delta_qp_in_val_minus1[i][j] specifies a delta value used to derive the input coordinate of the j-th pivot point of the i-th chroma QP mapping table. When not present, the value of sps_delta_qp_in_val_minus1[0][j] is inferred to be equal to 0.
sps_delta_qp_diff_val[i][j] specifies a delta value used to derive the output coordinate of the j-th pivot point of the i-th chroma QP mapping table.
The i-th chroma QP mapping table ChromaQpTable[i] for i=0 . . . numQpTables−1 is derived as follows:

```
qpInVal[ i ][ 0 ] = sps_qp_table_start_minus26[ i ] + 26
qpOutVal[ i ][ 0 ] = qpInVal[ i ][ 0 ]
for( j = 0; j <= sps_num_points_in_qp_table_minus1[ i ]; j++ ) {
  qpInVal[ i ][ j + 1 ] = qpInVal[ i ][ j ] + sps_delta_qp_in_val_minus1[ i ][ j ] + 1
  qpOutVal[ i ][ j + 1 ] = qpOutVal[ i ][ j ] +
    ( sps_delta_qp_in_val_minus1[ i ][ j ] \hat{ } sps_delta_qp_diff_val[ i ][ j ] )
}
ChromaQpTable[ i ][ qpInVal[ i ][ 0 ] ] = qpOutVal[ i ][ 0 ]
for( k = qpInVal[ i ][ 0 ] − 1; k >= −QpBdOffset; k − − )
  ChromaQpTable[ i ][ k ] = Clip3( −QpBdOffset, 63, ChromaQpTable[ i ][ k + 1 ] − 1 )
for( j = 0; j <= sps_num_points_in_qp_table_minus1[ i ]; j++ ) {
  sh = ( sps_delta_qp_in_val_minus1[ i ][j ] + 1 ) >> 1
  for( k = qpInVal[ i ][ j ] + 1, m = 1; k <= qpInVal[ i ][ j + 1 ]; k++, m++ )
    ChromaQpTable[ i ][ k ] = ChromaQpTable[ i ][ qpInVal[ i ][ j ] ] +
      ( ( qpOutVal[ i ][j + 1] − qpOutVal[ i ][ j ] ) * m + sh ) /
( sps_delta_qp_in_val_minus1[ i ][ j ] + 1 )
}
for( k = qpInVal[ i ][ sps_num_points_in_qp_table_minus1[ i ] + 1 ] + 1; k <= 63; k++ )
  ChromaQpTable[ i ][ k ] = Clip3( −QpBdOffset, 63, ChromaQpTable[ i ][ k − 1 ] + 1 )
```

When sps_same_qp_table_for_chroma_flag is equal to 1, ChromaQpTable[1][k] and ChromaQpTable[2][k] are set equal to ChromaQpTable[0][k] for k in the range of QpBdOffset to 63, inclusive.
It is a requirement of bitstream conformance that the values of qpInVal[i][j] and qpOutVal[i][j] shall be in the range of −QpBdOffset to 63, inclusive for i in the range of 0 to numQpTables−1, inclusive, and j in the range of 0 to sps_num_points_in_qp_table_minus1[i]+1, inclusive.
sps_sao_enabled_flag equal to 1 specifies that SAO is enabled for the CLVS. sps_sao_enabled_flag equal to 0 specifies that SAO is disabled for the CLVS.
sps_alf_enabled_flag equal to 1 specifies that ALF is enabled for the CLVS. sps_alf_enabled_flag equal to 0 specifies that ALF is disabled for the CLVS.
sps_ccalf_enabled_flag equal to 1 specifies that CCALF is enabled for the CLVS. sps_ccalf_enabled_flag equal to 0 specifies that CCALF is disabled for the CLVS. When not present, the value of sps_ccalf_enabled_flag is inferred to be equal to 0.
sps_lmcs_enabled_flag equal to 1 specifies that LMCS is enabled for the CLVS. sps_lmcs_enabled_flag equal to 0 specifies that LMCS is disabled for the CLVS. sps_weighted_pred_flag equal to 1 specifies that weighted prediction might be applied to P slices referring to the SPS. sps_weighted_pred_flag equal to 0 specifies that weighted prediction is not applied to P slices referring to the SPS.
sps_weighted_bipred_flag equal to 1 specifies that explicit weighted prediction might be applied to B slices referring to the SPS. sps_weighted_bipred_flag equal to 0 specifies that explicit weighted prediction is not applied to B slices referring to the SPS.
sps_long_term_ref_pics_flag equal to 0 specifies that no LTRP is used for inter prediction of any coded picture in the CLVS. sps_long_term_ref_pics_flag equal to 1 specifies that LTRPs might be used for inter prediction of one or more coded pictures in the CLVS.
sps_inter_layer_prediction_enabled_flag equal to 1 specifies that inter-layer prediction is enabled for the CLVS and ILRPs might be used for inter prediction of one or more coded pictures in the CLVS. sps_inter_layer_prediction_enabled_flag equal to 0 specifies that inter-layer prediction is disabled for the CLVS and no ILRP is used for inter prediction of any coded picture in the CLVS. When sps_video_parameter_set_id is equal to 0, the value of sps_inter_layer_prediction_enabled_flag is inferred to be equal to 0. When vps_independent_layer_flag[GeneralLayerIdx[nuh_layer_id] ] is equal to 1, the value of sps_inter_layer_prediction_enabled_flag shall be equal to 0.
sps_idr_rpl_present_flag equal to 1 specifies that RPL syntax elements could be present in slice headers of slices with nal_unit_type equal to IDR_N_LP or IDR_W_RADL. sps_idr_rpl_present_flag equal to 0 specifies that RPL syntax elements are not present in slice headers of slices with nal_unit_type equal to IDR_N_LP or IDR_W_RADL.
sps_rpl1_same_as_rpl0_flag equal to 1 specifies that the syntax element sps_num_ref_pic_lists[1] and the syntax structure ref_pic_list_struct(1, rplsIdx) are not present and the following applies:
The value of sps_num_ref_pic_lists[1] is inferred to be equal to the value of sps_num_ref_pic_lists[0].
The value of each of syntax elements in ref_pic_list_struct(1, rplsIdx) is inferred to be equal to the value of corresponding syntax element in ref_pic_list_struct(0, rplsIdx) for rplsIdx ranging from 0 to sps_num_ref_pic_lists[0]−1.
   sps_num_ref_pic_lists[i] specifies the number of the ref_pic_list_struct(listIdx, rplsIdx) syntax structures with listIdx equal to i included in the SPS. The value of sps_num_ref_pic_lists[i] shall be in the range of 0 to 64, inclusive.
NOTE—For each value of listIdx (equal to 0 or 1), a decoder could allocate memory for a total number of sps_num_ref_pic_lists[i]+1 ref_pic_list_struct(listIdx, rplsIdx) syntax structures since there could be one ref_pic_list_struct(listIdx, rplsIdx) syntax structure directly signalled in the picture headers or slice headers of a current picture.
   sps_ref_wraparound_enabled_flag equal to 1 specifies that horizontal wrap-around motion compensation is enabled for the CLVS. sps_ref_wraparound_enabled_flag equal to 0 specifies that horizontal wrap-around motion compensation is disabled for the CLVS.
   It is a requirement of bitstream conformance that, when there is one or more values of i in the range of 0 to sps_num_subpics_minus1, inclusive, for which sps_subpic_treated_as_pic_flag[i] is equal to 1 and sps_subpic_width_minus1[i] plus 1 is not equal to (sps_pic_width_max_in_luma_samples+CtbSizeY−1)>>CtbLog2SizeY), the value of sps_ref_wraparound_enabled_flag shall be equal to 0.
   sps_temporal_mvp_enabled_flag equal to 1 specifies that temporal motion vector predictors are enabled for the CLVS. sps_temporal_mvp_enabled_flag equal to 0 specifies that temporal motion vector predictors are disabled for the CLVS.
   sps_sbtmvp_enabled_flag equal to 1 specifies that subblock-based temporal motion vector predictors are enabled and might be used in decoding of pictures with all slices having sh_slice_type not equal to I in the CLVS. sps_sbtmvp_enabled_flag equal to 0 specifies that subblock-based temporal motion vector predictors are disabled and not used in decoding of pictures in the CLVS. When sps_sbtmvp_enabled_flag is not present, it is inferred to be equal to 0.
   sps_amvr_enabled_flag equal to 1 specifies that adaptive motion vector difference resolution is enabled for the CVLS. amvr_enabled_flag equal to 0 specifies that adaptive motion vector difference resolution is disabled for the CLVS.
   sps_bdof_enabled_flag equal to 1 specifies that the bi-directional optical flow inter prediction is enabled for the CLVS. sps_bdof_enabled_flag equal to 0 specifies that the bi-directional optical flow inter prediction is disabled for the CLVS.
   sps_bdof_control_present_in_ph_flag equal to 1 specifies that ph_bdof_disabled_flag could be present in PH syntax structures referring to the SPS. sps_bdof_control_present_in_ph_flag equal to 0 specifies that ph_bdof_disabled_flag is not present in PH syntax structures referring to the SPS. When not present, the value of sps_bdof_control_present_in_ph_flag is inferred to be equal to 0.
   sps_smvd_enabled_flag equal to 1 specifies that symmetric motion vector difference is enabled for the CLVS. sps_smvd_enabled_flag equal to 0 specifies that symmetric motion vector difference is disabled for the CLVS.
   sps_dmvr_enabled_flag equal to 1 specifies that decoder motion vector refinement based inter bi-prediction is enabled for the CLVS. sps_dmvr_enabled_flag equal to 0 specifies that decoder motion vector refinement based inter bi-prediction is disabled for the CLVS.
   sps_dmvr_control_present_in_ph_flag equal to 1 specifies that ph_dmvr_disabled_flag could be present in PH syntax structures referring to the SPS. sps_dmvr_control_present_in_ph_flag equal to 0 specifies that ph_dmvr_disabled_flag is not present in PH syntax structures referring to the SPS. When not present, the value of sps_dmvr_control_present_in_ph_flag is inferred to be equal to 0.
   sps_mmvd_enabled_flag equal to 1 specifies that merge mode with motion vector difference is enabled for the CLVS. sps_mmvd_enabled_flag equal to 0 specifies that merge mode with motion vector difference is disabled for the CLVS.
   sps_mmvd_fullpel_only_enabled_flag equal to 1 specifies that the merge mode with motion vector difference using only integer sample precision is enabled for the CLVS. sps_mmvd_fullpel_enabled_only_flag equal to 0 specifies that the merge mode with motion vector difference using only integer sample precision is disabled for the CLVS. When not present, the value of sps_mmvd_fullpel_only_enabled_flag is inferred to be equal to 0.
   sps_six_minus_max_num_merge_cand specifies the maximum number of merging motion vector prediction (MVP) candidates supported in the SPS subtracted from 6. The value of sps_six_minus_max_num_merge_cand shall be in the range of 0 to 5, inclusive.
   The maximum number of merging MVP candidates, MaxNumMergeCand, is derived as follows:

$$Max NumMergeCand = 6 - sps\_six \_minus \_max \_num \_merge \_cand$$

sps_sbt_enabled_flag equal to 1 specifies that subblock transform for inter-predicted CUs is enabled for the CLVS. sps_sbt_enabled_flag equal to 0 specifies that subblock transform for inter-predicted CUs is disabled for the CLVS.
sps_affine_enabled_flag equal to 1 specifies that the affine model based motion compensation is enabled for the CLVS and inter_affine_flag and cu_affine_type_flag could be present in the coding unit syntax of the CLVS. sps_affine_enabled_flag equal to 0 specifies that the affine model based motion compensation is disabled for the CLVS and inter_affine_flag and cu_affine_type_flag are not present in the coding unit syntax of the CLVS.
sps_five_minus_max_num_subblock_merge_cand specifies the maximum number of subblock-based merging motion vector prediction candidates supported in the SPS subtracted from 5. The value of sps_five_minus_max_num_subblock_merge_cand shall be in the range of 0 to 5−sps_sbtmvp_enabled_flag, inclusive.
sps_6param_affine_enabled_flag equal to 1 specifies that the 6-parameter affine model based motion compensation is enabled for the CLVS. sps_6param_affine_enabled_flag equal to 0 specifies that the 6-parameter affine model based motion compensation is disabled for the CLVS. When not present, the value of sps_6param_affine_enabled_flag is inferred to be equal to 0.
sps_affine_amvr_enabled_flag equal to 1 specifies that adaptive motion vector difference resolution is enabled for the CLVS. sps_affine_amvr_enabled_flag equal to 0 specifies that adaptive motion vector difference resolution is disabled for the CLVS. When not present, the value of sps_affine_amvr_enabled_flag is inferred to be equal to 0.
sps_affine_prof_enabled_flag equal to 1 specifies that the affine motion compensation refined with optical flow is enabled for the CLVS. sps_affine_prof_enabled_flag equal to 0 specifies that the affine motion compensation refined with optical flow is disabled for the CLVS. When not present, the value of sps_affine_prof_enabled_flag is inferred to be equal to 0.
sps_prof_control_present_in_ph_flag equal to 1 specifies that ph_prof_disabled_flag could be present in PH syntax structures referring to the SPS. sps_prof_control_present_in_ph_flag equal to 0 specifies that ph_prof_disabled_flag is not present in PH syntax structures referring to the SPS. When sps_prof_control_present_in_ph_flag is not present, the value of sps_prof_control_present_in_ph_flag is inferred to be equal to 0.
sps_bcw_enabled_flag equal to 1 specifies that bi-prediction with CU weights is enabled for the CLVS and bcw_idx could be present in the coding unit syntax of the CLVS. sps_bcw_enabled_flag equal to 0 specifies that bi-prediction with CU weights is disabled for the CLVS and bcw_idx is not present in the coding unit syntax of the CLVS.
sps_ciip_enabled_flag equal to 1 specifies that ciip_flag could be present in the coding unit syntax for inter coding units. sps_ciip_enabled_flag equal to 0 specifies that ciip_flag is not present in the coding unit syntax for inter coding units.
sps_gpm_enabled_flag equal to 1 specifies that the geometric partition based motion compensation is enabled for the CLVS and merge_gpm_partition_idx, merge_gpm_idx0, and merge_gpm_idx1 could be present in the coding unit syntax of the CLVS. sps_gpm_enabled_flag equal to 0 specifies that the geometric partition based motion compensation is disabled for the CLVS and merge_gpm_partition_idx, merge_gpm_idx0, and merge_gpm_idx1 are not present in the coding unit syntax of the CLVS. When not present, the value of sps_gpm_enabled_flag is inferred to be equal to 0.
sps_max_num_merge_cand_minus_max_num_gpm_cand specifies the maximum number of geometric partitioning merge mode candidates supported in the SPS subtracted from MaxNumMergeCand. The value of sps_max_num_merge_cand_minus_max_num_gpm_cand shall be in the range of 0 to MaxNumMergeCand −2, inclusive.
The maximum number of geometric partitioning merge mode candidates, MaxNumGpmMergeCand, is derived as follows:

```
if( sps_gpm_enabled_flag && MaxNumMergeCand >= 3 )
  MaxNumGpmMergeCand = MaxNumMergeCand −
    sps_max_num_merge_cand_minus_max_num_gpm_cand
else if( sps_gpm_enabled_flag && MaxNumMergeCand = = 2 )
  MaxNumGpmMergeCand = 2
else
  MaxNumGpmMergeCand = 0
```

sps_log2_parallel_merge_level_minus2 plus 2 specifies the value of the variable Log2ParMrgLevel, which is used in the derivation process for spatial merging candidates as specified, the derivation process for motion vectors and reference indices in subblock merge mode as specified, and to control the invocation of the updating process for the history-based motion vector predictor list. The value of sps_log2_parallel_merge_level_minus2 shall be in the range of 0 to CtbLog2SizeY−2, inclusive. The variable Log2ParMrgLevel is derived as follows:

$$Log 2 ParMrgLevel = sps\_log2 \_parallel \_merge \_level \_minus2 + 2$$

sps_isp_enabled_flag equal to 1 specifies that intra prediction with subpartitions is enabled for the CLVS. sps_isp_enabled_flag equal to 0 specifies that intra prediction with subpartitions is disabled for the CLVS.
sps_mrl_enabled_flag equal to 1 specifies that intra prediction with multiple reference lines is enabled for the CLVS. sps_mrl_enabled_flag equal to 0 specifies that intra prediction with multiple reference lines is disabled for the CLVS.
sps_mip_enabled_flag equal to 1 specifies that the matrix-based intra prediction is enabled for the CLVS. sps_mip_enabled_flag equal to 0 specifies that the matrix-based intra prediction is disabled for the CLVS.
sps_cclm_enabled_flag equal to 1 specifies that the cross-component linear model intra prediction from luma component to chroma component is enabled for the CLVS. sps_cclm_enabled_flag equal to 0 specifies that the cross-component linear model intra prediction from luma component to chroma component is disabled for the CLVS. When sps_cclm_enabled_flag is not present, it is inferred to be equal to 0.
sps_chroma_horizontal_collocated_flag equal to 1 specifies that prediction processes operate in a manner designed for chroma sample positions that are not horizontally shifted relative to corresponding luma sample positions. sps_chroma_horizontal_collocated_flag equal to 0 specifies that prediction processes operate in a manner designed for chroma sample positions that are shifted to the right by 0.5 in units of luma samples relative to corresponding luma sample positions. When sps_chroma_horizontal_collocated_flag is not present, it is inferred to be equal to 1.
sps_chroma_vertical_collocated_flag equal to 1 specifies that prediction processes operate in a manner designed for chroma sample positions that are not vertically shifted relative to corresponding luma sample positions. sps_chroma_vertical_collocated_flag equal to 0 specifies that prediction processes operate in a manner designed for chroma sample positions that are shifted downward by 0.5 in units of luma samples relative to corresponding luma sample positions. When sps_chroma_vertical_collocated_flag is not present, it is inferred to be equal to 1.
sps_palette_enabled_flag equal to 1 specifies that the palette prediction mode is enabled for the CLVS. sps_palette_enabled_flag equal to 0 specifies that the palette prediction mode is disabled for the CLVS. When sps_palette_enabled_flag is not present, it is inferred to be equal to 0.
sps_act_enabled_flag equal to 1 specifies that the adaptive colour transform is enabled for the CLVS and the cu_act_enabled_flag could be present in the coding unit syntax of the CLVS. sps_act_enabled_flag equal to 0 specifies that the adaptive colour transform is disabled for the CLVS and cu_act_enabled_flag is not present in the coding unit syntax of the CLVS. When sps_act_enabled_flag is not present, it is inferred to be equal to 0.
sps_min_qp_prime_ts specifies the minimum allowed quantization parameter for transform skip mode as follows:

$$QpPrimeTsMin = 4 + 6 * sps\_min \_qp \_prime \_ts$$

The value of sps_min_qp_prime_ts shall be in the range of 0 to 8, inclusive.
sps_ibc_enabled_flag equal to 1 specifies that the IBC prediction mode is enabled for the CLVS. sps_ibc_enabled_flag equal to 0 specifies that the IBC prediction mode is disabled for the CLVS. When sps_ibc_enabled_flag is not present, it is inferred to be equal to 0.
sps_six_minus_max_num_ibc_merge_cand, when sps_ibc_enabled_flag is equal to 1, specifies the maximum number of IBC merging block vector prediction (BVP) candidates supported in the SPS subtracted from 6. The value of sps_six_minus_max_num_ibc_merge_cand shall be in the range of 0 to 5, inclusive.
The maximum number of IBC merging BVP candidates, MaxNumIbcMergeCand, is derived as follows:

```
if( sps_ibc_enabled_flag )
  MaxNumIbcMergeCand = 6 −
  sps_six_minus_max_num_ibc_merge_cand
else
  MaxNumIbcMergeCand = 0
```

sps_ladf_enabled_flag equal to 1 specifies that sps_num_ladf_intervals_minus2, sps_ladf_lowest_interval_qp_offset, sps_ladf_qp_offset[i], and sps_ladf_delta_threshold_minus1[i] are present in the SPS. sps_ladf_enabled_flag equal to 0 specifies that sps_num_ladf_intervals_minus2, sps_ladf_lowest_interval_qp_offset, sps_ladf_qp_offset[i], and sps_ladf_delta_threshold_minus1[i] are not present in the SPS.
sps_num_ladf_intervals_minus2 plus 2 specifies the number of sps_ladf_delta_threshold_minus1[i] and sps_ladf_qp_offset[i] syntax elements that are present in the SPS. The value of sps_num_ladf_intervals_minus2 shall be in the range of 0 to 3, inclusive.
sps_ladf_lowest_interval_qp_offset specifies the offset used to derive the variable qP as specified The value of sps_ladf_lowest_interval_qp_offset shall be in the range of −63 to 63, inclusive.
sps_ladf_qp_offset[i] specifies the offset array used to derive the variable qP as specified. The value of sps_ladf_qp_offset[i] shall be in the range of −63 to 63, inclusive.
sps_ladf_delta_threshold_minus1[i] is used to compute the values of SpsLadfIntervalLowerBound[i], which specifies the lower bound of the i-th luma intensity level interval. The value of sps_ladf_delta_threshold_minus1[i] shall be in the range of 0 to 2^{BitDepth}−3, inclusive.
The value of SpsLadfIntervalLowerBound[0] is set equal to 0.
For each value of i in the range of 0 to sps_num_ladf_intervals_minus2, inclusive, the variable SpsLadfIntervalLowerBound[i+1] is derived as follows:

$$SpsLadfIntervalLowerBound [ i + 1 ] = SpsLadfIntervalLowerBound [ i ] + sps\_ladf \_delta \_threshold \_minus1 [ i ] + 1$$

sps_explicit_scaling_list_enabled_flag equal to 1 specifies that the use of an explicit scaling list, which is signalled in a scaling list APS, in the scaling process for transform coefficients when decoding a slice is enabled for the CLVS. sps_explicit_scaling_list_enabled_flag equal to 0 specifies that the use of an explicit scaling list in the scaling process for transform coefficients when decoding a slice is disabled for the CLVS.
sps_scaling_matrix_for_lfnst_disabled_flag equal to 1 specifies that scaling matrices are disabled for blocks coded with LFNST for the CLVS. sps_scaling_matrix_for_lfnst_disabled_flag equal to 0 specifies that the scaling matrices is enabled for blocks coded with LFNST for the CLVS.
sps_scaling_matrix_for_alternative_colour_space_disabled_flag equal to 1 specifies, for the CLVS, that scaling matrices are disabled and not applied to blocks of a coding unit when the decoded residuals of the current coding unit are applied using a colour space conversion. sps_scaling_matrix_for_alternative_colour_space_disabled_flag equal to 0 specifies, for the CLVS, that scaling matrices are enabled and could be applied to blocks of a coding unit when the decoded residuals of the current coding unit are applied using a colour space conversion. When not present, the value of sps_scaling_matrix_for_alternative_colour_space_disabled_flag is inferred to be equal to 0.
sps_scaling_matrix_designated_colour_space_flag equal to 1 specifies that the colour space of the scaling matrices is the colour space that does not use a colour space conversion for the decoded residuals. sps_scaling_matrix_designated_colour_space_flag equal to 0 specifies that the designated colour space of the scaling matrices is the colour space that uses a colour space conversion for the decoded residuals.
sps_dep_quant_enabled_flag equal to 1 specifies that dependent quantization is enabled for the CLVS. sps_dep_quant_enabled_flag equal to 0 specifies that dependent quantization is disabled for the CLVS.
sps_sign_data_hiding_enabled_flag equal to 1 specifies that sign bit hiding is enabled for the CLVS. sps_sign_data_hiding_enabled_flag equal to 0 specifies that sign bit hiding is disabled for the CLVS.
sps_virtual_boundaries_enabled_flag equal to 1 specifies that disabling in-loop filtering across virtual boundaries is enabled for the CLVS. sps_virtual_boundaries_enabled_flag equal to 0 specifies that disabling in-loop filtering across virtual boundaries is disabled for the CLVS. In-loop filtering operations include the deblocking filter, sample adaptive offset filter, and adaptive loop filter operations.
sps_virtual_boundaries_present_flag equal to 1 specifies that information of virtual boundaries is signalled in the SPS. sps_virtual_boundaries_present_flag equal to 0 specifies that information of virtual boundaries is not signalled in the SPS. When there is one or more than one virtual boundaries signalled in the SPS, the in-loop filtering operations are disabled across the virtual boundaries in pictures referring to the SPS. In-loop filtering operations include the deblocking filter, sample adaptive offset filter, and adaptive loop filter operations. When not present, the value of sps_virtual_boundaries_present_flag is inferred to be equal to 0.
When sps_res_change_in_clvs_allowed_flag is equal to 1, the value of sps_virtual_boundaries_present_flag shall be equal to 0.
When sps_subpic_info_present_flag and sps_virtual_boundaries_enabled_flag are both equal to 1, the value of sps_virtual_boundaries_present_flag shall be equal to 1.
sps_num_ver_virtual_boundaries specifies the number of sps_virtual_boundary_pos_x_minus1[i] syntax elements that are present in the SPS. The value of sps_num_ver_virtual_boundaries shall be in the range of 0 to (sps_pic_width_max_in_luma_samples<=8?0:3), inclusive. When sps_num_ver_virtual_boundaries is not present, it is inferred to be equal to 0.
sps_virtual_boundary_pos_x_minus1[i] plus 1 specifies the location of the i-th vertical virtual boundary in units of luma samples divided by 8. The value of sps_virtual_boundary_pos_x_minus1[i] shall be in the range of 0 to Ceil(sps_pic_width_max_in_luma_samples+8)−2, inclusive.
sps_num_hor_virtual_boundaries specifies the number of sps_virtual_boundary_pos_y_minus1[i] syntax elements that are present in the SPS. The value of sps_num_hor_virtual_boundaries shall be in the range of 0 to (sps_pic_height_max_in_luma_samples<=8?0:3), inclusive. When sps_num_hor_virtual_boundaries is not present, it is inferred to be equal to 0.
When sps_virtual_boundaries_enabled_flag is equal to 1 and sps_virtual_boundaries_present_flag is equal to 1, the sum of sps_num_ver_virtual_boundaries and sps_num_hor_virtual_boundaries shall be greater than 0.
sps_virtual_boundary_pos_y_minus1[i] plus 1 specifies the location of the i-th horizontal virtual boundary in units of luma samples divided by 8. The value of sps_virtual_boundary_pos_y_minus1[i] shall be in the range of 0 to Ceil(sps_pic_height_max_in_luma_samples+8)−2, inclusive.
sps_timing_hrd_params_present_flag equal to 1 specifies that the SPS contains a general_timing_hrd_parameters( ) syntax structure and an ols_timing_hrd_parameters( ) syntax structure. sps_timing_hrd_params_present_flag equal to 0 specifies that the SPS does not contain a general_timing_hrd_parameters( ) syntax structure or an ols_timing_hrd_parameters( ) syntax structure.
sps_sublayer_cpb_params_present_flag equal to 1 specifies that the ols_timing_hrd_parameters( ) syntax structure in the SPS includes HRD parameters for sublayer representations with TemporalId in the range of 0 to sps_max_sublayers_minus1, inclusive. sps_sublayer_cpb_params_present_flag equal to 0 specifies that the ols_timing_hrd_parameters( ) syntax structure in the SPS includes HRD parameters for the sublayer representation with TemporalId equal to sps_max_sublayers_minus1 only. When sps_max_sublayers_minus1 is equal to 0, the value of sps_sublayer_cpb_params_present_flag is inferred to be equal to 0.
When sps_sublayer_cpb_params_present_flag is equal to 0, the HRD parameters for the sublayer representations with TemporalId in the range of 0 to sps_max_sublayers_minus1−1, inclusive, are inferred to be the same as that for the sublayer representation with TemporalId equal to sps_max_sublayers_minus1. These include the HRD parameters starting from the fixed_pic_rate_general_flag[i] syntax element till the sublayer_hrd_parameters(i) syntax structure immediately under the condition “if(general_vcl_hrd_params_present_flag)” in the ols_timing_hrd_parameters syntax structure.

sps_field_seq_flag equal to 1 indicates that the CLVS conveys pictures that represent fields. sps_field_seq_flag equal to 0 indicates that the CLVS conveys pictures that represent frames.

When sps_field_seq_flag is equal to 1, a frame-field information SEI message shall be present for every coded picture in the CLVS.
NOTE—The specified decoding process does not treat pictures that represent fields or frames differently. A sequence of pictures that represent fields would therefore be coded with the picture dimensions of an individual field. For example, pictures that represent 1080i fields would commonly have cropped output dimensions of 1920×540, while the sequence picture rate would commonly express the rate of the source fields (typically between 50 and 60 Hz), instead of the source frame rate (typically between 25 and 30 Hz).
   sps_vui_parameters_present_flag equal to 1 specifies that the syntax structure vui_payload( ) is present in the SPS RBSP syntax structure. sps_vui_parameters_present_flag equal to 0 specifies that the syntax structure vui_payload( ) is not present in the SPS RBSP syntax structure.
   When sps_vui_parameters_present_flag is equal to 0, the information conveyed in the vui_payload( ) syntax structure is considered unspecified or determined by the application by external means.
   sps_vui_payload_size_minus1 plus 1 specifies the number of RBSP bytes in the vui_payload( ) syntax structure. The value of sps_vui_payload_size_minus1 shall be in the range of 0 to 1023, inclusive.
NOTE—The SPS NAL unit byte sequence containing the vui_payload( ) syntax structure might include one or more emulation prevention bytes (represented by emulation_prevention_three_byte syntax elements). Since the payload size of the vui_payload( ) syntax structure is specified in RBSP bytes, the quantity of emulation prevention bytes is not included in the size payloadSize of the vui_payload( ) syntax structure.
   sps_vui_alignment_zero_bit shall be equal to 0.
   sps_extension_flag equal to 0 specifies that no sps_extension_data_flag syntax elements are present in the SPS RBSP syntax structure. sps_extension_flag equal to 1 specifies that sps_extension_data_flag syntax elements might be present in the SPS RBSP syntax structure. sps_extension_flag shall be equal to 0 in bitstreams conforming to this version of this Specification. However, some use of sps_extension_flag equal to 1 could be specified in some future version of this Specification, and decoders conforming to this version of this Specification shall allow the value of sps_extension_flag equal to 1 to appear in the syntax.
   sps_extension_data_flag could have any value. Its presence and value do not affect the decoding process specified in this version of this Specification. Decoders conforming to this version of this Specification shall ignore all sps_extension_data_flag syntax elements.

As provided in Table 2, a NAL unit may include a picture parameter set syntax structure. Table 4 illustrates the syntax of the picture parameter set syntax structure provided in JVET-T2001.

TABLE 4

| | Descriptor |
|---|---|
| pic_parameter_set_rbsp( ) { | |
| pps_pic_parameter_set_id | u(6) |
| pps_seq_parameter_set_id | u(4) |
| pps_mixed_nalu_types_in_pic_flag | u(1) |
| pps_pic_width_in_luma_samples | ue(v) |
| pps_pic_height_in_luma_samples | ue(v) |
| pps_conformance_window_flag | u(1) |
| if( pps_conformance_window_flag ) { | |
| pps_conf_win_left_offset | ue(v) |
| pps_conf_win_right_offset | ue(v) |
| pps_conf_win_top_offset | ue(v) |
| pps_conf_win_bottom_offset | ue(v) |
| } | |
| pps_scaling_window_explicit_signalling_flag | u(1) |
| if( pps_scaling_window_explicit_signalling_flag ) { | |
| pps_scaling_win_left_offset | se(v) |
| pps_scaling_win_right_offset | se(v) |
| pps_scaling_win_top_offset | se(v) |
| pps_scaling_win_bottom_offset | se(v) |
| } | |
| pps_output_flag_present_flag | u(1) |
| pps_no_pic_partition_flag | u(1) |
| pps_subpic_id_mapping_present_flag | u(1) |
| if( pps_subpic_id_mapping_present_flag ) { | |
| if( !pps_no_pic_partition_flag ) | |
| pps_num_subpics_minus1 | ue(v) |
| pps_subpic_id_len_minus1 | ue(v) |
| for( i = 0; i <= pps_num_subpics_minus1; i++ ) | |
| pps_subpic_id[ i ] | u(v) |
| } | |
| if( !pps_no_pic_partition_flag ) { | |
| pps_log2_ctu_size_minus5 | u(2) |
| pps_num_exp_tile_columns_minus1 | ue(v) |
| pps_num_exp_tile_rows_minus1 | ue(v) |
| for( i = 0; i <= pps_num_exp_tile_columns_minus1; i++ ) | |
| pps_tile_column_width_minus1[ i ] | ue(v) |
| for( i = 0; i <= pps_num_exp_tile_rows_minus1; i++ ) | |
| pps_tile_row_height_minus1[ i ] | ue(v) |
| if( NumTilesInPic > 1 ) { | |
| pps_loop_filter_across_tiles_enabled_flag | u(1) |
| pps_rect_slice_flag | u(1) |
| } | |
| if( pps_rect_slice_flag ) | |
| pps_single_slice_per_subpic_flag | u(1) |
| if( pps_rect_slice_flag && !pps_single_slice_per_subpic_flag ) { | |
| pps_num_slices_in_pic_minus1 | ue(v) |
| if( pps_num_slices_in_pic_minus1 > 1 ) | |
| pps_tile_idx_delta_present_flag | u(1) |
| for( i = 0; i < pps_num_slices_in_pic_minus1; i++ ) { | |
| if( SliceTopLeftTileIdx[ i ] % NumTileColumns != | |
| NumTileColumns − 1 ) | |
| pps_slice_width_in_tiles_minus1[ i ] | ue(v) |
| if( SliceTopLeftTileIdx[ i ] / NumTileColumns != | |
| NumTileRows − 1 && | |
| ( pps_tile_idx_delta_present_flag \| \| | |
| SliceTopLeftTileIdx[ i ] % NumTileColumns = = 0 ) ) | |
| pps_slice_height_in_tiles_minus1[ i ] | ue(v) |
| if( pps_slice_width_in_tiles_minus1[ i ] = = 0 && | |
| pps_slice_height_in_tiles_minus1[ i ] = = 0 && | |
| RowHeightVal[ SliceTopLeftTileIdx[ i ] / NumTileColumns ] > | |
| 1 ) { | |
| pps_num_exp_slices_in_tile[ i ] | ue(v) |
| for( j = 0; j < pps_num_exp_slices_in_tile[ i ]; j++ ) | |
| pps_exp_slice_height_in_ctus_minus1[ i ][ j ] | ue(v) |
| i += NumSlicesInTile[ i ] − 1 | |
| } | |
| if( pps_tile_idx_delta_present_flag && i < | |
| pps_num_slices_in_pic_minus1 ) | |
| pps_tile_idx_delta_val[ i ] | se(v) |
| } | |
| } | |
| if( !pps_rect_slice_flag \| \| pps_single_slice_per_subpic_flag \| \| | |
| pps_num_slices_in_pic_minus1 > 0 ) | |
| pps_loop_filter_across_slices_enabled_flag | u(1) |
| } | |
| pps_cabac_init_present_flag | u(1) |
| for( i = 0; i < 2; i++ ) | |
| pps_num_ref_idx_default_active_minus1[ i ] | ue(v) |
| pps_rpl1_idx_present_flag | u(1) |
| pps_weighted_pred_flag | u(1) |
| pps_weighted_bipred_flag | u(1) |
| pps_ref_wraparound_enabled_flag | u(1) |
| if( pps_ref_wraparound_enabled_flag ) | |
| pps_pic_width_minus_wraparound_offset | ue(v) |
| pps_init_qp_minus26 | se(v) |
| pps_cu_qp_delta_enabled_flag | u(1) |
| pps_chroma_tool_offsets_present_flag | u(1) |
| if( pps_chroma_tool_offsets_present_flag ) { | |
| pps_cb_qp_offset | se(v) |
| pps_cr_qp_offset | se(v) |
| pps_joint_cbcr_qp_offset_present_flag | u(1) |
| if( pps_joint_cbcr_qp_offset_present_flag ) | |
| pps_joint_cbcr_qp_offset_value | se(v) |
| pps_slice_chroma_qp_offsets_present_flag | u(1) |
| pps_cu_chroma_qp_offset_list_enabled_flag | u(1) |
| if( pps_cu_chroma_qp_offset_list_enabled_flag ) { | |
| pps_chroma_qp_offset_list_len_minus1 | ue(v) |
| for( i = 0; i <= pps_chroma_qp_offset_list_len_minus1; i++ ) { | |
| pps_cb_qp_offset_list[ i ] | se(v) |
| pps_cr_qp_offset_list[ i ] | se(v) |
| if( pps_joint_cbcr_qp_offset_present_flag ) | |
| pps_joint_cbcr_qp_offset_list[ i ] | se(v) |
| } | |
| } | |
| } | |
| pps_deblocking_filter_control_present_flag | u(1) |
| if( pps_deblocking_filter_control_present_flag ) { | |
| pps_deblocking_filter_override_enabled_flag | u(1) |
| pps_deblocking_filter_disabled_flag | u(1) |
| if( !pps_no_pic_partition_flag && | |
| pps_deblocking_filter_override_enabled_flag ) | |
| pps_dbf_info_in_ph_flag | u(1) |
| if( !pps_deblocking_filter_disabled_flag ) { | |
| pps_luma_beta_offset_div2 | se(v) |
| pps_luma_tc_offset_div2 | se(v) |
| if( pps_chroma_tool_offsets_present_flag ) { | |
| pps_cb_beta_offset_div2 | se(v) |
| pps_cb_tc_offset_div2 | se(v) |
| pps_cr_beta_offset_div2 | se(v) |
| pps_cr_tc_offset_div2 | se(v) |
| } | |
| } | |
| } | |
| if( !pps_no_pic_partition_flag ) { | |
| pps_rpl_info_in_ph_flag | u(1) |
| pps_sao_info_in_ph_flag | u(1) |
| pps_alf_info_in_ph_flag | u(1) |
| if( ( pps_weighted_pred_flag \| \| pps_weighted_bipred_flag ) && | |
| pps_rpl_info_in_ph_flag ) | |
| pps_wp_info_in_ph_flag | u(1) |
| pps_qp_delta_info_in_ph_flag | u(1) |
| } | |
| pps_picture_header_extension_present_flag | u(1) |
| pps_slice_header_extension_present_flag | u(1) |
| pps_extension_flag | u(1) |
| if( pps_extension_flag ) | |
| while( more_rbsp_data( ) ) | |
| pps_extension_data_flag | u(1) |
| rbsp_trailing_bits( ) | |
| } | |

With respect to Table 4, JVET-T2001 provides the following semantics:

A PPS RBSP shall be available to the decoding process prior to it being referenced, included in at least one AU with TemporalId less than or equal to the TemporalId of the PPS NAL unit or provided through external means.

All PPS NAL units with a particular value of pps_pic_parameter_set_id within a PU shall have the same content.

pps_pic_parameter_set_id identifies the PPS for reference by other syntax elements.

PPS NAL units, regardless of the nuh_layer_id values, share the same value space of pps_pic_parameter_set_id.

Let ppsLayerId be the value of the nuh_layer_id of a particular PPS NAL unit, and vclLayerId be the value of the nuh_layer_id of a particular VCL NAL unit. The particular VCL NAL unit shall not refer to the particular PPS NAL unit unless ppsLayerId is less than or equal to vclLayerId and all OLSs specified by the VPS that contain the layer with nuh_layer_id equal to vclLayerId also contain the layer with nuh_layer_id equal to ppsLayerId.
NOTE—In a CVS that contains only one layer, the nuh_layer_id of referenced PPSs is equal to the nuh_layer_id of the VCL NAL units.
   pps_seq_parameter_set_id specifies the value of sps_seq_parameter_set_id for the SPS. The value of pps_seq_parameter_set_id shall be in the range of 0 to 15, inclusive. The value of pps_seq_parameter_set_id shall be the same in all PPSs that are referred to by coded pictures in a CLVS.
   pps_mixed_nalu_types_in_pic_flag equal to 1 specifies that each picture referring to the PPS has more than one VCL NAL unit and the VCL NAL units do not have the same value of nal_unit_type.
   pps_mixed_nalu_types_in_pic_flag equal to 0 specifies that each picture referring to the PPS has one or more VCL NAL units and the VCL NAL units of each picture referring to the PPS have the same value of nal_unit_type.
NOTE—pps_mixed_nalu_types_in_pic_flag equal to 1 indicates that pictures referring to the PPS contain slices with different NAL unit types, e.g., coded pictures originating from a subpicture bitstream merging operation for which encoders have to ensure matching bitstream structure and further alignment of parameters of the original bitstreams. One example of such alignments is as follows: When the value of sps_idr_rpl_present_flag is equal to 0 and pps_mixed_nalu_types_in_pic_flag is equal to 1, a picture referring to the PPS might not have slices with nal_unit_type equal to IDR_W_RADL or IDR_N_LP.
   pps_pic_width_in_luma_samples specifies the width of each decoded picture referring to the PPS in units of luma samples. pps_pic_width_in_luma_samples shall not be equal to 0, shall be an integer multiple of Max(8, MinCbSizeY), and shall be less than or equal to sps_pic_width_max_in_luma_samples.
   When sps_res_change_in_clvs_allowed_flag equal to 0, the value of pps_pic_width_in_luma_samples shall be equal to sps_pic_width_max_in_luma_samples.
   When sps_ref_wraparound_enabled_flag is equal to 1, the value of (CtbSizeY/MinCbSizeY+1) shall be less than or equal to the value of (pps_pic_width_in_luma_samples/MinCbSizeY−1).
   pps_pic_height_in_luma_samples specifies the height of each decoded picture referring to the PPS in units of luma samples. pps_pic_height_in_luma_samples shall not be equal to 0 and shall be an integer multiple of Max(8, MinCbSizeY), and shall be less than or equal to sps_pic_height_max_in_luma_samples.
   When sps_res_change_in_clvs_allowed_flag equal to 0, the value of pps_pic_height_in_luma_samples shall be equal to sps_pic_height_max_in_luma_samples.
   The variables PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$\begin{matrix}PicWidthInCtbsY = Ceil ( pps\_pic \_width \_in \_luma \_samples \div CtbSizeY ) \\ PicHeightInCtbsY = Ceil ( pps\_pic \_height \_in \_luma \_samples \div CtbSizeY ) \\ PicSizeInCtbsY = PicWidthInCtbsY * PicHeightInCtbsY \\ PicWidthInMinCbsY = pps\_pic \_width \_in \_luma \_samples / MinCBSizeY \\ PicHeightInMinCbsY = pps\_pic \_height \_in \_luma \_samples / MinCbSizeY \\ PicSizeInMinCbsY = PicWidthInMinCbsY * PicHeightInMinCbsY \\ PicSizeInSamplesY = pps\_pic \_width \_in \_luma \_samples * pps\_pic \_height \_in \_luma \_samples \\ PicWidthInSamplesC = pps\_pic \_width \_in \_luma \_samples / subWidthC \\ PicHeightInSamplesC = pps\_pic \_height \_in \_luma \_samples / SubHeightC\end{matrix}$$

pps_conformance_window_flag equal to 1 specifies that the conformance cropping window offset parameters follow next in the PPS. pps_conformance_window_flag equal to 0 specifies that the conformance cropping window offset parameters are not present in the PPS.
When pps_pic_width_in_luma_samples is equal to sps_pic_width_max_in_luma_samples and pps_pic_height_in_luma_samples is equal to sps_pic_height_max_in_luma_samples, the value of pps_conformance_window_flag shall be equal to 0.
pps_conf_win_left_offset, pps_conf_win_right_offset, pps_conf_win_top_offset, and pps_conf_win_bottom_offset specify the samples of the pictures in the CLVS that are output from the decoding process, in terms of a rectangular region specified in picture coordinates for output.
When pps_conformance_window_flag is equal to 0, the following applies:
If pps_pic_width_in_luma_samples is equal to sps_pic_width_max_in_luma_samples and pps_pic_height_in_luma_samples is equal to sps_pic_height_max_in_luma_samples, the values of pps_conf_win_left_offset, pps_conf_win_right_offset, pps_conf_win_top_offset, and pps_conf_win_bottom_offset are inferred to be equal to sps_conf_win_left_offset, sps_conf_win_right_offset, sps_conf_win_top_offset, and sps_conf_win_bottom_offset, respectively.
Otherwise, the values of pps_conf_win_left_offset, pps_conf_win_right_offset, pps_conf_win_top_offset, and pps_conf_win_bottom_offset are inferred to be equal to 0.
   The conformance cropping window contains the luma samples with horizontal picture coordinates from SubWidthC*pps_conf_win_left_offset to pps_pic_width_in_luma_samples−(SubWidthC*pps_conf_win_right_offset+1) and vertical picture coordinates from SubHeightC*pps_conf_win_top_offset to pps_pic_height_in_luma_samples−(SubHeightC*pps_conf_win_bottom_offset+1), inclusive.
   The value of SubWidthC*(pps_conf_win_left_offset+pps_conf_win_right_offset) shall be less than pps_pic_width_in_luma_samples, and the value of SubHeightC*(pps_conf_win_top_offset+pps_conf_win_bottom_offset) shall be less than pps_pic_height_in_luma_samples.
   When sps_chroma_format_idc is not equal to 0, the corresponding specified samples of the two chroma arrays are the samples having picture coordinates (x/SubWidthC, y/SubHeightC), where (x, y) are the picture coordinates of the specified luma samples.
NOTE—The conformance cropping window offset parameters are only applied at the output. All internal decoding processes are applied to the uncropped picture size.
   Let ppsA and ppsB be any two PPSs referring to the same SPS. It is a requirement of bitstream conformance that, when ppsA and ppsB have the same the values of pps_pic_width_in_luma_samples and pps_pic_height_in_luma_samples, respectively, ppsA and ppsB shall have the same values of pps_conf_win_left_offset, pps_conf_win_right_offset, pps_conf_win_top_offset, and pps_conf_win_bottom_offset, respectively.
   pps_scaling_window_explicit_signalling_flag equal to 1 specifies that the scaling window offset parameters are present in the PPS. pps_scaling_window_explicit_signalling_flag equal to 0 specifies that the scaling window offset parameters are not present in the PPS. When sps_ref_pic_resampling_enabled_flag is equal to 0, the value of pps_scaling_window_explicit_signalling_flag shall be equal to 0.
   pps_scaling_win_left_offset, pps_scaling_win_right_offset, pps_scaling_win_top_offset, and pps_scaling_win_bottom_offset specify the offsets that are applied to the picture size for scaling ratio calculation. When not present, the values of pps_scaling_win_left_offset, pps_scaling_win_right_offset, pps_scaling_win_top_offset, and pps_scaling_win_bottom_offset are inferred to be equal to pps_conf_win_left_offset, pps_conf_win_right_offset, pps_conf_win_top_offset, and pps_conf_win_bottom_offset, respectively.
   The values of SubWidthC*pps_scaling_win_left_offset and SubWidthC*pps_scaling_win_right_offset shall both be greater than or equal to −pps_pic_width_in_luma_samples*15 and less than pps_pic_width_in_luma_samples. The values of SubHeightC*pps_scaling_win_top_offset and SubHeightC*pps_scaling_win_bottom_offset shall both be greater than or equal to −pps_pic_height_in_luma_samples*15 and less than pps_pic_height_in_luma_samples.
   The value of SubWidthC*(pps_scaling_win_left_offset+pps_scaling_win_right_offset) shall be greater than or equal to −pps_pic_width_in_luma_samples*15 and less than pps_pic_width_in_luma_samples, and the value of SubHeightC*(pps_scaling_win_top_offset+pps_scaling_win_bottom_offset) shall be greater than or equal to −pps_pic_height_in_luma_samples*15 and less than pps_pic_height_in_luma_samples.
   The variables CurrPicScalWinWidthL and CurrPicScalWinHeightL are derived as follows:

$$\begin{matrix}CurrPicScalWinWidthL = pps\_pic \_width \_in \_luma \_samples - SubWidthC * ( pps\_scaling \_win \_right \_offset + pps\_scaling \_win \_left \_offset ) \\ CurrPicScalWinHeightL = pps\_pic \_height \_in \_luma \_samples - SubHeightC * ( pps\_scaling \_win \_bottom \_offset + pps\_scaling \_win \_top \_offset )\end{matrix}$$

Let refPicScalWinWidthL and refPicScalWinHeightL be the CurrPicScalWinWidthL and CurrPicScalWinHeightL, respectively, of a reference picture of a current picture referring to this PPS. It is a requirement of bitstream conformance that all of the following conditions shall be satisfied:
CurrPicScalWinWidthL*2 is greater than or equal to refPicScalWinWidthL.
CurrPicScalWinHeightL*2 is greater than or equal to refPicScalWinHeightL.
CurrPicScalWinWidthL is less than or equal to refPicScalWinWidthL*8.
CurrPicScalWinHeightL is less than or equal to refPicScalWinHeightL*8.
CurrPicScalWinWidthL*sps_pic_width_max_in_luma_samples is greater than or equal to refPicScalWinWidthL*(pps_pic_width_in_luma_samples−Max(8, MinCbSizeY)).
CurrPicScalWinHeightL*sps_pic_height_max_in_luma_samples is greater than or equal to refPicScalWinHeightL*(pps_pic_height_in_luma_samples−Max(8, MinCbSizeY)).
   pps_output_flag_present_flag equal to 1 specifies that the ph_pic_output_flag syntax element could be present in PH syntax structures referring to the PPS. pps_output_flag_present_flag equal to 0 specifies that the ph_pic_output_flag syntax element is not present in PH syntax structures referring to the PPS.
   pps_no_pic_partition_flag equal to 1 specifies that no picture partitioning is applied to each picture referring to the PPS. pps_no_pic_partition_flag equal to 0 specifies that each picture referring to the PPS might be partitioned into more than one tile or slice.
   When sps_num_subpics_minus1 is greater than 0 or pps_mixed_nalu_types_in_pic_flag is equal to 1, the value of pps_no_pic_partition_flag shall be equal to 0.
   pps_subpic_id_mapping_present_flag equal to 1 specifies that the subpicture ID mapping is signalled in the PPS. pps_subpic_id_mapping_present_flag equal to 0 specifies that the subpicture ID mapping is not signalled in the PPS. If sps_subpic_id_mapping_explicitly_signalled_flag is 0 or sps_subpic_id_mapping_present_flag is equal to 1, the value of pps_subpic_id_mapping_present_flag shall be equal to 0. Otherwise (sps_subpic_id_mapping_explicitly_signalled_flag is equal to 1 and sps_subpic_id_mapping_present_flag is equal to 0), the value of pps_subpic_id_mapping_present_flag shall be equal to 1.
   pps_num_subpics_minus1 shall be equal to sps_num_subpics_minus1. When pps_no_pic_partition_flag is equal to 1, the value of pps_num_subpics_minus1 is inferred to be equal to 0.
   pps_subpic_id_len_minus1 shall be equal to sps_subpic_id_len_minus1.
   pps_subpic_id[i] specifies the subpicture ID of the i-th subpicture. The length of the pps_subpic_id[i] syntax element is pps_subpic_id_len_minus1+1 bits.
   The variable SubpicIdVal[i], for each value of i in the range of 0 to sps_num_subpics_minus1, inclusive, is derived as follows:

```
for( i = 0; i <= sps_num_subpics_minus1; i++ )
  if( sps_subpic_id_mapping_explicitly_signalled_flag )
    SubpicIdVal[ i ] = pps_subpic_id_mapping_present_flag ?
pps_subpic_id[ i ] : sps_subpic_id[ i ]
  else
    SubpicIdVal[ i ] = i
```

It is a requirement of bitstream conformance that, for any two different values of i and j in the range of 0 to sps_num_subpics_minus1, inclusive, SubpicIdVal[i] shall not be equal to SubpicIdVal[j].
pps_log2_ctu_size_minus5 plus 5 specifies the luma coding tree block size of each CTU. pps_log2_ctu_size_minus5 shall be equal to sps_log2_ctu_size_minus5.
pps_num_exp_tile_columns_minus1 plus 1 specifies the number of explicitly provided tile column widths. The value of pps_num_exp_tile_columns_minus1 shall be in the range of 0 to PicWidthInCtbsY−1, inclusive. When pps_no_pic_partition_flag is equal to 1, the value of pps_num_exp_tile_columns_minus1 is inferred to be equal to 0.
pps_num_exp_tile_rows_minus1 plus 1 specifies the number of explicitly provided tile row heights. The value of pps_num_exp_tile_rows_minus1 shall be in the range of 0 to PicHeightInCtbsY−1, inclusive. When pps_no_pic_partition_flag is equal to 1, the value of num_tile_rows_minus1 is inferred to be equal to 0.
pps_tile_column_width_minus1[i] plus 1 specifies the width of the i-th tile column in units of CTBs for i in the range of 0 to pps_num_exp_tile_columns_minus1, inclusive. pps_tile_column_width_minus1[pps_num_exp_tile_columns_minus1] is also used to derive the widths of the tile columns with index greater than pps_num_exp_tile_columns_minus1 as specified in clause 6.5.1. The value of pps_tile_column_width_minus1[i] shall be in the range of 0 to PicWidthInCtbsY−1, inclusive. When not present, the value of pps_tile_column_width_minus1[0] is inferred to be equal to PicWidthInCtbsY−1.
pps_tile_row_height_minus1[i] plus 1 specifies the height of the i-th tile row in units of CTBs for i in the range of 0 to pps_num_exp_tile_rows_minus1, inclusive. pps_tile_row_height_minus1[pps_num_exp_tile_rows_minus1] is also used to derive the heights of the tile rows with index greater than pps_num_exp_tile_rows_minus1 as specified. The value of pps_tile_row_height_minus1[i] shall be in the range of 0 to PicHeightInCtbsY−1, inclusive. When not present, the value of pps_tile_row_height_minus1[0] is inferred to be equal to PicHeightInCtbsY−1.
pps_loop_filter_across_tiles_enabled_flag equal to 1 specifies that in-loop filtering operations across tile boundaries are enabled for pictures referring to the PPS.
pps_loop_filter_across_tiles_enabled_flag equal to 0 specifies that in-loop filtering operations across tile boundaries are disabled for pictures referring to the PPS. The in-loop filtering operations include the deblocking filter, SAO, and ALF operations. When not present, the value of pps_loop_filter_across_tiles_enabled_flag is inferred to be equal to 0.
pps_rect_slice_flag equal to 0 specifies that the raster-san slice mode is in use for each picture referring to the PPS and the slice layout is not signalled in PPS. pps_rect_slice_flag equal to 1 specifies that the rectangular slice mode is in use for each picture referring to the PPS and the slice layout is signalled in the PPS. When not present, the value of pps_rect_slice_flag is inferred to be equal to 1. When sps_subpic_info_present_flag is equal to 1 or pps_mixed_nalu_types_in_pic_flag is equal to 1, the value of pps_rect_slice_flag shall be equal to 1.
pps_single_slice_per_subpic_flag equal to 1 specifies that each subpicture consists of one and only one rectangular slice. pps_single_slice_per_subpic_flag equal to 0 specifies that each subpicture could consist of one or more rectangular slices. When pps_no_pic_partition_flag is equal to 1, the value of pps_single_slice_per_subpic_flag is inferred to be equal to 1.
NOTE—When there is only one subpicture per picture, pps_single_slice_per_subpic_flag equal to 1 means that there is only one slice per picture.
   pps_num_slices_in_pic_minus1 plus 1 specifies the number of rectangular slices in each picture referring to the PPS. The value of pps_num_slices_in_pic_minus1 shall be in the range of 0 to MaxSlicesPerAu−1, inclusive, where MaxSlicesPerAu is specified. When pps_no_pic_partition_flag is equal to 1, the value of pps_num_slices_in_pic_minus1 is inferred to be equal to 0. When pps_single_slice_per_subpic_flag is equal to 1, the value of pps_num_slices_in_pic_minus1 is inferred to be equal to sps_num_subpics_minus1.
   pps_tile_idx_delta_present_flag equal to 0 specifies that pps_tile_idx_delta_val[i] syntax elements are not present in the PPS and all pictures referring to the PPS are partitioned into rectangular slice rows and rectangular slice columns in slice raster order. pps_tile_idx_delta_present_flag equal to 1 specifies that pps_tile_idx_delta_val[i] syntax elements could be present in the PPS and all rectangular slices in pictures referring to the PPS are specified in the order indicated by the values of the pps_tile_idx_delta_val[i] in increasing values of i. When not present, the value of pps_tile_idx_delta_present_flag is inferred to be equal to 0.
   pps_slice_width_in_tiles_minus1[i] plus 1 specifies the width of the i-th rectangular slice in units of tile columns. The value of pps_slice_width_in_tiles_minus1[i] shall be in the range of 0 to NumTileColumns−1, inclusive. When not present, the value of pps_slice_width_in_tiles_minus1[i] is inferred to be equal to 0.
   pps_slice_height_in_tiles_minus1[i] plus 1 specifies the height of the i-th rectangular slice in units of tile rows when pps_num_exp_slices_in_tile[i] is equal to 0. The value of pps_slice_height_in_tiles_minus1[i] shall be in the range of 0 to NumTileRows−1, inclusive.
   When pps_slice_height_in_tiles_minus1[i] is not present, it is inferred as follows:
If SliceTopLeftTileIdx[i]/NumTileColumns is equal to NumTileRows−1, the value of pps_slice_height_in_tiles_minus1[i] is inferred to be equal to 0.
Otherwise, the value of pps_slice_height_in_tiles_minus1[i] is inferred to be equal to pps_slice_height_in_tiles_minus1[i−1].
   pps_num_exp_slices_in_tile[i] specifies the number of explicitly provided slice heights for the slices in the tile containing the i-th slice (i.e., the tile with tile index equal to SliceTopLeftTileIdx[i]). The value of pps_num_exp_slices_in_tile[i] shall be in the range of 0 to RowHeightVal[SliceTopLeftTileIdx[i]/NumTileColumns]−1, inclusive. When not present, the value of pps_num_exp_slices_in_tile[i] is inferred to be equal to 0.
NOTE—If pps_num_exp_slices_in_tile[i] is equal to 0, the tile containing the i-th slice is not split into multiple slices. Otherwise (pps_num_exp_slices_in_tile[i] is greater than 0), the tile containing the i-th slice might or might not be split into multiple slices.
   pps_exp_slice_height_in_ctus_minus1[i][j] plus 1 specifies the height of the j-th rectangular slice in the tile containing the i-th slice, in units of CTU rows, for j in the range of 0 to pps_num_exp_slices_in_tile[i]−1, inclusive, when pps_num_exp_slices_in_tile[i] is greater than 0. pps_exp_slice_height_in_ctus_minus1[i][pps_num_exp_slices_in_tile[i] ] is also used to derive the heights of the rectangular slices in the tile containing the i-th slice with index greater than pps_num_exp_slices_in_tile[i]−1 as specified. The value of pps_exp_slice_height_in_ctus_minus1[i][j] shall be in the range of 0 to RowHeightVal[SliceTopLeftTileIdx[i]/NumTileColumns]−1, inclusive.
   pps_tile_idx_delta_val[i] specifies the difference between the tile index of the tile containing the first CTU in the (i+1)-th rectangular slice and the tile index of the tile containing the first CTU in the i-th rectangular slice. The value of pps_tile_idx_delta_val[i] shall be in the range of −NumTilesInPic+1 to NumTilesInPic−1, inclusive. When not present, the value of pps_tile_idx_delta_val[i] is inferred to be equal to 0. When present, the value of pps_tile_idx_delta_val[i] shall not be equal to 0.
   When pps_rect_slice_flag is equal to 1, it is a requirement of bitstream conformance that, for any two slices, with picture-level slice indices idxA and idxB, that belong to the same picture and different subpictures, when SubpicIdxForSlice[idxA] is less than SubpicIdxForSlice[idxB], the value of idxA shall be less than idxB.
   pps_loop_filter_across_slices_enabled_flag equal to 1 specifies that in-loop filtering operations across slice boundaries are enabled for pictures referring to the PPS. loop_filter_across_slice_enabled_flag equal to 0 specifies that in-loop filtering operations across slice boundaries are disabled for the PPS. The in-loop filtering operations include the deblocking filter, SAO, and ALF operations. When not present, the value of pps_loop_filter_across_slices_enabled_flag is inferred to be equal to 0.
   pps_cabac_init_present_flag equal to 1 specifies that sh_cabac_init_flag is present in slice headers referring to the PPS. pps_cabac_init_present_flag equal to 0 specifies that sh_cabac_init_flag is not present in slice headers referring to the PPS.
   pps_num_ref_idx_default_active_minus1[i] plus 1, when i is equal to 0, specifies the inferred value of the variable NumRefIdxActive[0] for P or B slices with sh_num_ref_idx_active_override_flag equal to 0, and, when i is equal to 1, specifies the inferred value of NumRefIdxActive[1] for B slices with sh_num_ref_idx_active_override_flag equal to 0. The value of pps_num_ref_idx_default_active_minus1[i] shall be in the range of 0 to 14, inclusive.
   pps_rpl1_idx_present_flag equal to 0 specifies that rpl_sps_flag[1] and rpl_idx[1] are not present in the PH syntax structures or the slice headers for pictures referring to the PPS.
   pps_rpl1_idx_present_flag equal to 1 specifies that rpl_sps_flag[1] and rpl_idx[1] could be present in the PH syntax structures or the slice headers for pictures referring to the PPS.
   pps_weighted_pred_flag equal to 0 specifies that weighted prediction is not applied to P slices referring to the PPS. pps_weighted_pred_flag equal to 1 specifies that weighted prediction is applied to P slices referring to the PPS. When sps_weighted_pred_flag is equal to 0, the value of pps_weighted_pred_flag shall be equal to 0.
   pps_weighted_bipred_flag equal to 0 specifies that explicit weighted prediction is not applied to B slices referring to the PPS. pps_weighted_bipred_flag equal to 1 specifies that explicit weighted prediction is applied to B slices referring to the PPS. When sps_weighted_bipred_flag is equal to 0, the value of pps_weighted_bipred_flag shall be equal to 0.
   pps_ref_wraparound_enabled_flag equal to 1 specifies that the horizontal wrap-around motion compensation is enabled for pictures referring to the PPS. pps_ref_wraparound_enabled_flag equal to 0 specifies that the horizontal wrap-around motion compensation is disabled for pictures referring to the PPS.
   When sps_ref_wraparound_enabled_flag is equal to 0 or the value of CtbSizeY/MinCbSizeY+1 is greater than pps_pic_width_in_luma_samples/MinCbSizeY−1, the value of pps_ref_wraparound_enabled_flag shall be equal to 0.
   pps_pic_width_minus_wraparound_offset specifies the difference between the picture width and the offset used for computing the horizontal wrap-around position in units of MinCbSizeY luma samples. The value of pps_pic_width_minus_wraparound_offset shall be less than or equal to (pps_pic_width_in_luma_samples/MinCbSizeY)−(CtbSizeY/MinCbSizeY)−2.
   The variable PpsRefWraparoundOffset is set equal to pps_pic_width_in_luma_samples/MinCbSizeY−pps_pic_width_minus_wraparound_offset.
   pps_init_qp_minus26 plus 26 specifies the initial value of SliceQp_{Y} for each slice referring to the PPS. The initial value of SliceQp_{Y} is modified at the picture level when a non-zero value of ph_qp_delta is decoded or at the slice level when a non-zero value of sh_qp_delta is decoded. The value of pps_init_qp_minus26 shall be in the range of −(26+QpBdOffset) to +37, inclusive.
   pps_cu_qp_delta_enabled_flag equal to 1 specifies that either or both of the ph_cu_qp_delta_subdiv_intra_slice and ph_cu_qp_delta_subdiv_inter_slice syntax elements are present in PH syntax structures referring to the PPS, and the cu_qp_delta_abs and cu_qp_delta_sign_flag syntax elements could be present in the transform unit syntax and the palette coding syntax. pps_cu_qp_delta_enabled_flag equal to 0 specifies that the ph_cu_qp_delta_subdiv_intra_slice and ph_cu_qp_delta_subdiv_inter_slice syntax elements are not present in PH syntax structures referring to the PPS, and the cu_qp_delta_abs and cu_qp_delta_sign_flag syntax elements are not present in the transform unit syntax or the palette coding syntax.
   pps_chroma_tool_offsets_present_flag equal to 1 specifies that chroma tool offsets related syntax elements are present in the PPS RBSP syntax structure and the chroma deblocking t_{c} and β offset syntax elements could be present in the PH syntax structures or the SHs of pictures referring to the PPS. pps_chroma_tool_offsets_present_flag equal to 0 specifies that chroma tool offsets related syntax elements are not present in the PPS RBSP syntax structure and the chroma deblocking t_{c} and β offset syntax elements are not present in the PH syntax structures or the SHs of pictures referring to the PPS. When sps_chroma_format_idc is equal to 0, the value of pps_chroma_tool_offsets_present_flag shall be equal to 0.
   pps_cb_qp_offset and pps_cr_qp_offset specify the offsets to the luma quantization parameter Qp′_{Y} used for deriving Qp′_{Cb} and Qp′_{Cr}, respectively. The values of pps_cb_qp_offset and pps_cr_qp_offset shall be in the range of −12 to +12, inclusive. When sps_chroma_format_idc is equal to 0, pps_cb_qp_offset and pps_cr_qp_offset are not used in the decoding process and decoders shall ignore their value. When not present, the values of pps_cb_qp_offset and pps_cr_qp_offset are inferred to be equal to 0.
   pps_joint_cbcr_qp_offset_present_flag equal to 1 specifies that pps_joint_cbcr_qp_offset_value and pps_joint_cbcr_qp_offset_list[i] are present in the PPS RBSP syntax structure. pps_joint_cbcr_qp_offset_present_flag equal to 0 specifies that pps_joint_cbcr_qp_offset_value and pps_joint_cbcr_qp_offset_list[i] are not present in the PPS RBSP syntax structure. When sps_chroma_format_idc is equal to 0 or sps_joint_cbcr_enabled_flag is equal to 0, the value of pps_joint_cbcr_qp_offset_present_flag shall be equal to 0. When not present, the value of pps_joint_cbcr_qp_offset_present_flag is inferred to be equal to 0.
   pps_joint_cbcr_qp_offset_value specifies the offset to the luma quantization parameter Qp′_{Y} used for deriving Qp′_{CbCr}. The value of pps_joint_cbcr_qp_offset_value shall be in the range of −12 to +12, inclusive. When sps_chroma_format_idc is equal to 0 or sps_joint_cber_enabled_flag is equal to 0, pps_joint_cbcr_qp_offset_value is not used in the decoding process and decoders shall ignore its value. When pps_joint_cbcr_qp_offset_present_flag is equal to 0, pps_joint_cbcr_qp_offset_value is not present and is inferred to be equal to 0.
   pps_slice_chroma_qp_offsets_present_flag equal to 1 specifies that the sh_cb_qp_offset and sh_cr_qp_offset syntax elements are present in the associated slice headers. pps_slice_chroma_qp_offsets_present_flag equal to 0 specifies that the sh_cb_qp_offset and sh_cr_qp_offset syntax elements are not present in the associated slice headers. When not present, the value of pps_slice_chroma_qp_offsets_present_flag is inferred to be equal to 0.
   pps_cu_chroma_qp_offset_list_enabled_flag equal to 1 specifies that the ph_cu_chroma_qp_offset_subdiv_intra_slice and ph_cu_chroma_qp_offset_subdiv_inter_slice syntax elements are present in PH syntax structures referring to the PPS and cu_chroma_qp_offset_flag could be present in the transform unit syntax and the palette coding syntax. pps_cu_chroma_qp_offset_list_enabled_flag equal to 0 specifies that the ph_cu_chroma_qp_offset_subdiv_intra_slice and ph_cu_chroma_qp_offset_subdiv_inter_slice syntax elements are not present in PH syntax structures referring to the PPS and the cu_chroma_qp_offset_flag is not present in the transform unit syntax and the palette coding syntax. When not present, the value of pps_cu_chroma_qp_offset_list_enabled_flag is inferred to be equal to 0.
   pps_chroma_qp_offset_list_len_minus1 plus 1 specifies the number of pps_cb_qp_offset_list[i], pps_cr_qp_offset_list[i], and pps_joint_cbcr_qp_offset_list[i], syntax elements that are present in the PPS RBSP syntax structure. The value of pps_chroma_qp_offset_list_len_minus1 shall be in the range of 0 to 5, inclusive.
   pps_cb_qp_offset_list[i], pps_cr_qp_offset_list[i], and pps_joint_cbcr_qp_offset_list[i], specify offsets used in the derivation of Qp′_{Cb}, Qp′_{Cr}, and Qp′_{CbCr}, respectively. The values of pps_cb_qp_offset_list[i], pps_cr_qp_offset_list[i], and pps_joint_cbcr_qp_offset_list[i] shall be in the range of −12 to +12, inclusive. When pps_joint_cbcr_qp_offset_present_flag is equal to 0, pps_joint_cbcr_qp_offset_list[i] is not present and it is inferred to be equal to 0.
   pps_deblocking_filter_control_present_flag equal to 1 specifies the presence of deblocking filter control syntax elements in the PPS. pps_deblocking_filter_control_present_flag equal to 0 specifies the absence of deblocking filter control syntax elements in the PPS and that the deblocking filter is applied for all slices referring to the PPS, using 0-valued deblocking β and t_{C} offsets.
   pps_deblocking_filter_override_enabled_flag equal to 1 specifies that the deblocking behaviour for pictures referring to the PPS could be overridden in the picture level or slice level. pps_deblocking_filter_override_enabled_flag equal to 0 specifies that the deblocking behaviour for pictures referring to the PPS is not overridden in the picture level or slice level. When not present, the value of pps_deblocking_filter_override_enabled_flag is inferred to be equal to 0.
   pps_deblocking_filter_disabled_flag equal to 1 specifies that the deblocking filter is disabled for pictures referring to the PPS unless overridden for a picture or slice by information present the PH or SH, respectively. pps_deblocking_filter_disabled_flag equal to 0 specifies that the deblocking filter is enabled for pictures referring to the PPS unless overridden for a picture or slice by information present the PH or SH, respectively. When not present, the value of pps_deblocking_filter_disabled_flag is inferred to be equal to 0.
NOTE—When pps_deblocking_filter_disabled_flag equal is equal to 1 for a slice, the deblocking filter is disabled for the slice when one of the following two conditions is true: 1) ph_deblocking_filter_disabled_flag and sh_deblocking_filter_disabled_flag are not present and inferred to be equal to 1 and 2) ph_deblocking_filter_disabled_flag or sh_deblocking_filter_disabled_flag is present and equal to 1, and the deblocking filter is enabled for the slice when one of the following two conditions is true: 1) ph_deblocking_filter_disabled_flag and sh_deblocking_filter_disabled_flag are not present and inferred to be equal to 0 and 2) ph_deblocking_filter_disabled_flag or sh_deblocking_filter_disabled_flag is present and equal to 0.
NOTE—When pps_deblocking_filter_disabled_flag is equal to 0 for a slice, the deblocking filter is enabled for the slice when one of the following two conditions is true: 1) ph_deblocking_filter_disabled_flag and sh_deblocking_filter_disabled_flag are not present and 2) ph_deblocking_filter_disabled_flag or sh_deblocking_filter_disabled_flag is present and equal to 0, and the deblocking filter is disabled for the slice when ph_deblocking_filter_disabled_flag or sh_deblocking_filter_disabled_flag is present and equal to 1.
   pps_dbf_info_in_ph_flag equal to 1 specifies that deblocking filter information is present in the PH syntax structure and not present in slice headers referring to the PPS that do not contain a PH syntax structure. pps_dbf_info_in_ph_flag equal to 0 specifies that deblocking filter information is not present in the PH syntax structure and could be present in slice headers referring to the PPS. When not present, the value of pps_dbf_info_in_ph_flag is inferred to be equal to 0.
   pps_luma_beta_offset_div2 and pps_luma_tc_offset_div2 specify the default deblocking parameter offsets for β and tC (divided by 2) that are applied to the luma component for slices referring to the PPS, unless the default deblocking parameter offsets are overridden by the deblocking parameter offsets present in the picture headers or the slice headers of the slices referring to the PPS. The values of pps_luma_beta_offset_div2 and pps_luma_tc_offset_div2 shall both be in the range of −12 to 12, inclusive. When not present, the values of pps_luma_beta_offset_div2 and pps_luma_tc_offset_div2 are both inferred to be equal to 0.
   pps_cb_beta_offset_div2 and pps_cb_tc_offset_div2 specify the default deblocking parameter offsets for β and tC (divided by 2) that are applied to the Cb component for slices referring to the PPS, unless the default deblocking parameter offsets are overridden by the deblocking parameter offsets present in the picture headers or the slice headers of the slices referring to the PPS. The values of pps_cb_beta_offset_div2 and pps_cb_tc_offset_div2 shall both be in the range of −12 to 12, inclusive. When not present, the values of pps_cb_beta_offset_div2 and pps_cb_tc_offset_div2 are inferred to be equal to pps_luma_beta_offset_div2 and pps_luma_tc_offset_div2, respectively.
   pps_cr_beta_offset_div2 and pps_cr_tc_offset_div2 specify the default deblocking parameter offsets for β and tC (divided by 2) that are applied to the Cr component for slices referring to the PPS, unless the default deblocking parameter offsets are overridden by the deblocking parameter offsets present in the picture headers or the slice headers of the slices referring to the PPS. The values of pps_cr_beta_offset_div2 and pps_cr_tc_offset_div2 shall both be in the range of −12 to 12, inclusive. When not present, the values of pps_cr_beta_offset_div2 and pps_cr_tc_offset_div2 are inferred to be equal to pps_luma_beta_offset_div2 and pps_luma_tc_offset_div2, respectively.
   pps_rpl_info_in_ph_flag equal to 1 specifies that RPL information is present in the PH syntax structure and not present in slice headers referring to the PPS that do not contain a PH syntax structure. pps_rpl_info_in_ph_flag equal to 0 specifies that RPL information is not present in the PH syntax structure and could be present in slice headers referring to the PPS. When not present, the value of pps_rpl_info_in_ph_flag is inferred to be equal to 0.
   pps_sao_info_in_ph_flag equal to 1 specifies that SAO filter information could be present in the PH syntax structure and not present in slice headers referring to the PPS that do not contain a PH syntax structure. pps_sao_info_in_ph_flag equal to 0 specifies that SAO filter information is not present in the PH syntax structure and could be present in slice headers referring to the PPS. When not present, the value of pps_sao_info_in_ph_flag is inferred to be equal to 0.
   pps_alf_info_in_ph_flag equal to 1 specifies that ALF information could be present in the PH syntax structure and not present in slice headers referring to the PPS that do not contain a PH syntax structure. pps_alf_info_in_ph_flag equal to 0 specifies that ALF information is not present in the PH syntax structure and could be present in slice headers referring to the PPS. When not present, the value of pps_alf_info_in_ph_flag is inferred to be equal to 0.
   pps_wp_info_in_ph_flag equal to 1 specifies that weighted prediction information could be present in the PH syntax structure and not present in slice headers referring to the PPS that do not contain a PH syntax structure. pps_wp_info_in_ph_flag equal to 0 specifies that weighted prediction information is not present in the PH syntax structure and could be present in slice headers referring to the PPS. When not present, the value of pps_wp_info_in_ph_flag is inferred to be equal to 0.
   pps_qp_delta_info_in_ph_flag equal to 1 specifies that QP delta information is present in the PH syntax structure and not present in slice headers referring to the PPS that do not contain a PH syntax structure. pps_qp_delta_info_in_ph_flag equal to 0 specifies that QP delta information is not present in the PH syntax structure and is present in slice headers referring to the PPS. When not present, the value of pps_qp_delta_info_in_ph_flag is inferred to be equal to 0.
   pps_picture_header_extension_present_flag equal to 0 specifies that no PH extension syntax elements are present in PH syntax structures referring to the PPS. pps_picture_header_extension_present_flag equal to 1 specifies that PH extension syntax elements are present in PH syntax structures referring to the PPS. pps_picture_header_extension_present_flag shall be equal to 0 in bitstreams conforming to this version of this Specification. However, some use of pps_picture_header_extension_present_flag equal to 1 could be specified in some future version of this Specification, and decoders conforming to this version of this Specification shall allow the value of pps_picture_header_extension_present_flag equal to 1 to appear in the syntax.
   pps_slice_header_extension_present_flag equal to 0 specifies that no slice header extension syntax elements are present in the slice headers for coded pictures referring to the PPS. pps_slice_header_extension_present_flag equal to 1 specifies that slice header extension syntax elements are present in the slice headers for coded pictures referring to the PPS. pps_slice_header_extension_present_flag shall be equal to 0 in bitstreams conforming to this version of this Specification. However, some use of pps_slice_header_extension_present_flag equal to 1 could be specified in some future version of this Specification, and decoders conforming to this version of this Specification shall allow the value of pps_slice_header_extension_present_flag equal to 1 to appear in the syntax.
   pps_extension_flag equal to 0 specifies that no pps_extension_data_flag syntax elements are present in the PPS RBSP syntax structure. pps_extension_flag equal to 1 specifies that pps_extension_data_flag syntax elements might be present in the PPS RBSP syntax structure. pps_extension_flag shall be equal to 0 in bitstreams conforming to this version of this Specification. However, some use of pps_extension_flag equal to 1 could be specified in some future version of this Specification, and decoders conforming to this version of this Specification shall allow the value of pps_extension_flag equal to 1 to appear in the syntax.
   pps_extension_data_flag could have any value. Its presence and value do not affect the decoding process specified in this version of this Specification. Decoders conforming to this version of this Specification shall ignore all pps_extension_data_flag syntax elements.

As provided in Table 2, a NAL unit may include an adaptation_parameter_set_rbsp( ).

TABLE 5

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

With respect to Table 5, JVET-T2001 provides the following semantics:

Each APS RBSP shall be available to the decoding process prior to it being referenced, included in at least one AU with TemporalId less than or equal to the TemporalId of the coded slice NAL unit that refers it or provided through external means.

All APS NAL units with a particular value of nal_unit_type, a particular value of aps_adaptation_parameter_set_id, and a particular value of aps_params_type within a PU shall have the same content.

aps_params_type specifies the type of APS parameters carried in the APS as specified in Table 6. The value of aps_params_type shall be in the range of 0 to 2, inclusive, in bitstreams conforming to this version of this Specification. Other values of aps_params_type are reserved for future use by ITU-T|ISO/IEC. Decoders conforming to this version of this Specification shall ignore APS NAL units with reserved values of aps_params_type.

TABLE 6

| | Name of | |
|---|---|---|
| aps_params_type | aps_params_type | Type of APS parameters |
| 0 | ALF_APS | ALF parameters |
| 1 | LMCS_APS | LMCS parameters |
| 2 | SCALING_APS | Scaling list parameters |

All APS NAL units with a particular value of aps_params_type, regardless of the nuh_layer_id values and whether they are prefix or suffix APS NAL units, share the same value space for aps_adaptation_parameter_set_id. APS NAL units with different values of aps_params_type use separate values spaces for aps_adaptation_parameter_set_id.
aps_adaptation_parameter_set_id provides an identifier for the APS for reference by other syntax elements.

When aps_params_type is equal to ALF_APS or SCALING_APS, the value of aps_adaptation_parameter_set_id shall be in the range of 0 to 7, inclusive.

When aps_params_type is equal to LMCS_APS, the value of aps_adaptation_parameter_set_id shall be in the range of 0 to 3, inclusive.

Let apsLayerId be the value of the nuh_layer_id of a particular APS NAL unit, and velLayerId be the value of the nuh_layer_id of a particular VCL NAL unit. The particular VCL NAL unit shall not refer to the particular APS NAL unit unless apsLayerId is less than or equal to velLayerId and all OLSs specified by the VPS that contain the layer with nuh_layer_id equal to vclLayerId also contain the layer with nuh_layer_id equal to apsLayerId.
NOTE—In a CVS that contains only one layer, the nuh_layer_id of referenced APSs is equal to the nuh_layer_id of the VCL NAL units.
NOTE—An APS NAL unit (with a particular value of nal_unit_type, a particular value of aps_adaptation_parameter_set_id, and a particular value of aps_params_type) could be shared across pictures, and different slices within a picture can refer to different ALF APSs.
NOTE—A suffix APS NAL unit associated with a particular VCL NAL unit (this VCL NAL unit precedes the suffix APS NAL unit in decoding order) is not for use by the particular VCL NAL unit, but for use by VCL NAL units following the suffix APS NAL unit in decoding order.
   aps_chroma_present_flag equal to 1 specifies that the APS NAL unit could include chroma related syntax elements. aps_chroma_present_flag equal to 0 specifies that the APS NAL unit does not include chroma related syntax elements.
   aps_extension_flag equal to 0 specifies that no aps_extension_data_flag syntax elements are present in the APS RBSP syntax structure. aps_extension_flag equal to 1 specifies that aps_extension_data_flag syntax elements might be present in the APS RBSP syntax structure. aps_extension_data_flag shall be equal to 0 in bitstreams conforming to this version of this Specification. However, some use of aps_extension_data_flag equal to 1 could be specified in some future version of this Specification, and decoders conforming to this version of this Specification shall allow the value of aps_extension_data_flag equal to 1 to appear in the syntax.
   aps_extension_data_flag could have any value. Its presence and value do not affect the decoding process specified in this version of this Specification. Decoders conforming to this version of this Specification shall ignore all aps_extension_data_flag syntax elements.

As provided in Table 2, a NAL unit may include a picture_header_rbsp( ) which includes a picture header syntax structure, picture_header_structure( ). Table 7 illustrates the syntax of the picture header syntax structure provided in JVET-T2001.

TABLE 7

| | Descriptor |
|---|---|
| picture_header_structure( ) { | |
| ph_gdr_or_irap_pic_flag | u(1) |
| ph_non_ref_pic_flag | u(1) |
| if( ph_gdr_or_irap_pic_flag ) | |
| ph_gdr_pic_flag | u(1) |
| ph_inter_slice_allowed_flag | u(1) |
| if( ph_inter_slice_allowed_flag ) | |
| ph_intra_slice_allowed_flag | u(1) |
| ph_pic_parameter_set_id | ue(v) |
| ph_pic_order_cnt_lsb | u(v) |
| if( ph_gdr_pic_flag ) | |
| ph_recovery_poc_cnt | ue(v) |
| for( i = 0; i < NumExtraPhBits; i++ ) | |
| ph_extra_bit[ i ] | u(1) |
| if( sps_poc_msb_cycle_flag ) { | |
| ph_poc_msb_cycle_present_flag | u(1) |
| if( ph_poc_msb_cycle_present_flag ) | |
| ph_poc_msb_cycle_val | u(v) |
| } | |
| if( sps_alf_enabled_flag && pps_alf_info_in_ph_flag ) { | |
| ph_alf_enabled_flag | u(1) |
| if( ph_alf_enabled_flag ) { | |
| ph_num_alf_aps_ids_luma | u(3) |
| for( i = 0; i < ph_num_alf_aps_ids_luma; i++ ) | |
| ph_alf_aps_id_luma[ i ] | u(3) |
| if( sps_chroma_format_idc != 0 ) { | |
| ph_alf_cb_enabled_flag | u(1) |
| ph_alf_cr_enabled_flag | u(1) |
| } | |
| if( ph_alf_cb_enabled_flag \| \| ph_alf_cr_enabled_flag ) | |
| ph_alf_aps_id_chroma | u(3) |
| if( sps_ccalf_enabled_flag ) { | |
| ph_alf_cc_cb_enabled_flag | u(1) |
| if( ph_alf_cc_cb_enabled_flag ) | |
| ph_alf_cc_cb_aps_id | u(3) |
| ph_alf_cc_cr_enabled_flag | u(1) |
| if( ph_alf_cc_cr_enabled_flag ) | |
| ph_alf_cc_cr_aps_id | u(3) |
| } | |
| } | |
| } | |
| if( sps_lmcs_enabled_flag ) { | |
| ph_lmcs_enabled_flag | u(1) |
| if( ph_lmcs_enabled_flag ) { | |
| ph_lmcs_aps_id | u(2) |
| if( sps_chroma_format_idc != 0 ) | |
| ph_chroma_residual_scale_flag | u(1) |
| } | |
| } | |
| if( sps_explicit_scaling_list_enabled_flag ) { | |
| ph_explicit_scaling_list_enabled_flag | u(1) |
| if( ph_explicit_scaling_list_enabled_flag ) | |
| ph_scaling_list_aps_id | u(3) |
| } | |
| if( sps_virtual_boundaries_enabled_flag | |
| && !sps_virtual_boundaries_present_flag ) { | |
| ph_virtual_boundaries_present_flag | u(1) |
| if( ph_virtual_boundaries_present_flag ) { | |
| ph_num_ver_virtual_boundaries | ue(v) |
| for( i = 0; i < ph_num_ver_virtual_boundaries; i++ ) | |
| ph_virtual_boundary_pos_x_minus1[ i ] | ue(v) |
| ph_num_hor_virtual_boundaries | ue(v) |
| for( i = 0; i < ph_num_hor_virtual_boundaries; i++ ) | |
| ph_virtual_boundary_pos_y_minus1[ i ] | ue(v) |
| } | |
| } | |
| if( pps_output_flag_present_flag && !ph_non_ref_pic_flag ) | |
| ph_pic_output_flag | u(1) |
| if( pps_rpl_info_in_ph_flag ) | |
| ref_pic_lists( ) | |
| if( sps_partition_constraints_override_enabled_flag ) | |
| ph_partition_constraints_override_flag | u(1) |
| if( ph_intra_slice_allowed_flag ) { | |
| if( ph_partition_constraints_override_flag ) { | |
| ph_log2_diff_min_qt_min_cb_intra_slice_luma | ue(v) |
| ph_max_mtt_hierarchy_depth_intra_slice_luma | ue(v) |
| if( ph_max_mtt_hierarchy_depth_intra_slice_luma != 0 ) { | |
| ph_log2_diff_max_bt_min_qt_intra_slice_luma | ue(v) |
| ph_log2_diff_max_tt_min_qt_intra_slice_luma | ue(v) |
| } | |
| if( sps_qtbtt_dual_tree_intra_flag ) { | |
| ph_log2_diff_min_qt_min_cb_intra_slice_chroma | ue(v) |
| ph_max_mtt_hierarchy_depth_intra_slice_chroma | ue(v) |
| if( ph_max_mtt_hierarchy_depth_intra_slice_chroma != 0 ) { | |
| ph_log2_diff_max_bt_min_qt_intra_slice_chroma | ue(v) |
| ph_log2_diff_max_tt_min_qt_intra_slice_chroma | ue(v) |
| } | |
| } | |
| } | |
| if( pps_cu_qp_delta_enabled_flag ) | |
| ph_cu_qp_delta_subdiv_intra_slice | ue(v) |
| if( pps_cu_chroma_qp_offset_list_enabled_flag ) | |
| ph_cu_chroma_qp_offset_subdiv_intra_slice | ue(v) |
| } | |
| if( ph_inter_slice_allowed_flag ) { | |
| if( ph_partition_constraints_override_flag ) { | |
| ph_log2_diff_min_qt_min_cb_inter_slice | ue(v) |
| ph_max_mtt_hierarchy_depth_inter_slice | ue(v) |
| if( ph_max_mtt_hierarchy_depth_inter_slice != 0 ) { | |
| ph_log2_diff_max_bt_min_qt_inter_slice | ue(v) |
| ph_log2_diff_max_tt_min_qt_inter_slice | ue(v) |
| } | |
| } | |
| if( pps_cu_qp_delta_enabled_flag ) | |
| ph_cu_qp_delta_subdiv_inter_slice | ue(v) |
| if( pps_cu_chroma_qp_offset_list_enabled_flag ) | |
| ph_cu_chroma_qp_offset_subdiv_inter_slice | ue(v) |
| if( sps_temporal_mvp_enabled_flag ) { | |
| ph_temporal_mvp_enabled_flag | u(1) |
| if( ph_temporal_mvp_enabled_flag && pps_rpl_info_in_ph_flag ) { | |
| if( num_ref_entries[ 1 ][ RplsIdx[ 1 ] ] > 0 ) | |
| ph_collocated_from_l0_flag | u(1) |
| if( ( ph_collocated_from_l0_flag && | |
| num_ref_entries[ 0 ][ RplsIdx[ 0 ] ] > 1 ) \| \| | |
| ( !ph_collocated_from_l0_flag && | |
| num_ref_entries[ 1 ][ RplsIdx[ 1 ] ] > 1 ) ) | |
| ph_collocated_ref_idx | ue(v) |
| } | |
| } | |
| if( sps_mmvd_fullpel_only_enabled_flag ) | |
| ph_mmvd_fullpel_only_flag | u(1) |
| presenceFlag = 0 | |
| if( !pps_rpl_info_in_ph_flag ) /* This condition is intentionally not | |
| merged into the next, | |
| to avoid possible interpretation of RplsIdx[ i ] not having a specified | |
| value. */ | |
| presenceFlag = 1 | |
| else if( num_ref_entries[ 1 ][ RplsIdx[ 1 ] ] > 0 ) | |
| presenceFlag = 1 | |
| if( presenceFlag ) { | |
| ph_mvd_l1_zero_flag | u(1) |
| if( sps_bdof_control_present_in_ph_flag ) | |
| ph_bdof_disabled_flag | u(1) |
| if( sps_dmvr_control_present_in_ph_flag ) | |
| ph_dmvr_disabled_flag | u(1) |
| } | |
| if( sps_prof_control_present_in_ph_flag ) | |
| ph_prof_disabled_flag | u(1) |
| if( ( pps_weighted_pred_flag \| \| pps_weighted_bipred_flag ) | |
| && | |
| pps_wp_info_in_ph_flag ) | |
| pred_weight_table( ) | |
| } | |
| if( pps_qp_delta_info_in_ph_flag ) | |
| ph_qp_delta | se(v) |
| if( sps_joint_cbcr_enabled_flag ) | |
| ph_joint_cbcr_sign_flag | u(1) |
| if( sps_sao_enabled_flag && pps_sao_info_in_ph_flag ) { | |
| ph_sao_luma_enabled_flag | u(1) |
| if( sps_chroma_format_idc != 0 ) | |
| ph_sao_chroma_enabled_flag | u(1) |
| } | |
| if( pps_dbf_info_in_ph_flag ) { | |
| ph_deblocking_params_present_flag | u(1) |
| if( ph_deblocking_params_present_flag ) { | |
| if( !pps_deblocking_filter_disabled_flag ) | |
| ph_deblocking_filter_disabled_flag | u(1) |
| if( !ph_deblocking_filter_disabled_flag ) { | |
| ph_luma_beta_offset_div2 | se(v) |
| ph_luma_tc_offset_div2 | se(v) |
| if( pps_chroma_tool_offsets_present_flag ) { | |
| ph_cb_beta_offset_div2 | se(v) |
| ph_cb_tc_offset_div2 | se(v) |
| ph_cr_beta_offset_div2 | se(v) |
| ph_cr_tc_offset_div2 | se(v) |
| } | |
| } | |
| } | |
| } | |
| if( pps_picture_header_extension_present_flag ) { | |
| ph_extension_length | ue(v) |
| for( i = 0; i < ph_extension_length; i++) | |
| ph_extension_data_byte[ i ] | u(8) |
| } | |
| } | |

With respect to Table 7, JVET-T2001 provides the following semantics:

The PH syntax structure contains information that is common for all slices of the current picture.
ph_gdr_or_irap_pic_flag equal to 1 specifies that the current picture is a GDR or IRAP picture. ph_gdr_orjirap_pic_flag equal to 0 specifies that the current picture is not a GDR picture and might or might not be an IRAP picture.
ph_non_ref_pic_flag equal to 1 specifies that the current picture is never used as a reference picture. ph_non_ref_pic_flag equal to 0 specifies that the current picture might or might not be used as a reference picture.
ph_gdr_pic_flag equal to 1 specifies that the current picture is a GDR picture. ph_gdr_pic_flag equal to 0 specifies that the current picture is not a GDR picture. When not present, the value of ph_gdr_pic_flag is inferred to be equal to 0. When sps_gdr_enabled_flag is equal to 0, the value of ph_gdr_pic_flag shall be equal to 0.
NOTE—When ph_gdr_or_irap_pic_flag is equal to 1 and ph_gdr_pic_flag is equal to 0, the current picture is an IRAP picture.
   ph_inter_slice_allowed_flag equal to 0 specifies that all coded slices of the picture have sh_slice_type equal to 2. ph_inter_slice_allowed_flag equal to 1 specifies that there might or might not be one or more coded slices in the picture that have sh_slice_type equal to 0 or 1.
   When ph_gdr_or_irap_pic_flag is equal to 1 and ph_gdr_pic_flag is equal to 0 (i.e., the picture is an IRAP picture), and vps_independent_layer_flag[GeneralLayerIdx[nuh_layer_id] ] is equal to 1, the value of ph_inter_slice_allowed_flag shall be equal to 0.
   ph_intra_slice_allowed_flag equal to 0 specifies that all coded slices of the picture have sh_slice_type equal to 0 or 1. ph_intra_slice_allowed_flag equal to 1 specifies that there might or might not be one or more coded slices in the picture that have sh_slice_type equal to 2. When not present, the value of ph_intra_slice_allowed_flag is inferred to be equal to 1.
NOTE—For bitstreams that are supposed to work for subpicture based bitstream merging without the need of changing PH NAL units, the encoder is expected to set the values of both ph_inter_slice_allowed_flag and ph_intra_slice_allowed_flag equal to 1.
   ph_pic_parameter_set_id specifies the value of pps_pic_parameter_set_id for the PPS in use. The value of ph_pic_parameter_set_id shall be in the range of 0 to 63, inclusive. It is a requirement of bitstream conformance that the value of TemporalId of the PH shall be greater than or equal to the value of TemporalId of the PPS that has pps_pic_parameter_set_id equal to ph_pic_parameter_set_id.
   ph_pic_order_cnt_lsb specifies the picture order count modulo MaxPicOrderCntLsb for the current picture. The length of the ph_pic_order_cnt_lsb syntax element is sps_log2_max_pic_order_cnt_lsb_minus4+4 bits. The value of the ph_pic_order_cnt_lsb shall be in the range of 0 to MaxPicOrderCntLsb−1, inclusive.
   ph_recovery_poc_cnt specifies the recovery point of decoded pictures in output order.
   When the current picture is a GDR picture, the variable recoveryPointPocVal is derived as follows:

$$recoveryPointPocVal = PicOrderCntVal + ph\_recovery \_poc \_cnt$$

If the current picture is a GDR picture and ph_recovery_poc_cnt is equal to 0, the current picture itself is also referred to as the recovery point. Otherwise, if the current picture is a GDR picture, and there is a picture picA that follows the current GDR picture in decoding order in the CLVS that has PicOrderCntVal equal to recoveryPointPocVal, the picture picA is referred to as the recovery point picture, otherwise, the first picture in output order that has PicOrderCntVal greater than recoveryPointPocVal in the CLVS is referred to as the recovery point picture. The recovery point picture shall not precede the current GDR picture in decoding order. The pictures that are associated with the current GDR picture and have PicOrderCntVal less than recoveryPointPocVal are referred to as the recovering pictures of the GDR picture. The value of ph_recovery_poc_cnt shall be in the range of 0 to MaxPicOrderCntLsb−1, inclusive.
NOTE—When sps_gdr_enabled_flag is equal to 1 and PicOrderCntVal of the current picture is greater than or equal to recoveryPointPocVal of the associated GDR picture, the current and subsequent decoded pictures in output order are exact match to the corresponding pictures produced by starting the decoding process from the previous IRAP picture, when present, preceding the associated GDR picture in decoding order.
   ph_extra_bit[i] could have any value. Decoders conforming to this version of this Specification shall ignore the presence and value of ph_extra_bit[i]. Its value does not affect the decoding process specified in this version of this Specification.
   ph_poc_msb_cycle_present_flag equal to 1 specifies that the syntax element ph_poc_msb_cycle_val is present in the PH syntax structure. ph_poc_msb_cycle_present_flag equal to 0 specifies that the syntax element ph_poc_msb_cycle_val is not present in the PH syntax structure. When vps_independent_layer_flag[GeneralLayerIdx[nuh_layer_id] ] is equal to 0 and there is an ILRP entry in RefPicList[0] or RefPicList[1] of a slice of the current picture, the value of ph_poc_msb_cycle_present_flag shall be equal to 0.
   ph_poc_msb_cycle_val specifies the value of the POC MSB cycle of the current picture. The length of the syntax element ph_poc_msb_cycle_val is sps_poc_msb_cycle_len_minus1+1 bits.
   When present, ph_alf_enabled_flag equal to 1 specifies that the adaptive loop filter is enabled for the current picture, and ph_alf_enabled_flag equal to 0 specifies that the adaptive loop filter is disabled for the current picture. When not present, the value of ph_alf_enabled_flag is inferred to be equal to 0.
   ph_num_alf_aps_ids_luma specifies the number of ALF APSs that the slices in the current picture refers to.
   ph_alf_aps_id_luma[i] specifies the aps_adaptation_parameter_set_id of the i-th ALF APS that the luma component of the slices in the current picture refers to.
   When ph_alf_aps_id_luma[i] is present, the following applies:
The value of alf_luma_filter_signal_flag of the APS NAL unit having aps_params_type equal to ALF_APS and aps_adaptation_parameter_set_id equal to ph_alf_aps_id_luma[i] shall be equal to 1.
The TemporalId of the APS NAL unit having aps_params_type equal to ALF_APS and aps_adaptation_parameter_set_id equal to ph_alf_aps_id_luma[i] shall be less than or equal to the TemporalId of the current picture.
When sps_chroma_format_idc is equal to 0, the value of aps_chroma_present_flag of the APS NAL unit having aps_params_type equal to ALF_APS and aps_adaptation_parameter_set_id equal to ph_alf_aps_id_luma[i] shall be equal to 0.
When sps_ccalf_enabled_flag is equal to 0, the values of alf_cc_cb_filter_signal_flag and alf_cc_cr_filter_signal_flag of the APS NAL unit having aps_params_type equal to ALF_APS and aps_adaptation_parameter_set_id equal to ph_alf_aps_id_luma[i] shall be equal to 0.
   When present, ph_alf_cb_enabled_flag equal to 1 specifies that the adaptive loop filter is enabled for the Cb colour component of the current picture, and ph_alf_cb_enabled_flag equal to 0 specifies that the adaptive loop filter is disabled for the Cb colour component of the current picture.
   When ph_alf_cb_enabled_flag is not present, it is inferred to be equal to 0.
   When present, ph_alf_cr_enabled_flag equal to 1 specifies that the adaptive loop filter is enabled for the Cr colour component of the current picture, and ph_alf_cr_enabled_flag equal to 0 specifies that the adaptive loop filter is disabled for the Cr colour component of the current picture. When ph_alf_cr_enabled_flag is not present, it is inferred to be equal to 0.
   ph_alf_aps_id_chroma specifies the aps_adaptation_parameter_set_id of the ALF APS that the chroma component of the slices in the current picture refers to.
   When ph_alf_aps_id_chroma is present, the following applies:
The value of alf_chroma_filter_signal_flag of the APS NAL unit having aps_params_type equal to ALF_APS and aps_adaptation_parameter_set_id equal to ph_alf_aps_id_chroma shall be equal to 1.
The TemporalId of the APS NAL unit having aps_params_type equal to ALF_APS and aps_adaptation_parameter_set_id equal to ph_alf_aps_id_chroma shall be less than or equal to the TemporalId of the current picture.
When sps_ccalf_enabled_flag is equal to 0, the values of alf_cc_cb_filter_signal_flag and alf_cc_cr_filter_signal_flag of the APS NAL unit having aps_params_type equal to ALF_APS and aps_adaptation_parameter_set_id equal to ph_alf_aps_id_chroma shall be equal to 0.
   When present, ph_alf_cc_cb_enabled_flag equal to 1 specifies that the cross-component adaptive loop filter for the Cb colour component is enabled for the current picture, and ph_alf_cc_cb_enabled_flag equal to 0 specifies that the cross-component adaptive loop filter for the Cb colour component is disabled for the current picture. When not present, the value of ph_alf_cc_cb_enabled_flag is inferred to be equal to 0.
   ph_alf_cc_cb_aps_id specifies the aps_adaptation_parameter_set_id of the ALF APS that the Cb colour component of the slices in the current picture refers to.
   When ph_alf_cc_cb_aps_id is present, the following applies:
The value of alf_cc_cb_filter_signal_flag of the APS NAL unit having aps_params_type equal to ALF_APS and aps_adaptation_parameter_set_id equal to ph_alf_cc_cb_aps_id shall be equal to 1.
The TemporalId of the APS NAL unit having aps_params_type equal to ALF_APS and aps_adaptation_parameter_set_id equal to ph_alf_cc_cb_aps_id shall be less than or equal to the TemporalId of the current picture.
   When present, ph_alf_cc_cr_enabled_flag equal to 1 specifies that the cross-component adaptive loop filter for the Cr colour component is enabled for the current picture, and ph_alf_cc_cr_enabled_flag equal to 0 specifies that the cross-component adaptive loop filter for the Cr colour component is disabled for the current picture. When not present, the value of ph_alf_cc_cr_enabled_flag is inferred to be equal to 0.
   ph_alf_cc_cr_aps_id specifies the aps_adaptation_parameter_set_id of the ALF APS that the Cr colour component of the slices in the current picture refers to.
   When ph_alf_cc_cr_aps_id is present, the following applies:
The value of alf_cc_cr_filter_signal_flag of the APS NAL unit having aps_params_type equal to ALF_APS and aps_adaptation_parameter_set_id equal to ph_alf_cc_cr_aps_id shall be equal to 1.
The TemporalId of the APS NAL unit having aps_params_type equal to ALF_APS and aps_adaptation_parameter_set_id equal to ph_alf_cc_cr_aps_id shall be less than or equal to the TemporalId of the current picture.
   ph_lmcs_enabled_flag equal to 1 specifies that LMCS is enabled for the current picture. ph_lmcs_enabled_flag equal to 0 specifies that LMCS is disabled for the current picture. When not present, the value of ph_lmcs_enabled_flag is inferred to be equal to 0.
   ph_lmcs_aps_id specifies the aps_adaptation_parameter_set_id of the LMCS APS that the slices in the current picture refers to.
   When ph_lmcs_aps_id is present, the following applies:
The TemporalId of the APS NAL unit having aps_params_type equal to LMCS_APS and aps_adaptation_parameter_set_id equal to ph_lmcs_aps_id shall be less than or equal to the TemporalId of the picture associated with PH.
When sps_chroma_format_idc is equal to 0, the value of aps_chroma_present_flag of the APS NAL unit having aps_params_type equal to LMCS_APS and aps_adaptation_parameter_set_id equal to ph_lmcs_aps_id shall be equal to 0.
The value of lmcs_delta_cw_prec_minus1 of the APS NAL unit having aps_params_type equal to LMCS_APS and aps_adaptation_parameter_set_id equal to ph_lmcs_aps_id shall be in the range of 0 to BitDepth−2, inclusive.
   ph_chroma_residual_scale_flag equal to 1 specifies that chroma residual scaling is enabled and could be used for the current picture. ph_chroma_residual_scale_flag equal to 0 specifies that chroma residual scaling is disabled and not used for the current picture. When ph_chroma_residual_scale_flag is not present, it is inferred to be equal to 0.
NOTE—When the current picture is a GDR picture or a recovering picture of a GDR picture, and the current picture contains a non-CTU-aligned boundary between a “refreshed area” (i.e., an area that has an exact match of decoded sample values when starting the decoding process from the GDR picture compared to starting the decoding process from the previous IRAP picture in decoding order, when present) and a “dirty area” (i.e., an area that might not have an exact match of decoded sample values when starting the decoding process from the GDR picture compared to starting the decoding process from the previous IRAP picture in decoding order, when present), chroma residual scaling of LMCS would have to be disabled in the current picture to avoid the “dirty area” to affect decoded sample values of the “refreshed area”.
   ph_explicit_scaling_list_enabled_flag equal to 1 specifies that the explicit scaling list is enabled for the current picture. ph_explicit_scaling_list_enabled_flag equal to 0 specifies that the explicit scaling list is disabled for the picture. When not present, the value of ph_explicit_scaling_list_enabled_flag is inferred to be equal to 0.
   ph_scaling_list_aps_id specifies the aps_adaptation_parameter_set_id of the scaling list APS.
   When ph_scaling_list_aps_id is present, the following applies:
The TemporalId of the APS NAL unit having aps_params_type equal to SCALING_APS and aps_adaptation_parameter_set_id equal to ph_scaling_list_aps_id shall be less than or equal to the TemporalId of the picture associated with PH.
The value of aps_chroma_present_flag of the APS NAL unit having aps_params_type equal to SCALING_APS and aps_adaptation_parameter_set_id equal to ph_scaling_list_aps_id shall be equal to sps_chroma_format_idc==0?0:1.
   ph_virtual_boundaries_present_flag equal to 1 specifies that information of virtual boundaries is signalled in the PH syntax structure. ph_virtual_boundaries_present_flag equal to 0 specifies that information of virtual boundaries is not signalled in the PH syntax structure. When there is one or more than one virtual boundary signalled in the PH syntax structure, the in-loop filtering operations are disabled across the virtual boundaries in the picture. The in-loop filtering operations include the deblocking filter, sample adaptive offset filter, and adaptive loop filter operations.
   When not present, the value of ph_virtual_boundaries_present_flag is inferred to be equal to 0.
   The variable VirtualBoundariesPresentFlag is derived as follows:

```
VirtualBoundariesPresentFlag = 0
if( sps_virtual_boundaries_enabled_flag )
  VirtualBoundariesPresentFlag = sps_virtual_boundaries_present_flag
  | |
    ph_virtual_boundaries_present_flag
```

ph_num_ver_virtual_boundaries specifies the number of ph_virtual_boundary_pos_x_minus1[i] syntax elements that are present in the PH syntax structure. The value of ph_num_ver_virtual_boundaries shall be in the range of 0 to (pps_pic_width_in_luma_samples<=8?0:3), inclusive. When ph_num_ver_virtual_boundaries is not present, it is inferred to be equal to 0.
The variable NumVerVirtualBoundaries is derived as follows:

```
NumVerVirtualBoundaries = 0
if( sps_virtual_boundaries_enabled_flag )
  NumVerVirtualBoundaries = sps_virtual_boundaries_present_flag ?
    sps_num_ver_virtual_boundaries :
    ph_num_ver_virtual_boundaries
```

ph_virtual_boundary_pos_x_minus1[i] plus 1 specifies the location of the i-th vertical virtual boundary in units of luma samples divided by 8. The value of ph_virtual_boundary_pos_x_minus1[i] shall be in the range of 0 to Ceil(pps_pic_width_in_luma_samples÷8)−2, inclusive.
The list VirtualBoundaryPosX[i] for i ranging from 0 to NumVerVirtualBoundaries−1, inclusive, in units of luma samples, specifying the locations of the vertical virtual boundaries, is derived as follows:

```
for( i = 0; i < NumVerVirtualBoundaries; i++)
  VirtualBoundaryPosX[ i ] = ( sps_virtual_boundaries_present_flag ?
    ( sps_virtual_boundary_pos_x_minus1[ i ] + 1 ) :
    ( ph_virtual_boundary_pos_x_minus1[ i ] + 1 ) ) * 8
```

The distance between any two vertical virtual boundaries shall be greater than or equal to CtbSizeY luma samples.
ph_num_hor_virtual_boundaries specifies the number of ph_virtual_boundary_pos_y_minus1[i] syntax elements that are present in the PH syntax structure. The value of ph_num_hor_virtual_boundaries shall be in the range of 0 to (pps_pic_height_in_luma_samples<=8?0:3), inclusive. When ph_num_hor_virtual_boundaries is not present, it is inferred to be equal to 0.
The parameter NumHorVirtualBoundaries is derived as follows:

```
NumHorVirtualBoundaries = 0
if( sps_virtual_boundaries_enabled_flag )
  NumHorVirtualBoundaries = sps_virtual_boundaries_present_flag ?
    sps_num_hor_virtual_boundaries :
    ph_num_hor_virtual_boundaries
```

When sps_virtual_boundaries_enabled_flag is equal to 1 and ph_virtual_boundaries_present_flag is equal to 1, the sum of ph_num_ver_virtual_boundaries and ph_num_hor_virtual_boundaries shall be greater than 0.
ph_virtual_boundary_pos_y_minus1[i] plus 1 specifies the location of the i-th horizontal virtual boundary in units of luma samples divided by 8. The value of ph_virtual_boundary_pos_y_minus1[i] shall be in the range of 0 to Ceil(pps_pic_height_in_luma_samples÷8)−2, inclusive.
The list VirtualBoundaryPosY[i] for i ranging from 0 to NumHorVirtualBoundaries−1, inclusive, in units of luma samples, specifying the locations of the horizontal virtual boundaries, is derived as follows:

```
for( i = 0; i < NumHorVirtualBoundaries; i++)
  VirtualBoundaryPosY[ i ] = ( sps_virtual_boundaries_present_flag ?
    ( sps_virtual_boundary_pos_y_minus1[ i ] + 1 ) :
    ( ph_virtual_boundary_pos_y_minus1[ i ] + 1 ) ) * 8
```

The distance between any two horizontal virtual boundaries shall be greater than or equal to CtbSizeY luma samples.
ph_pic_output_flag affects the decoded picture output and removal processes as specified. When ph_pic_output_flag is not present, it is inferred to be equal to 1.
It is a requirement of bitstream conformance that the bitstream shall contain at least one picture with pic_output_flag equal to 1 that is in an output layer.
NOTE—There is no picture in the bitstream that has ph_non_ref_pic_flag equal to 1 and ph_pic_output_flag equal to 0.
   ph_partition_constraints_override_flag equal to 1 specifies that partition constraint parameters are present in the PH syntax structure. ph_partition_constraints_override_flag equal to 0 specifies that partition constraint parameters are not present in the PH syntax structure. When not present, the value of ph_partition_constraints_override_flag is inferred to be equal to 0.
   ph_log2_diff_min_qt_min_cb_intra_slice_luma specifies the difference between the base 2 logarithm of the minimum size in luma samples of a luma leaf block resulting from quadtree splitting of a CTU and the base 2 logarithm of the minimum coding block size in luma samples for luma CUs in the slices with sh_slice_type equal to 2 (I) in the current picture. The value of ph_log2_diff_min_qt_min_cb_intra_slice_luma shall be in the range of 0 to Min(6, CtbLog2SizeY)−MinCbLog2SizeY, inclusive. When not present, the value of ph_log2_diff_min_qt_min_cb_intra_slice_luma is inferred to be equal to sps_log2_diff_min_qt_min_cb_intra_slice_luma.
   The value of MinQtLog2SizeIntraY is updated as follows:

$$MinQtLog 2 SizeIntraY = {ph}_{-} log2\_diff \_min \_qt \_min \_cb \_intra \_slice \_luma + MinCbLog 2 SizeY$$

ph_max_mtt_hierarchy_depth_intra_slice_luma specifies the maximum hierarchy depth for coding units resulting from multi-type tree splitting of a quadtree leaf in slices with sh_slice_type equal to 2 (I) in the current picture. The value of ph_max_mtt_hierarchy_depth_intra_slice_luma shall be in the range of 0 to 2*(CtbLog2SizeY−MinCbLog2SizeY), inclusive. When not present, the value of ph_max_mtt_hierarchy_depth_intra_slice_luma is inferred to be equal to sps_max_mtt_hierarchy_depth_intra_slice_luma.
ph_log2_diff_max_bt_min_qt_intra_slice_luma specifies the difference between the base 2 logarithm of the maximum size (width or height) in luma samples of a luma coding block that can be split using a binary split and the base 2 logarithm of the minimum size (width or height) in luma samples of a luma leaf block resulting from quadtree splitting of a CTU in slices with sh_slice_type equal to 2 (I) in the current picture. The value of ph_log2_diff_max_bt_min_qt_intra_slice_luma shall be in the range of 0 to (sps_qtbtt_dual_tree_intra_flag?Min(6, CtbLog2SizeY):CtbLog2SizeY)−MinQtLog2SizeIntraY, inclusive. When not present, the value of ph_log2_diff_max_bt_min_qt_intra_slice_luma is inferred to be equal to sps_log2_diff_max_bt_min_qt_intra_slice_luma.
ph_log2_diff_max_tt_min_qt_intra_slice_luma specifies the difference between the base 2 logarithm of the maximum size (width or height) in luma samples of a luma coding block that can be split using a ternary split and the base 2 logarithm of the minimum size (width or height) in luma samples of a luma leaf block resulting from quadtree splitting of a CTU in slices with sh_slice_type equal to 2 (I) in the current picture. The value of ph_log2_diff_max_tt_min_qt_intra_slice_luma shall be in the range of 0 to Min(6, CtbLog2SizeY)−MinQtLog2SizeIntraY, inclusive. When not present, the value of ph_log2_diff_max_tt_min_qt_intra_slice_luma is inferred to be equal to sps_log2_diff_max_tt_min_qt_intra_slice_luma.
ph_log2_diff_min_qt_min_cb_intra_slice_chroma specifies the difference between the base 2 logarithm of the minimum size in luma samples of a chroma leaf block resulting from quadtree splitting of a chroma CTU with treeType equal to DUAL_TREE_CHROMA and the base 2 logarithm of the minimum coding block size in luma samples for chroma CUs with treeType equal to DUAL_TREE_CHROMA in slices with sh_slice_type equal to 2 (I) in the current picture. The value of ph_log2_diff_min_qt_min_cb_intra_slice_chroma shall be in the range of 0 to Min(6, CtbLog2SizeY)−MinCbLog2SizeY, inclusive. When not present, the value of ph_log2_diff_min_qt_min_cb_intra_slice_chroma is inferred to be equal to sps_log2_diff_min_qt_min_cb_intra_slice_chroma.
The value of MinQtLog2SizeIntraC is updated as follows:

$$MinQtLog 2 SizeIntraC = ph\_log2 \_diff \_min \_qt \_min \_cb \_intra \_slice \_chroma + MinCbLog 2 SizeY$$

ph_max_mtt_hierarchy_depth_intra_slice_chroma specifies the maximum hierarchy depth for chroma coding units resulting from multi-type tree splitting of a chroma quadtree leaf with treeType equal to DUAL_TREE_CHROMA in slices with sh_slice_type equal to 2 (I) in the current picture. The value of ph_max_mtt_hierarchy_depth_intra_slice_chroma shall be in the range of 0 to 2*(CtbLog2SizeY−MinCbLog2SizeY), inclusive. When not present, the value of ph_max_mtt_hierarchy_depth_intra_slice_chroma is inferred to be equal to sps_max_mtt_hierarchy_depth_intra_slice_chroma.
ph_log2_diff_max_bt_min_qt_intra_slice_chroma specifies the difference between the base 2 logarithm of the maximum size (width or height) in luma samples of a chroma coding block that can be split using a binary split and the base 2 logarithm of the minimum size (width or height) in luma samples of a chroma leaf block resulting from quadtree splitting of a chroma CTU with treeType equal to DUAL_TREE_CHROMA in slices with sh_slice_type equal to 2 (I) in the current picture. The value of ph_log2_diff_max_bt_min_qt_intra_slice_chroma shall be in the range of 0 to Min(6, CtbLog2SizeY)−MinQtLog2SizeIntraC, inclusive. When not present, the value of ph_log2_diff_max_bt_min_qt_intra_slice_chroma is inferred to be equal to sps_log2_diff_max_bt_min_qt_intra_slice_chroma.
ph_log2_diff_max_tt_min_qt_intra_slice_chroma specifies the difference between the base 2 logarithm of the maximum size (width or height) in luma samples of a chroma coding block that can be split using a ternary split and the base 2 logarithm of the minimum size (width or height) in luma samples of a chroma leaf block resulting from quadtree splitting of a chroma CTU with treeType equal to DUAL_TREE_CHROMA in slices with sh_slice_type equal to 2 (I) in the current picture. The value of ph_log2_diff_max_tt_min_qt_intra_slice_chroma shall be in the range of 0 to Min(6, CtbLog2SizeY)−MinQtLog2SizeIntraC, inclusive. When not present, the value of ph_log2_diff_max_tt_min_qt_intra_slice_chroma is inferred to be equal to sps_log2_diff_max_tt_min_qt_intra_slice_chroma.
ph_cu_qp_delta_subdiv_intra_slice specifies the maximum cbSubdiv value of coding units in intra slice that convey cu_qp_delta_abs and cu_qp_delta_sign_flag. The value of ph_cu_qp_delta_subdiv_intra_slice shall be in the range of 0 to 2*(CtbLog2SizeY−MinQtLog2SizeIntraY+ph_max_mtt_hierarchy_depth_intra_slice_luma), inclusive.
When not present, the value of ph_cu_qp_delta_subdiv_intra_slice is inferred to be equal to 0.
ph_cu_chroma_qp_offset_subdiv_intra_slice specifies the maximum cbSubdiv value of coding units in intra slice that convey cu_chroma_qp_offset_flag. The value of ph_cu_chroma_qp_offset_subdiv_intra_slice shall be in the range of 0 to 2*(CtbLog2SizeY−MinQtLog2SizeIntraY+ph_max_mtt_hierarchy_depth_intra_slice_luma), inclusive.
When not present, the value of ph_cu_chroma_qp_offset_subdiv_intra_slice is inferred to be equal to 0.
ph_log2_diff_min_qt_min_cb_inter_slice specifies the difference between the base 2 logarithm of the minimum size in luma samples of a luma leaf block resulting from quadtree splitting of a CTU and the base 2 logarithm of the minimum luma coding block size in luma samples for luma CUs in the slices with sh_slice_type equal to 0 (B) or 1 (P) in the current picture. The value of ph_log2_diff_min_qt_min_cb_inter_slice shall be in the range of 0 to Min(6, CtbLog2SizeY)−MinCbLog2SizeY, inclusive. When not present, the value of ph_log2_diff_min_qt_min_cb_inter_slice is inferred to be equal to sps_log2_diff_min_qt_min_cb_inter_slice.
The value of MinQtLog2SizeInterY is updated as follows:

$$MinQtLog 2 size InterY = ph\_log2 \_diff \_min \_qt \_min \_cb \_inter \_slice + MinCbLog 2 SizeY$$

ph_max_mtt_hierarchy_depth_inter_slice specifies the maximum hierarchy depth for coding units resulting from multi-type tree splitting of a quadtree leaf in slices with sh_slice_type equal to 0 (B) or 1 (P) in the current picture. The value of ph_max_mtt_hierarchy_depth_inter_slice shall be in the range of 0 to 2*(CtbLog2SizeY−MinCbLog2SizeY), inclusive. When not present, the value of ph_max_mtt_hierarchy_depth_inter_slice is inferred to be equal to sps_max_mtt_hierarchy_depth_inter_slice.
ph_log2_diff_max_bt_min_qt_inter_slice specifies the difference between the base 2 logarithm of the maximum size (width or height) in luma samples of a luma coding block that can be split using a binary split and the base 2 logarithm of the minimum size (width or height) in luma samples of a luma leaf block resulting from quadtree splitting of a CTU in the slices with sh_slice_type equal to 0 (B) or 1 (P) in the current picture. The value of ph_log2_diff_max_bt_min_qt_inter_slice shall be in the range of 0 to CtbLog2SizeY−MinQtLog2SizeInterY, inclusive. When not present, the value of ph_log2_diff_max_bt_min_qt_inter_slice is inferred to be equal to sps_log2_diff_max_bt_min_qt_inter_slice.
ph_log2_diff_max_tt_min_qt_inter_slice specifies the difference between the base 2 logarithm of the maximum size (width or height) in luma samples of a luma coding block that can be split using a ternary split and the base 2 logarithm of the minimum size (width or height) in luma samples of a luma leaf block resulting from quadtree splitting of a CTU in slices with sh_slice_type equal to 0 (B) or 1 (P) in the current picture. The value of ph_log2_diff_max_tt_min_qt_inter_slice shall be in the range of 0 to Min(6, CtbLog2SizeY)−MinQtLog2SizeInterY, inclusive. When not present, the value of ph_log2_diff_max_tt_min_qt_inter_slice is inferred to be equal to sps_log2_diff_max_tt_min_qt_inter_slice.
ph_cu_qp_delta_subdiv_inter_slice specifies the maximum cbSubdiv value of coding units that in inter slice convey cu_qp_delta_abs and cu_qp_delta_sign_flag. The value of ph_cu_qp_delta_subdiv_inter_slice shall be in the range of 0 to 2*(CtbLog2SizeY−MinQtLog2SizeInterY+ph_max_mtt_hierarchy_depth_inter_slice), inclusive.
When not present, the value of ph_cu_qp_delta_subdiv_inter_slice is inferred to be equal to 0.
ph_cu_chroma_qp_offset_subdiv_inter_slice specifies the maximum cbSubdiv value of coding units in inter slice that convey cu_chroma_qp_offset_flag. The value of ph_cu_chroma_qp_offset_subdiv_inter_slice shall be in the range of 0 to 2*(CtbLog2SizeY−MinQtLog2SizeInterY+ph_max_mtt_hierarchy_depth_inter_slice), inclusive.
When not present, the value of ph_cu_chroma_qp_offset_subdiv_inter_slice is inferred to be equal to 0.
ph_temporal_mvp_enabled_flag equal to 1 specifies that temporal motion vector predictor is enabled for the current picture. ph_temporal_mvp_enabled_flag equal to 0 specifies that temporal motion vector predictor is disabled for the current picture. When not present, the value of ph_temporal_mvp_enabled_flag is inferred to be equal to 0.
NOTE—Due to the other existing constraints, the value of ph_temporal_mvp_enabled_flag could only be equal to 0 in a conforming bitstream when one or more of the following conditions are true: 1) no reference picture in the DPB has the same spatial resolution and the same scaling window offsets as the current picture, and 2) no reference picture in the DPB exists in the active entries of the RPLs of all slices in the current picture. Note that there are other, complicated conditions under which ph_temporal_mvp_enabled_flag could only be equal to 0 that are not listed.
   The maximum number of subblock-based merging MVP candidates, MaxNumSubblockMergeCand, is derived as follows:

```
if( sps_affine_enabled_flag )
  MaxNumSubblockMergeCand = 5 −
sps_five_minus_max_num_subblock_merge_cand
else
  MaxNumSubblockMergeCand =
sps_sbtmvp_enabled_flag && ph_temporal_mvp_enabled_flag
```

The value of MaxNumSubblockMergeCand shall be in the range of 0 to 5, inclusive.
ph_collocated_from_l0_flag equal to 1 specifies that the collocated picture used for temporal motion vector prediction is derived from RPL 0. ph_collocated_from_l0_flag equal to 0 specifies that the collocated picture used for temporal motion vector prediction is derived from RPL 1. When ph_temporal_mvp_enabled_flag and pps_rpl_info_in_ph_flag are both equal to 1 and num_ref_entries[1][RplsIdx[1] ] is equal to 0, the value of ph_collocated_from_l0_flag is inferred to be equal to 1.
ph_collocated_ref_idx specifies the reference index of the collocated picture used for temporal motion vector prediction.
When ph_collocated_from_l0_flag is equal to 1, ph_ollocated_ref_idx refers to an entry in RPL 0, and the value of ph_collocated_ref_idx shall be in the range of 0 to num_ref_entries[0][RplsIdx[0] ]−1, inclusive.
When ph_collocated_from_l0_flag is equal to 0, ph_collocated_ref_idx refers to an entry in RPL 1, and the value of ph_collocated_ref_idx shall be in the range of 0 to num_ref_entries[1][RplsIdx[1] ]−1, inclusive.
When not present, the value of ph_ollocated_ref_idx is inferred to be equal to 0.
ph_mmvd_fullpel_only_flag equal to 1 specifies that the merge mode with motion vector difference uses only integer sample precision for the current picture. ph_mmvd_fullpel_only_flag equal to 0 specifies that the merge mode with motion vector difference could use either fractional or integer sample precision for the current picture. When not present, the value of ph_mmvd_fullpel_only_flag is inferred to be 0.
ph_mvd_l1_zero_flag equal to 1 specifies that the mvd_coding(x0, y0, 1, cpIdx) syntax structure is not parsed and MvdL1[x0][y0][compIdx] and MvdCpL1[x0][y0][cpIdx][compIdx] are set equal to 0 for compIdx=0 . . . 1 and cpIdx=0 . . . 2. ph_mvd_l1_zero_flag equal to 0 specifies that the mvd_coding(x0, y0, 1, cpIdx) syntax structure is parsed. When not present, the value of ph_mvd_l1_zero_flag is inferred to be 1.
ph_bdof_disabled_flag equal to 1 specifies that the bi-directional optical flow inter prediction based inter bi-prediction is disabled for the current picture. ph_bdof_disabled_flag equal to 0 specifies that the bi-directional optical flow inter prediction based inter bi-prediction is enabled for the current picture.
When not present, the value of ph_bdof_disabled_flag is inferred as follows:
If sps_bdof_control_present_in_ph_flag is equal to 0, the value of ph_bdof_disabled_flag is inferred to be equal to 1−sps_bdof_enabled_flag.
Otherwise (sps_bdof_control_present_in_ph_flag is equal to 1), the value of ph_bdof_disabled_flag is inferred to be equal to 1.
   ph_dmvr_disabled_flag equal to 1 specifies that the decoder motion vector refinement based inter bi-prediction is disabled for the current picture. ph_dmvr_disabled_flag equal to 0 specifies that the decoder motion vector refinement based inter bi-prediction is enabled for the current picture.
   When not present, the value of ph_dmvr_disabled_flag is inferred as follows:
If sps_dmvr_control_present_in_ph_flag is equal to 0, the value of ph_dmvr_disabled_flag is inferred to be equal to 1−sps_dmvr_enabled_flag.
Otherwise (sps_dmvr_control_present_in_ph_flag is equal to 1), the value of ph_dmvr_disabled_flag is inferred to be equal to 1.
   ph_prof_disabled_flag equal to 1 specifies that prediction refinement with optical flow is disabled for the current picture. ph_prof_disabled_flag equal to 0 specifies that prediction refinement with optical flow is enabled for the current picture.
   When ph_prof_disabled_flag is not present, it is inferred as follows:
If sps_affine_prof_enabled_flag is equal to 1, the value of ph_prof_disabled_flag is inferred to be equal to 0.
Otherwise (sps_affine_prof_enabled_flag is equal to 0), the value of ph_prof_disabled_flag is inferred to be equal to 1.
   ph_qp_delta specifies the initial value of Qp_{Y} to be used for the coding blocks in the picture until modified by the value of CuQpDeltaVal in the coding unit layer.
   When pps_qp_delta_info_in_ph_flag is equal to 1, the initial value of the Qp_{Y} quantization parameter for all slices of the picture, SliceQp_{Y}, is derived as follows:

$${SliceQp}_{Y} = 26 + pps\_init \_qp \_minus26 + ph\_qp \_delta$$

The value of SliceQp_{Y} shall be in the range of −QpBdOffset to +63, inclusive.
ph_joint_cbcr_sign_flag specifies whether, in transform units with tu_joint_cbcr_residual_flag[x0][y0] equal to 1, the collocated residual samples of both chroma components have inverted signs. When tu_joint_cbcr_residual_flag[x0][y0] equal to 1 for a transform unit, ph_joint_cbcr_sign_flag equal to 0 specifies that the sign of each residual sample of the Cr (or Cb) component is identical to the sign of the collocated Cb (or Cr) residual sample and ph_joint_cbcr_sign_flag equal to 1 specifies that the sign of each residual sample of the Cr (or Cb) component is given by the inverted sign of the collocated Cb (or Cr) residual sample.
When present, ph_sao_luma_enabled_flag equal to 1 specifies that SAO is enabled for the luma component of the current picture, and ph_sao_luma_enabled_flag equal to 0 specifies that SAO is disabled for the luma component of the current picture. When ph_sao_luma_enabled_flag is not present, it is inferred to be equal to 0.
When present, ph_sao_chroma_enabled_flag equal to 1 specifies that SAO is enabled for the chroma component of the current picture, and ph_sao_chroma_enabled_flag equal to 0 specifies that SAO is disabled for the chroma component of the current picture. When ph_sao_chroma_enabled_flag is not present, it is inferred to be equal to 0.
ph_deblocking_params_present_flag equal to 1 specifies that the deblocking parameters could be present in the PH syntax structure. ph_deblocking_params_present_flag equal to 0 specifies that the deblocking parameters are not present in the PH syntax structure. When not present, the value of ph_deblocking_params_present_flag is inferred to be equal to 0.
When present, ph_deblocking_filter_disabled_flag equal to 1 specifies that the deblocking filter is disabled for the current picture, and ph_deblocking_filter_disabled_flag equal to 0 specifies that the deblocking filter is enabled for the current picture.
NOTE—When ph_deblocking_filter_disabled_flag is equal to 1, the deblocking filter is disabled for the slices of the current picture for which sh_deblocking_filter_disabled_flag is not present in the SHs and inferred to be equal to 1 or is present in the SHs and equal to 1, and the deblocking filter is enabled for the slices of the current picture for which sh_deblocking_filter_disabled_flag is not present in the SHs and inferred to be equal to 0 or is present in the SHs and equal to 0.
NOTE—When ph_deblocking_filter_disabled_flag is equal to 0, the deblocking filter is enabled for the slices of the current picture for which sh_deblocking_filter_disabled_flag is not present in the SHs and inferred to be equal to 0 or is present in the SHs and equal to 0, and the deblocking filter is not applied for the slices of the current picture for which sh_deblocking_filter_disabled_flag is not present in the SHs and inferred to be equal to 1 or is present in the SHs and equal to 1.
   When ph_deblocking_filter_disabled_flag is not present, it is inferred as follows:
If pps_deblocking_filter_disabled_flag and ph_deblocking_params_present_flag are both equal to 1, the value of ph_deblocking_filter_disabled_flag is inferred to be equal to 0.
Otherwise (pps_deblocking_filter_disabled_flag or ph_deblocking_params_present_flag is equal to 0), the value of ph_deblocking_filter_disabled_flag is inferred to be equal to pps_deblocking_filter_disabled_flag.
   ph_luma_beta_offset_div2 and ph_luma_tc_offset_div2 specify the deblocking parameter offsets for β and tC (divided by 2) that are applied to the luma component for the slices in the current picture. The values of ph_luma_beta_offset_div2 and ph_luma_tc_offset_div2 shall both be in the range of −12 to 12, inclusive. When not present, the values of ph_luma_beta_offset_div2 and ph_luma_tc_offset_div2 are inferred to be equal to pps_luma_beta_offset_div2 and pps_luma_tc_offset_div2, respectively.
   ph_cb_beta_offset_div2 and ph_cb_tc_offset_div2 specify the deblocking parameter offsets for β and tC (divided by 2) that are applied to the Cb component for the slices in the current picture. The values of ph_cb_beta_offset_div2 and ph_cb_tc_offset_div2 shall both be in the range of −12 to 12, inclusive.
   When not present, the values of ph_cb_beta_offset_div2 and ph_cb_tc_offset_div2 are inferred as follows:
If pps_chroma_tool_offsets_present_flag is equal to 1, the values of ph_cb_beta_offset_div2 and ph_cb_tc_offset_div2 are inferred to be equal to pps_cb_beta_offset_div2 and pps_cb_tc_offset_div2, respectively.
Otherwise (pps_chroma_tool_offsets_present_flag is equal to 0), the values of ph_cb_beta_offset_div2 and ph_cb_tc_offset_div2 are inferred to be equal to ph_luma_beta_offset_div2 and ph_luma_tc_offset_div2, respectively.
   ph_cr_beta_offset_div2 and ph_cr_tc_offset_div2 specify the deblocking parameter offsets for β and tC (divided by 2) that are applied to the Cr component for the slices in the current picture. The values of ph_cr_beta_offset_div2 and ph_cr_tc_offset_div2 shall both be in the range of −12 to 12, inclusive.
   When not present, the values of ph_cr_beta_offset_div2 and ph_cr_tc_offset_div2 are inferred as follows:
If pps_chroma_tool_offsets_present_flag is equal to 1, the values of ph_cr_beta_offset_div2 and ph_cr_tc_offset_div2 are inferred to be equal to pps_cr_beta_offset_div2 and pps_cr_tc_offset_div2, respectively.
Otherwise (pps_chroma_tool_offsets_present_flag is equal to 0), the values of ph_cr_beta_offset_div2 and ph_cr_tc_offset_div2 are inferred to be equal to ph_luma_beta_offset_div2 and ph_luma_tc_offset_div2, respectively.
   ph_extension_length specifies the length of the PH extension data in bytes, not including the bits used for signalling ph_extension_length itself. When not present, the value of ph_extension_length is inferred to be equal to 0. Although ph_extension_length is not present in bitstreams conforming to this version of this Specification, some use of ph_extension_length could be specified in some future version of this Specification, and decoders conforming to this version of this Specification shall allow ph_extension_length to be present and in the range of 0 to 256, inclusive.
   ph_extension_data_byte could have any value. Its presence and value do not affect the decoding process specified in this version of this Specification. Decoders conforming to this version of this Specification shall ignore the value of ph_extension_data_byte.

As provided in Table 2, a NAL unit may include a slice_layer_rbsp( ) syntax structure. Table 8 illustrates the syntax structure of the slice_layer_rbsp( ) and Table 9 illustrates the syntax structure of the slice_header( ) in JVET-T2001.

TABLE 8

Descriptor

```
slice_layer_rbsp( ) {
  slice_header( )
  slice_data( )
  rbsp_slice_trailing_bits( )
}
```

TABLE 9

| | Descriptor |
|---|---|
| slice_header( ) { | |
| sh_picture_header_in_slice_header_flag | u(1) |
| if( sh_picture_header_in_slice_header_flag ) | |
| picture_header_structure( ) | |
| if( sps_subpic_info_present_flag ) | |
| sh_subpic_id | u(v) |
| if( ( pps_rect_slice_flag && NumSlicesInSubpic[ CurrSubpicIdx ] > 1 ) \| \| | |
| ( !pps_rect_slice_flag && NumTilesInPic > 1 ) ) | |
| sh_slice_address | u(v) |
| for( i = 0; i < NumExtraShBits; i++ ) | |
| sh_extra_bit[ i ] | u(1) |
| if( !pps_rect_slice_flag && NumTilesInPic − sh_slice_address > 1 ) | |
| sh_num_tiles_in_slice_minus1 | ue(v) |
| if( ph_inter_slice_allowed_flag ) | |
| sh_slice_type | ue(v) |
| if( nal_unit_type = = IDR_W_RADL \| \| nal_unit_type = = IDR_N_LP | |
| \| \| | |
| nal_unit_type = = CRA_NUT \| \| nal_unit_type = = GDR_NUT ) | |
| sh_no_output_of_prior_pics_flag | u(1) |
| if( sps_alf_enabled_flag && !pps_alf_info_in_ph_flag ) { | |
| sh_alf_enabled_flag | u(1) |
| if( sh_alf_enabled_flag ) { | |
| sh_num_alf_aps_ids_luma | u(3) |
| for( i = 0; i < sh_num_alf_aps_ids_luma; i++ ) | |
| sh_alf_aps_id_luma[ i ] | u(3) |
| if( sps_chroma_format_idc != 0 ) { | |
| sh_alf_cb_enabled_flag | u(1) |
| sh_alf_cr_enabled_flag | u(1) |
| } | |
| if( sh_alf_cb_enabled_flag \| \| sh_alf_cr_enabled_flag ) | |
| sh_alf_aps_id_chroma | u(3) |
| if( sps_ccalf_enabled_flag ) { | |
| sh_alf_cc_cb_enabled_flag | u(1) |
| if( sh_alf_cc_cb_enabled_flag ) | |
| sh_alf_cc_cb_aps_id | u(3) |
| sh_alf_cc_cr_enabled_flag | u(1) |
| if( sh_alf_cc_cr_enabled_flag ) | |
| sh_alf_cc_cr_aps_id | u(3) |
| } | |
| } | |
| } | |
| if( ph_lmcs_enabled_flag && !sh_picture_header_in_slice_header_flag ) | |
| sh_lmcs_used_flag | u(1) |
| if( ph_explicit_scaling_list_enabled_flag | |
| && !sh_picture_header_in_slice_header_flag ) | |
| sh_explicit_scaling_list_used_flag | u(1) |
| if( !pps_rpl_info_in_ph_flag && ( ( nal_unit_type != IDR_W_RADL | |
| && | |
| nal_unit_type != IDR_N_LP ) \| \| sps_idr_rpl_present_flag ) ) | |
| ref_pic_lists( ) | |
| if( ( sh_slice_type != I && num_ref_entries[ 0 ][ RplsIdx[ 0 ] ] > 1 ) \| \| | |
| ( sh_slice_type = = B && num_ref_entries[ 1 ][ RplsIdx[ 1 ] ] > 1 ) ) | |
| { | |
| sh_num_ref_idx_active_override_flag | u(1) |
| if( sh_num_ref_idx_active_override_flag ) | |
| for( i = 0; i < ( sh_slice_type = = B ? 2: 1 ); i++ ) | |
| if( num_ref_entries[ i ][ RplsIdx[ i ] ] > 1 ) | |
| sh_num_ref_idx_active_minus1[ i ] | ue(v) |
| } | |
| if( sh_slice_type != I ) { | |
| if( pps_cabac_init_present_flag ) | |
| sh_cabac_init_flag | u(1) |
| if( ph_temporal_mvp_enabled_flag && !pps_rpl_info_in_ph_flag ) { | |
| if( sh_slice_type = = B ) | |
| sh_collocated_from_l0_flag | u(1) |
| if( ( sh_collocated_from_l0_flag && NumRefIdxActive[ 0 ] > 1 ) \| \| | |
| ( ! sh_collocated_from_l0_flag && NumRefIdxActive[ 1 ] > 1 ) ) | |
| sh_collocated_ref_idx | ue(v) |
| } | |
| if( !pps_wp_info_in_ph_flag && | |
| ( ( pps_weighted_pred_flag && sh_slice_type = = P ) \| \| | |
| ( pps_weighted_bipred_flag && sh_slice_type = = B ) ) ) | |
| pred_weight_table( ) | |
| } | |
| if( !pps_qp_delta_info_in_ph_flag ) | |
| sh_qp_delta | se(v) |
| if( pps_slice_chroma_qp_offsets_present_flag ) { | |
| sh_cb_qp_offset | se(v) |
| sh_cr_qp_offset | se(v) |
| if( sps_joint_cbcr_enabled_flag ) | |
| sh_joint_cbcr_qp_offset | se(v) |
| } | |
| if( pps_cu_chroma_qp_offset_list_enabled_flag ) | |
| sh_cu_chroma_qp_offset_enabled_flag | u(1) |
| if( sps_sao_enabled_flag && !pps_sao_info_in_ph_flag ) { | |
| sh_sao_luma_used_flag | u(1) |
| if( sps_chroma_format_idc != 0 ) | |
| sh_sao_chroma_used_flag | u(1) |
| } | |
| if( pps_deblocking_filter_override_enabled_flag | |
| && !pps_dbf_info_in_ph_flag ) | |
| sh_deblocking_params_present_flag | u(1) |
| if( sh_deblocking_params_present_flag ) { | |
| if( !pps_deblocking_filter_disabled_flag ) | |
| sh_deblocking_filter_disabled_flag | u(1) |
| if( !sh_deblocking_filter_disabled flag ) { | |
| sh_luma_beta_offset_div2 | se(v) |
| sh_luma_tc_offset_div2 | se(v) |
| if( pps_chroma_tool_offsets_present_flag ) { | |
| sh_cb_beta_offset_div2 | se(v) |
| sh_cb_tc_offset_div2 | se(v) |
| sh_cr_beta_offset_div2 | se(v) |
| sh_cr_tc_offset_div2 | se(v) |
| } | |
| } | |
| } | |
| if( sps_dep_quant_enabled_flag ) | |
| sh_dep_quant_used_flag | u(1) |
| if( sps_sign_data_hiding_enabled_flag && !sh_dep_quant_used_flag ) | |
| sh_sign_data_hiding_used_flag | u(1) |
| if( sps_transform_skip_enabled_flag && !sh_dep_quant_used_flag && | |
| !sh_sign_data_hiding_used_flag ) | |
| sh_ts_residual_coding_disabled_flag | u(1) |
| if( pps_slice_header_extension_present_flag ) { | |
| sh_slice_header_extension_length | ue(v) |
| for( i = 0; i < sh_slice_header_extension_length; i++) | |
| sh_slice_header_extension_data_byte[ i ] | u(8) |
| } | |
| if( NumEntryPoints > 0 ) { | |
| sh_entry_offset_len_minus1 | ue(v) |
| for( i = 0; i < NumEntryPoints; i++ ) | |
| sh_entry_point_offset_minus1[ i ] | u(v) |
| } | |
| byte_alignment( ) | |
| } | |

With respect to Table 9, JVET-Q2001 provides the following semantics:

The variable CuQpDeltaVal, specifying the difference between a luma quantization parameter for the coding unit containing cu_qp_delta_abs and its prediction, is set equal to 0. The variables CuQpOffset_{Cb}, CuQpOffset_{Cr}, and CuQpOffset_{CbCr}, specifying values to be used when determining the respective values of the Qp′_{Cb}, Qp′_{Cr}, and Qp′_{CbCr} quantization parameters for the coding unit containing cu_chroma_qp_offset_flag, are all set equal to 0.
sh_picture_header_in_slice_header_flag equal to 1 specifies that the PH syntax structure is present in the slice header. sh_picture_header_in_slice_header_flag equal to 0 specifies that the PH syntax structure is not present in the slice header.
It is a requirement of bitstream conformance that the value of sh_picture_header_in_slice_header_flag shall be the same in all coded slices in a CLVS.
When sh_picture_header_in_slice_header_flag is equal to 1 for a coded slice, it is a requirement of bitstream conformance that no NAL unit with nal_unit_type equal to PH_NUT shall be present in the CLVS.
When sh_picture_header_in_slice_header_flag is equal to 0, all coded slices in the current picture shall have sh_picture_header_in_slice_header_flag equal to 0, and the current PU shall have a PH NAL unit.
When any of the following conditions is true, the value of sh_picture_header_in_slice_header_flag shall be equal to 0:
The value of sps_subpic_info_present_flag is equal to 1.
The value of pps_rect_slice_flag is equal to 0.
The value of pps_rpl_info_in_ph_flag, pps_dbf_info_in_ph_flag, pps_sao_info_in_ph_flag, pps_alf_info_in_ph_flag, pps_wp_info_in_ph_flag, or pps_qp_delta_info_in_ph_flag is equal to 1.
   sh_subpic_id specifies the subpicture ID of the subpicture that contains the slice. If sh_subpic_id is present, the value of the variable CurrSubpicIdx is derived to be such that SubpicIdVal[CurrSubpicIdx] is equal to sh_subpic_id. Otherwise (sh_subpic_id is not present), CurrSubpicIdx is derived to be equal to 0. The length of sh_subpic_id is sps_subpic_id_len_minus1+1 bits.
   sh_slice_address specifies the slice address of the slice. When not present, the value of sh_slice_address is inferred to be equal to 0.
   If pps_rect_slice_flag is equal to 0, the following applies:
The slice address is the raster scan tile index of the first tile in the slice.
The length of sh_slice_address is Ceil(Log2 (NumTilesInPic)) bits.
The value of sh_slice_address shall be in the range of 0 to NumTilesInPic−1, inclusive.
   Otherwise (pps_rect_slice_flag is equal to 1), the following applies:
The slice address is the subpicture-level slice index of the current slice, i.e., SubpicLevelSliceIdx[j], where j is the picture-level slice index of the current slice.
The length of sh_slice_address is Ceil(Log2(NumSlicesInSubpic[CurrSubpicIdx])) bits.
The value of sh_slice_address shall be in the range of 0 to NumSlicesInSubpic[CurrSubpicIdx]−1, inclusive.
   It is a requirement of bitstream conformance that the following constraints apply:
If pps_rect_slice_flag is equal to 0 or sps_subpic_info_present_flag is equal to 0, the value of sh_slice_address shall not be equal to the value of sh_slice_address of any other coded slice NAL unit of the same coded picture.
Otherwise, the pair of sh_subpic_id and sh_slice_address values shall not be equal to the pair of sh_subpic_id and sh_slice_address values of any other coded slice NAL unit of the same coded picture.
The shapes of the slices of a picture shall be such that each CTU, when decoded, shall have its entire left boundary and entire top boundary consisting of a picture boundary or consisting of boundaries of previously decoded CTU(s).
   sh_extra_bit[i] could have any value. Decoders conforming to this version of this Specification shall ignore the presence and value of sh_extra_bit[i]. Its value does not affect the decoding process specified in this version of this Specification.
   sh_num_tiles_in_slice_minus1 plus 1, when present, specifies the number of tiles in the slice. The value of sh_num_tiles_in_slice_minus1 shall be in the range of 0 to NumTilesInPic−1, inclusive. When not present, the value of sh_num_tiles_in_slice_minus1 shall be inferred to be equal to 0.
   The variable NumCtusInCurrSlice, which specifies the number of CTUs in the current slice, and the list CtbAddrInCurrSlice[i], for i ranging from 0 to NumCtusInCurrSlice−1, inclusive, specifying the picture raster scan address of the i-th CTB within the slice, are derived as follows:

```
if( pps_rect_slice_flag ) {
  picLevelSliceIdx = sh_slice_address
  for( j = 0; j < CurrSubpicIdx; j++ )
    picLevelSliceIdx += NumSlicesInSubpic[ j ]
  NumCtusInCurrSlice = NumCtusInSlice[ picLevelSliceIdx ]
  for( i = 0; i < NumCtusInCurrSlice; i++ )
    CtbAddrInCurrSlice[ i ] = CtbAddrInSlice[ picLevelSliceIdx ][ i ]
} else {
  NumCtusInCurrSlice = 0
  for( tileIdx = sh_slice_address; tileIdx <=
sh_slice_address + sh_num_tiles_in_slice_minus1; tileIdx++ ) {
    tileX = tileIdx % NumTileColumns
    tileY = tileIdx / NumTileColumns
    for( ctbY = TileRowBdVal[ tileY ]; ctbY < TileRowBdVal[ tileY +
    1 ]; ctbY++ ) {
      for( ctbX = TileColBdVal[ tileX ]; ctbX < TileColBdVal[ tileX +
      1 ]; ctbX++ ) {
        CtbAddrInCurrSlice[ NumCtusInCurrSlice ] =
ctbY * PicWidthInCtbsY + ctbX
        NumCtusInCurrSlice++
      }
    }
  }
}
```

The variables SubpicLeftBoundaryPos, SubpicTopBoundaryPos, SubpicRightBoundaryPos, and SubpicBotBoundaryPos are derived as follows:

```
if( sps_subpic_treated_as_pic_flag[ CurrSubpicIdx ] ) {
  SubpicLeftBoundaryPos = sps_subpic_ctu_top_left_x[ CurrSubpicIdx ] * CtbSizeY
  SubpicRightBoundaryPos = Min( pps_pic_width_in_luma_samples − 1,
    ( sps_subpic_ctu_top_left_x[ CurrSubpicIdx ] +
    sps_subpic_width_minus1[ CurrSubpicIdx ] + 1 ) * CtbSizeY − 1 )
  SubpicTopBoundaryPos = sps_subpic_ctu_top_left_y[ CurrSubpicIdx ] *CtbSizeY
  SubpicBotBoundaryPos = Min( pps_pic_height_in_luma_samples − 1,
    ( sps_subpic_ctu_top_left_y[ CurrSubpicIdx ] +
    sps_subpic_height_minus1[ CurrSubpicIdx ] + 1 ) * CtbSizeY − 1 )
}
```

sh_slice_type specifies the coding type of the slice according to Table 10.

TABLE 10

| | Name of |
|---|---|
| sh_slice_type | sh_slice_type |
| 0 | B (B slice) |
| 1 | P (P slice) |
| 2 | I (I slice) |

When not present, the value of sh_slice_type is inferred to be equal to 2.
When ph_intra_slice_allowed_flag is equal to 0, the value of sh_slice_type shall be equal to 0 or 1.
When both of the following conditions are true, the value of sh_slice_type shall be equal to 2:
The value of nal_unit_type is in the range of IDR_W_RADL to CRA_NUT, inclusive.
The value of vps_independent_layer_flag[GeneralLayerIdx[nuh_layer_id] ] is equal to 1 or the current picture is the first picture in the current AU.
   When sps_subpic_treated_as_pic_flag[CurrSubpicIdx] is equal to 0, pps_mixed_nalu_types_in_pic_flag is equal to 1 (i.e., there are at least two subpictures in the current picture having different NAL unit types), the value of sh_slice_type shall be equal to 2.
NOTE—This constraint is technically equivalent to the following: “When pps_mixed_nalu_types_in_pic_flag for a picture is equal to 1 (i.e., there are at least two subpictures in a picture having different NAL unit types), the value of sps_subpic_treated_as_pic_flag[ ] shall be equal to 1 for all the subpictures that are in the picture and contain at least one P or B slice.”
   sh_no_output_of_prior_pics_flag affects the output of previously-decoded pictures in the DPB after the decoding of a picture in a CVSS AU that is not the first AU in the bitstream as specified. It is a requirement of bitstream conformance that the value of sh_no_output_of_prior_pics_flag shall be the same for all slices in an AU that have sh_no_output_of_prior_pics_flag present in the SHs.
   When all slices in an AU have sh_no_output_of_prior_pics_flag present in the SHs, the value of sh_no_output_of_prior_pics_flag in the SHs is also referred to as the value sh_no_output_of_prior_pics_flag of the AU.
   The variables MinQtLog2SizeY, MinQtLog2SizeC, MinQtSizeY, MinQtSizeC, MaxBtSizeY, MaxBtSizeC, MinBtSizeY, MaxTtSizeY, MaxTtSizeC, MinTtSizeY, MaxMttDepthY and MaxMttDepthC are derived as follows:
If sh_slice_type equal to 2 (I), the following applies:

$$\begin{matrix}MinQtLog 2 SizeY = MinCbLog 2 SizeY + ph\_log2 \_diff \_min \_qt \_min \_cb \_intra \_slice \_luma \\ MinQtLog 2 SizeC = MinCbLog 2 SizeY + ph\_log2 \_diff \_min \_qt \_min \_cb \_intra \_slice \_chroma \\ MaxBtSizeY = 1 << ( MinQtLog2SizeY + ph\_log2 \_diff \_max \_bt \_min \_qt \_intra \_slice \_luma ) \\ MaxBtSizeC = 1 << ( MinQtLog 2 SizeC + ph\_log2 \_diff \_max \_bt \_min \_qt \_intra \_slice \_chroma ) \\ MaxTtSizeY = 1 << ( MinQtLog2SizeY + ph\_log2 \_diff \_max \_tt \_min \_qt \_intra \_slice \_luma ) \\ MaxTtSizeC = 1 << ( MinQtLog 2 SizeC + ph\_log2 \_diff \_max \_tt \_min \_qt \_intra \_slice \_chroma )\end{matrix}$$

MaxMttDepthY=ph_max_mtt_hierarchy_depth_intra_slice_luma

MaxMttDepthC=ph_max_mtt_hierarchy_depth_intra_slice_chroma

CuQpDeltaSubdiv=ph_cu_qp_delta_subdiv_intra_slice

CuChromaQpOffsetSubdiv=ph_cu_chroma_qp_offset_subdiv_intra_slice
Otherwise (sh_slice_type equal to 0 (B) or 1 (P)), the following applies:

$$\begin{matrix}MinQtLog 2 SizeY = MinCbLog 2 SizeY + ph\_log2 \_diff \_min \_qt \_min \_cb \_inter \_slice \\ MinQtLog 2 SizeC = MinCbLog 2 SizeY + ph\_log2 \_diff \_min \_qt \_min \_cb \_inter \_slice \\ MaxBtSizeY = 1 << ( MinQtLog 2 SizeY + ph\_log2 \_diff \_max \_bt \_min \_qt \_inter \_slice ) \\ MaxBtSizeC = 1 << ( MinQtLog 2 SizeC + ph\_log2 \_diff \_max \_bt \_min \_qt \_inter \_slice ) \\ MaxBtSizeY = 1 << ( MinQtLog 2 SizeY + ph\_log2 \_diff \_max \_tt \_min \_qt \_inter \_slice ) \\ MaxBtSizeC = 1 << ( MinQtLog 2 SizeC + ph\_log2 \_diff \_max \_tt \_min \_qt \_inter \_slice )\end{matrix}$$

MaxMttDepthY=ph_max_mtt_hierarchy_depth_inter_slice

MaxMttDepthC=ph_max_mtt_hierarchy_depth_inter_slice

CuQpDeltaSubdiv=ph_cu_qp_delta_subdiv_inter_slice

CuChromaQpOffsetSubdiv=ph_cu_chroma_qp_offset_subdiv_inter_slice
The following applies:

$$\begin{matrix}MinQtSizeY = 1 << MinQt Log 2 SizeY \\ MinQtSizeC = 1 << MinQt Log 2 SizeC \\ MinBtSizeY = 1 << MinCb Log 2 SizeY \\ MinTtSizeY = 1 << MinCb Log 2 SizeY\end{matrix}$$

sh_alf_enabled_flag equal to 1 specifies that ALF is enabled for the Y, Cb, or Cr colour component of the current slice. sh_alf_enabled_flag equal to 0 specifies that ALF is disabled for all colour components in the current slice. When not present, the value of sh_alf_enabled_flag is inferred to be equal to ph_alf_enabled_flag.
sh_num_alf_aps_ids_luma specifies the number of ALF APSs that the slice refers to. When sh_alf_enabled_flag is equal to 1 and sh_num_alf_aps_ids_luma is not present, the value of sh_num_alf_aps_ids_luma is inferred to be equal to the value of ph_num_alf_aps_ids_luma.
sh_alf_aps_id_luma[i] specifies the aps_adaptation_parameter_set_id of the i-th ALF APS that the luma component of the slice refers to. When sh_alf_enabled_flag is equal to 1 and sh_alf_aps_id_luma[i] is not present, the value of sh_alf_aps_id_luma[i] is inferred to be equal to the value of ph_alf_aps_id_luma[i].
When sh_alf_aps_id_luma[i] is present, the following applies:
The TemporalId of the APS NAL unit having aps_params_type equal to ALF_APS and aps_adaptation_parameter_set_id equal to sh_alf_aps_id_luma[i] shall be less than or equal to the TemporalId of the coded slice NAL unit.
The value of alf_luma_filter_signal_flag of the APS NAL unit having aps_params_type equal to ALF_APS and aps_adaptation_parameter_set_id equal to sh_alf_aps_id_luma[i] shall be equal to 1.
When sps_chroma_format_idc is equal to 0, the value of aps_chroma_present_flag of the APS NAL unit having aps_params_type equal to ALF_APS and aps_adaptation_parameter_set_id equal to sh_alf_aps_id_luma[i] shall be equal to 0.
When sps_ccalf_enabled_flag is equal to 0, the values of alf_cc_cb_filter_signal_flag and alf_cc_cr_filter_signal_flag of the APS NAL unit having aps_params_type equal to ALF_APS and aps_adaptation_parameter_set_id equal to sh_alf_aps_id_luma[i] shall be equal to 0.
   sh_alf_cb_enabled_flag equal to 1 specifies that ALF is enabled for the Cb colour component of the current slice. sh_alf_cb_enabled_flag equal to 0 specifies that ALF is disabled for the Cb colour component of the current slice. When sh_alf_cb_enabled_flag is not present, it is inferred to be equal to ph_alf_cb_enabled_flag.
   sh_alf_cr_enabled_flag equal to 1 specifies that ALF is enabled for the Cr colour component of the current slice. sh_alf_cr_enabled_flag equal to 0 specifies that ALF is disabled for the Cr colour component of the current slice. When sh_alf_cr_enabled_flag is not present, it is inferred to be equal to ph_alf_cr_enabled_flag.
   sh_alf_aps_id_chroma specifies the aps_adaptation_parameter_set_id of the ALF APS that the chroma component of the slice refers to. When sh_alf_enabled_flag is equal to 1 and sh_alf_aps_id_chroma is not present, the value of sh_alf_aps_id_chroma is inferred to be equal to the value of ph_alf_aps_id_chroma.
   When sh_alf_aps_id_chroma is present, the following applies:
The TemporalId of the APS NAL unit having aps_params_type equal to ALF_APS and aps_adaptation_parameter_set_id equal to sh_alf_aps_id_chroma shall be less than or equal to the TemporalId of the coded slice NAL unit.
The value of alf_chroma_filter_signal_flag of the APS NAL unit having aps_params_type equal to ALF_APS and aps_adaptation_parameter_set_id equal to sh_alf_aps_id_chroma shall be equal to 1.
When sps_ccalf_enabled_flag is equal to 0, the values of alf_cc_cb_filter_signal_flag and alf_cc_cr_filter_signal_flag of the APS NAL unit having aps_params_type equal to ALF_APS and aps_adaptation_parameter_set_id equal to sh_alf_aps_id_chroma shall be equal to 0.
   sh_alf_cc_cb_enabled_flag equal to 1 specifies that CCALF is enabled for the Cb colour component. sh_alf_cc_cb_enabled_flag equal to 0 specifies that CCALF is disabled for the Cb colour component. When sh_alf_cc_cb_enabled_flag is not present, it is inferred to be equal to ph_alf_cc_cb_enabled_flag.
   sh_alf_cc_cb_aps_id specifies the aps_adaptation_parameter_set_id that the Cb colour component of the slice refers to.
   The TemporalId of the APS NAL unit having aps_params_type equal to ALF_APS and aps_adaptation_parameter_set_id equal to sh_alf_cc_cb_aps_id shall be less than or equal to the TemporalId of the coded slice NAL unit. When sh_alf_cc_cb_enabled_flag is equal to 1 and sh_alf_cc_cb_aps_id is not present, the value of sh_alf_cc_cb_aps_id is inferred to be equal to the value of ph_alf_cc_cb_aps_id.
   The value of alf_cc_cb_filter_signal_flag of the APS NAL unit having aps_params_type equal to ALF_APS and aps_adaptation_parameter_set_id equal to sh_alf_cc_cb_aps_id shall be equal to 1.
   sh_alf_cc_cr_enabled_flag equal to 1 specifies that CCALF is enabled for the Cr colour component of the current slice. sh_alf_cc_cr_enabled_flag equal to 0 specifies that CCALF is disabled for the Cr colour component. When sh_alf_cc_cr_enabled_flag is not present, it is inferred to be equal to ph_alf_cc_cr_enabled_flag.
   sh_alf_cc_cr_aps_id specifies the aps_adaptation_parameter_set_id that the Cr colour component of the slice refers to. The TemporalId of the APS NAL unit having aps_params_type equal to ALF_APS and aps_adaptation_parameter_set_id equal to sh_alf_cc_cr_aps_id shall be less than or equal to the TemporalId of the coded slice NAL unit. When sh_alf_cc_cr_enabled_flag is equal to 1 and sh_alf_cc_cr_aps_id is not present, the value of sh_alf_cc_cr_aps_id is inferred to be equal to the value of ph_alf_cc_cr_aps_id.
   The value of alf_cc_cr_filter_signal_flag of the APS NAL unit having aps_params_type equal to ALF_APS and aps_adaptation_parameter_set_id equal to sh_alf_cc_cr_aps_id shall be equal to 1. sh_lmcs_used_flag equal to 1 specifies that luma mapping is used for the current slice and chroma scaling could be used for the current slice (depending on the value of ph_chroma_residual_scale_flag). sh_lmcs_used_flag equal to 0 specifies that luma mapping with chroma scaling is not used for the current slice. When sh_lmcs_used_flag is not present, it is inferred to be equal to sh_picture_header_in_slice_header_flag?ph_lmcs_enabled_flag:0.
   sh_explicit_scaling_list_used_flag equal to 1 specifies that the explicit scaling list is used in the scaling process for transform coefficients when decoding the current slice. sh_explicit_scaling_list_used_flag equal to 0 specifies that the explicit scaling list is not used in the scaling process for transform coefficients when decoding the current slice. When not present, the value of sh_explicit_scaling_list_used_flag is inferred to be equal to sh_picture_header_in_slice_header_flag?ph_explicit_scaling_list_enabled_flag:0.
   sh_num_ref_idx_active_override_flag equal to 1 specifies that the syntax element sh_num_ref_idx_active_minus1[0] is present for P and B slices when num_ref_entries[0][RplsIdx[0] ] is greater than 1 and the syntax element sh_num_ref_idx_active_minus1[1] is present for B slices when num_ref_entries[1][RplsIdx[1] ] is greater than 1. sh_num_ref_idx_active_override_flag equal to 0 specifies that the syntax elements sh_num_ref_idx_active_minus1[0] and sh_num_ref_idx_active_minus1[1] are not present. When not present, the value of sh_num_ref_idx_active_override_flag is inferred to be equal to 1. sh_num_ref_idx_active_minus1[i] is used for the derivation of the variable NumRefIdxActive[i] as specified. The value of sh_num_ref_idx_active_minus1[i] shall be in the range of 0 to 14, inclusive.
   For i equal to 0 or 1, when the current slice is a B slice, sh_num_ref_idx_active_override_flag is equal to 1, and sh_num_ref_idx_active_minus1[i] is not present, sh_num_ref_idx_active_minus1[i] is inferred to be equal to 0.
   When the current slice is a P slice, sh_num_ref_idx_active_override_flag is equal to 1, and sh_num_ref_idx_active_minus1[0] is not present, sh_num_ref_idx_active_minus1[0] is inferred to be equal to 0.
   The variable NumRefIdxActive[i] is derived as follows:

```
for( i = 0; i < 2; i++ ) {
  if( sh_slice_type = = B | | ( sh_slice_type = = P && i = = 0 ) ) {
    if( sh_num_ref_idx_active_override_flag )
      NumRefIdxActive[ i ] = sh_num_ref_idx_active_minus1[ i ] +
      1
    else {
      if( num_ref_entries[ i ][ RplsIdx[ i ] ] >=
pps_num_ref_idx_default_active_minus1[ i ] + 1 )
        NumRefIdxActive[ i ] =
        pps_num_ref_idx_default_active_minus1[ i ] + 1
      else
        NumRefIdxActive[ i ] = num_ref_entries[ i ][ RplsIdx[ i ] ]
    }
  } else /* sh_slice_type = = I | | ( sh_slice_type = = P && i = = 1 ) */
    NumRefIdxActive[ i ] = 0
}
```

The value of NumRefIdxActive[i]−1 specifies the maximum reference index for RPL i that may be used to decode the slice. When the value of NumRefIdxActive[i] is equal to 0, no reference index for RPL i is used to decode the slice.
When the current slice is a P slice, the value of NumRefIdxActive[0] shall be greater than 0.
When the current slice is a B slice, both NumRefIdxActive[0] and NumRefIdxActive[1] shall be greater than 0.
sh_cabac_init_flag specifies the method for determining the initialization table used in the initialization process for context variables. When sh_cabac_init_flag is not present, it is inferred to be equal to 0.
sh_collocated_from_l0_flag equal to 1 specifies that the collocated picture used for temporal motion vector prediction is derived from RPL 0. sh_collocated_from_l0_flag equal to 0 specifies that the collocated picture used for temporal motion vector prediction is derived from RPL 1.
When sh_slice_type is equal to B or P, ph_temporal_mvp_enabled_flag is equal to 1, and sh_collocated_from_l0_flag is not present, the following applies:
If sh_slice_type is equal to B, sh_collocated_from_l0_flag is inferred to be equal to ph_collocated_from_l0_flag.
Otherwise (sh_slice_type is equal to P), the value of sh_collocated_from_l0_flag is inferred to be equal to 1.
   sh_collocated_ref_idx specifies the reference index of the collocated picture used for temporal motion vector prediction.
   When sh_slice_type is equal to P or when sh_slice_type is equal to B and sh_collocated_from_l0_flag is equal to 1, sh_collocated_ref_idx refers to an entry in RPL 0, and the value of sh_collocated_ref_idx shall be in the range of 0 to NumRefIdxActive[0]−1, inclusive.
   When sh_slice_type is equal to B and sh_collocated_from_l0_flag is equal to 0, sh_collocated_ref_idx refers to an entry in RPL 1, and the value of sh_collocated_ref_idx shall be in the range of 0 to NumRefIdxActive[1]−1, inclusive.
   When sh_collocated_ref_idx is not present, the following applies:
If pps_rpl_info_in_ph_flag is equal to 1, the value of sh_collocated_ref_idx is inferred to be equal to ph_collocated_ref_idx.
Otherwise (pps_rpl_info_in_ph_flag is equal to 0), the value of sh_collocated_ref_idx is inferred to be equal to 0.
   Let colPicList be set equal to sh_collocated_from_l0_flag?0:1. It is a requirement of bitstream conformance that the picture referred to by sh_collocated_ref_idx shall be the same for all non-I slices of a coded picture, the value of RprConstraintsActiveFlag[colPicList][sh_collocated_ref_idx] shall be equal to 0, and the value of sps_log2_ctu_size_minus5 for the picture referred to by sh_collocated_ref_idx shall be equal to the value of sps_log2_ctu_size_minus5 for the current picture.
NOTE—The collocated picture has the same spatial resolution, the same scaling window offsets, the same number of subpictures, and the same CTU size as the current picture.
   sh_qp_delta specifies the initial value of Qp_{Y} to be used for the coding blocks in the slice until modified by the value of CuQpDeltaVal in the coding unit layer.
   When pps_qp_delta_info_in_ph_flag is equal to 0, the initial value of the Qp_{Y} quantization parameter for the slice, SliceQp_{Y}, is derived as follows:

$${SliceQp}_{Y} = 26 + pps\_init \_qp \_minus26 + sh\_qp \_delta$$

The value of SliceQp_{Y} shall be in the range of −QpBdOffset to +63, inclusive.
When either of the following conditions is true, the value of NumRefIdxActive[0] shall be less than or equal to the value of NumWeightsL0:
The value of pps_wp_info_in_ph_flag is equal to 1, pps_weighted_pred_flag is equal to 1, and sh_slice_type is equal to P.
The value of pps_wp_info_in_ph_flag is equal to 1, pps_weighted_bipred_flag is equal to 1, and sh_slice_type is equal to B.
   When pps_wp_info_in_ph_flag is equal to 1, pps_weighted_bipred_flag is equal to 1, and sh_slice_type is equal to B, the value of NumRefIdxActive[1] shall be less than or equal to the value of NumWeightsL1.
   When either of the following conditions is true, for each value of i in the range of 0 to NumRefIdxActive[0]−1, inclusive, the values of luma_weight_l0_flag[i] and chroma_weight_l0_flag[i] are both inferred to be equal to 0:
The value of pps_wp_info_in_ph_flag is equal to 1, pps_weighted_pred_flag is equal to 0, and sh_slice_type is equal to P.
The value of pps_wp_info_in_ph_flag is equal to 1, pps_weighted_bipred_flag is equal to 0, and sh_slice_type is equal to B.
   sh_cb_qp_offset specifies a difference to be added to the value of pps_cb_qp_offset when determining the value of the Qp′_{Cb} quantization parameter. The value of sh_cb_qp_offset shall be in the range of −12 to +12, inclusive. When sh_cb_qp_offset is not present, it is inferred to be equal to 0. The value of pps_cb_qp_offset+sh_cb_qp_offset shall be in the range of −12 to +12, inclusive.
   sh_cr_qp_offset specifies a difference to be added to the value of pps_cr_qp_offset when determining the value of the Qp′_{Cr} quantization parameter. The value of sh_cr_qp_offset shall be in the range of −12 to +12, inclusive. When sh_cr_qp_offset is not present, it is inferred to be equal to 0. The value of pps_cr_qp_offset+sh_cr_qp_offset shall be in the range of −12 to +12, inclusive.
   shjoint_cbcr_qp_offset specifies a difference to be added to the value of pps_joint_cbcr_qp_offset_value when determining the value of the Qp′_{CbCr}. The value of sh_joint_cbcr_qp_offset shall be in the range of −12 to +12, inclusive. When sh_joint_cbcr_qp_offset is not present, it is inferred to be equal to 0. The value of pps_joint_cbcr_qp_offset_value+sh_joint_cbcr_qp_offset shall be in the range of −12 to +12, inclusive.
   sh_cu_chroma_qp_offset_enabled_flag equal to 1 specifies that the cu_chroma_qp_offset_flag could be present in the transform unit and palette coding syntax of the current slice. sh_cu_chroma_qp_offset_enabled_flag equal to 0 specifies that the cu_chroma_qp_offset_flag is not present in the transform unit or palette coding syntax of the current slice. When not present, the value of sh_cu_chroma_qp_offset_enabled_flag is inferred to be equal to 0.
   sh_sao_luma_used_flag equal to 1 specifies that SAO is used for the luma component in the current slice. sh_sao_luma_used_flag equal to 0 specifies that SAO is not used for the luma component in the current slice. When sh_sao_luma_used_flag is not present, it is inferred to be equal to ph_sao_luma_enabled_flag.
   sh_sao_chroma_used_flag equal to 1 specifies that SAO is used for the chroma component in the current slice. sh_sao_chroma_used_flag equal to 0 specifies that SAO is not used for the chroma component in the current slice. When sh_sao_chroma_used_flag is not present, it is inferred to be equal to ph_sao_chroma_enabled_flag.
   sh_deblocking_params_present_flag equal to 1 specifies that the deblocking parameters could be present in the slice header. sh_deblocking_params_present_flag equal to 0 specifies that the deblocking parameters are not present in the slice header. When not present, the value of sh_deblocking_params_present_flag is inferred to be equal to 0.
   sh_deblocking_filter_disabled_flag equal to 1 specifies that the deblocking filter is disabled for the current slice. sh_deblocking_filter_disabled_flag equal to 0 specifies that the deblocking filter is enabled for the current slice.
   When sh_deblocking_filter_disabled_flag is not present, it is inferred as follows:
If pps_deblocking_filter_disabled_flag and sh_deblocking_params_present_flag are both equal to 1, the value of sh_deblocking_filter_disabled_flag is inferred to be equal to 0.
Otherwise (pps_deblocking_filter_disabled_flag or sh_deblocking_params_present_flag is equal to 0), the value of sh_deblocking_filter_disabled_flag is inferred to be equal to ph_deblocking_filter_disabled_flag.
   sh_luma_beta_offset_div2 and sh_luma_tc_offset_div2 specify the deblocking parameter offsets for β and tC (divided by 2) that are applied to the luma component for the current slice. The values of sh_luma_beta_offset_div2 and sh_luma_tc_offset_div2 shall both be in the range of −12 to 12, inclusive. When not present, the values of sh_luma_beta_offset_div2 and sh_luma_tc_offset_div2 are inferred to be equal to ph_luma_beta_offset_div2 and ph_luma_tc_offset_div2, respectively.
   sh_cb_beta_offset_div2 and sh_cb_tc_offset_div2 specify the deblocking parameter offsets for β and tC (divided by 2) that are applied to the Cb component for the current slice. The values of sh_cb_beta_offset_div2 and sh_cb_tc_offset_div2 shall both be in the range of −12 to 12, inclusive.
   When not present, the values of sh_cb_beta_offset_div2 and sh_cb_tc_offset_div2 are inferred as follows:
If pps_chroma_tool_offsets_present_flag is equal to 1, the values of sh_cb_beta_offset_div2 and sh_cb_tc_offset_div2 are inferred to be equal to ph_cb_beta_offset_div2 and ph_cb_tc_offset_div2, respectively.
Otherwise (pps_chroma_tool_offsets_present_flag is equal to 0), the values of sh_cb_beta_offset_div2 and sh_cb_tc_offset_div2 are inferred to be equal to sh_luma_beta_offset_div2 and sh_luma_tc_offset_div2, respectively.
   sh_cr_beta_offset_div2 and sh_cr_tc_offset_div2 specify the deblocking parameter offsets for β and tC (divided by 2) that are applied to the Cr component for the current slice. The values of sh_cr_beta_offset_div2 and sh_cr_tc_offset_div2 shall both be in the range of −12 to 12, inclusive.
   When not present, the values of sh_cr_beta_offset_div2 and sh_cr_tc_offset_div2 are inferred as follows:
If pps_chroma_tool_offsets_present_flag is equal to 1, the values of sh_cr_beta_offset_div2 and sh_cr_tc_offset_div2 are inferred to be equal to ph_cr_beta_offset_div2 and ph_cr_tc_offset_div2, respectively.
Otherwise (pps_chroma_tool_offsets_present_flag is equal to 0), the values of sh_cr_beta_offset_div2 and sh_cr_tc_offset_div2 are inferred to be equal to sh_luma_beta_offset_div2 and sh_luma_tc_offset_div2, respectively.
   sh_dep_quant_used_flag equal to 0 specifies that dependent quantization is not used for the current slice. sh_dep_quant_used_flag equal to 1 specifies that dependent quantization is used for the current slice. When sh_dep_quant_used_flag is not present, it is inferred to be equal to 0.
   sh_sign_data_hiding_used_flag equal to 0 specifies that sign bit hiding is not used for the current slice. sh_sign_data_hiding_used_flag equal to 1 specifies that sign bit hiding is used for the current slice. When sh_sign_data_hiding_used_flag is not present, it is inferred to be equal to 0.
   sh_ts_residual_coding_disabled_flag equal to 1 specifies that the residual_coding( ) syntax structure is used to parse the residual samples of a transform skip block for the current slice.
   sh_ts_residual_coding_disabled_flag equal to 0 specifies that the residual_ts_coding( ) syntax structure is used to parse the residual samples of a transform skip block for the current slice. When sh_ts_residual_coding_disabled_flag is not present, it is inferred to be equal to 0.
   sh_slice_header_extension_length specifies the length of the slice header extension data in bytes, not including the bits used for signalling sh_slice_header_extension_length itself. When not present, the value of sh_slice_header_extension_length is inferred to be equal to 0. Although sh_slice_header_extension_length is not present in bitstreams conforming to this version of this Specification, some use of sh_slice_header_extension_length could be specified in some future version of this Specification, and decoders conforming to this version of this Specification shall allow sh_slice_header_extension_length to be present and in the range of 0 to 256, inclusive.
   sh_slice_header_extension_data_byte[i] could have any value. Its presence and value do not affect the decoding process specified in this version of this Specification. Decoders conforming to this version of this Specification shall ignore the values of all the sh_slice_header_extension_data_byte[i] syntax elements. Its value does not affect the decoding process specified in this version of specification.
   The variable NumEntryPoints, which specifies the number of entry points in the current slice, is derived as follows:

```
NumEntryPoints = 0
if( sps_entry_point_offsets_present_flag )
  for( i = 1; i < NumCtusInCurrSlice; i++ ) {
    ctbAddrX = CtbAddrInCurrSlice[ i ] % PicWidthInCtbsY
    ctbAddrY = CtbAddrInCurrSlice[ i ] / PicWidthInCtbsY
      prevCtbAddrX = CtbAddrInCurrSlice[ i − 1 ] %
      PicWidthInCtbsY
    prevCtbAddrY = CtbAddrInCurrSlice[ i − 1 ] / PicWidthInCtbsY
    if( CtbToTileRowBd[ ctbAddrY ] != CtbToTileRowBd[
    prevCtbAddrY ] | |
      CtbToTileColBd[ ctbAddrX ] != CtbToTileColBd[ prevCtbAddrX
      ] | |
        ( ctbAddrY != prevCtbAddrY &&
sps_entropy_coding_sync_enabled_flag ) )
      NumEntryPoints++
  }
```

sh_entry_offset_len_minus1 plus 1 specifies the length, in bits, of the sh_entry_point_offset_minus1[i] syntax elements. The value of sh_entry_offset_len_minus1 shall be in the range of 0 to 31, inclusive.
sh_entry_point_offset_minus1[i] plus 1 specifies the i-th entry point offset in bytes, and is represented by sh_entry_offset_len_minus1 plus 1 bits. The slice data that follow the slice header consists of NumEntryPoints+1 subsets, with subset index values ranging from 0 to NumEntryPoints, inclusive. The first byte of the slice data is considered byte 0. When present, emulation prevention bytes that appear in the slice data portion of the coded slice NAL unit are counted as part of the slice data for purposes of subset identification. Subset 0 consists of bytes 0 to sh_entry_point_offset_minus1[0], inclusive, of the coded slice data, subset k, with k in the range of 1 to NumEntryPoints−1, inclusive, consists of bytes firstByte[k] to lastByte[k], inclusive, of the coded slice data with firstByte[k] and lastByte[k] derived as follows:

$$\begin{matrix}firstByte [ k ] = {\sum }_{n = 1}^{k} ( s h [ n - 1 ] + 1 ) \\ lastByte [ k ] = firstByte [ k ] + sh\_entry \_point \_offset \_minus1 [ k ]\end{matrix}$$

The last subset (with subset index equal to NumEntryPoints) consists of the remaining bytes of the coded slice data.
When sps_entropy_coding_sync_enabled_flag is equal to 0 and the slice contains one or more complete tiles, each subset shall consist of all coded bits of all CTUs in the slice that are within the same tile, and the number of subsets (i.e., the value of NumEntryPoints+1) shall be equal to the number of tiles in the slice.
When sps_entropy_coding_sync_enabled_flag is equal to 0 and the slice contains a subset of CTU rows from a single tile, the NumEntryPoints shall be 0, and the number of subsets shall be 1. The subset shall consist of all coded bits of all CTUs in the slice.
When sps_entropy_coding_sync_enabled_flag is equal to 1, each subset k with k in the range of 0 to NumEntryPoints, inclusive, shall consist of all coded bits of all CTUs in a CTU row within a tile, and the number of subsets (i.e., the value of NumEntryPoints+1) shall be equal to the total number of tile-specific CTU rows in the slice.

As described above, the techniques described herein provide general high-level syntax compatible with JVET-T2001 for signaling NN ILF filter parameters and signaling NN ILF filter parameters in an SPS or PPS may suffer from one or more drawbacks. In one example, according to the techniques herein, NN ILF filter parameters may be signaled in an APS. In one example, a new APS type may be defined for NN ILF filter parameters.

As described above, JVET-U0099 applies an up-sampling filter in the context of VVC Reference Picture Resampling (RPR). As provided above, in the semantics of sps_ref_pic_resampling_enabled_flag, in JVET-T2001, RPR describes where a reference picture has one or more of the following seven parameters different than that of the current picture: 1) pps_pic_width_in_luma_samples, 2) pps_pic_height_in_luma_samples, 3) pps_scaling_win_left_offset, 4) pps_scaling_win_right_offset, 5) pps_scaling_win_top_offset, 6) pps_scaling_win_bottom_offset, and 7) sps_num_subpics_minus1. Thus, for example, scaling window offsets may be used to calculate a scaling ratio for scaling a recovered decoded picture for storage as a reference picture. That is, for example, a recovered decoded picture (and thus the encoded picture) may have 960×540 luma samples and the reference picture may be upscaled by a scaling factor (or ratio) of 2 to 1920×1080. It should be noted that in JVET-T2001, full-pel and fractional-pel locations within a reference picture are determined and then the existing motion compensation interpolators are used. The full-pel location is used to fetch the reference block patch from the reference picture and the fractional-pel location is used to select the proper interpolation filter. This process would typically introduce artifacts and as such, may not be adequate to achieve coding improvements provided by super-resolution techniques. Thus, in order to achieve coding improvements provided by super-resolution techniques, for example, those described above, it may be necessary to signal NN SR filter parameters for use in an NN SR up-sampling process. It should be noted that in general, super resolution filtering can be done either inside the coding loop or outside the coding loop purely as a post processing filter. The techniques described herein provide general high-level syntax compatible with JVET-T2001 for signaling NN SR filter parameters and as described above, signaling NN SR filter parameters in an SPS or PPS may suffer from one or more drawbacks. In one example, according to the techniques herein NN SR filter parameters may be signaled in an APS. In one example, a new APS type may be defined for NN SR filter parameters.

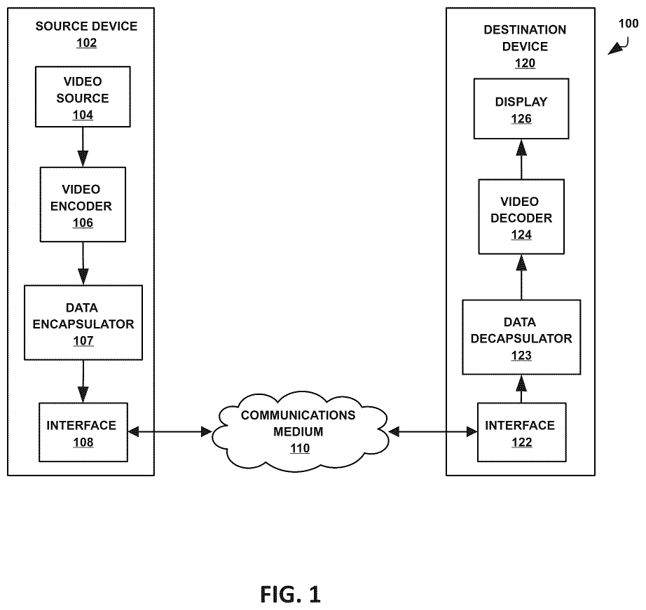

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

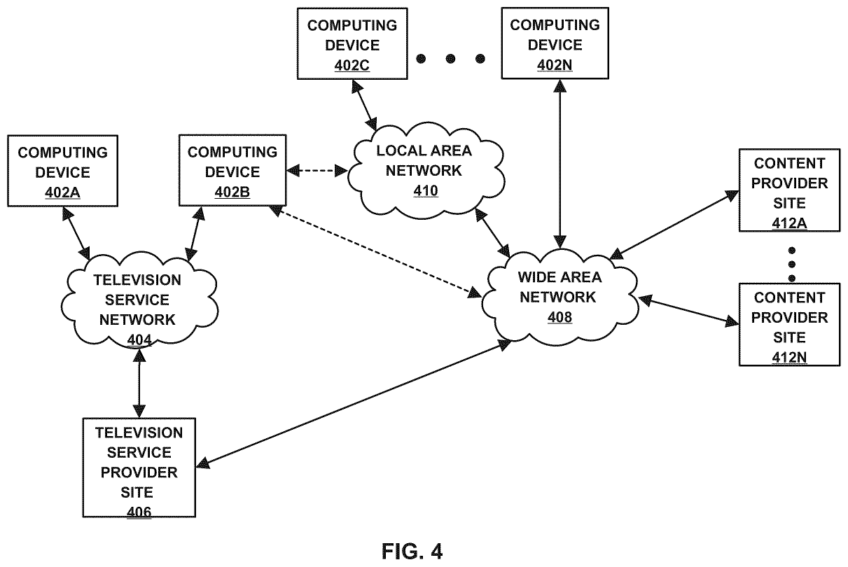

FIG. 4 is a conceptual drawing illustrating an example of components that may be included in an implementation of system 100. In the example implementation illustrated in FIG. 4, system 100 includes one or more computing devices 402A-402N, television service network 404, television service provider site 406, wide area network 408, local area network 410, and one or more content provider sites 412A-412N. The implementation illustrated in FIG. 4 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 4, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 4, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink. Further, as illustrated in FIG. 4, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 408 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 4, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard.

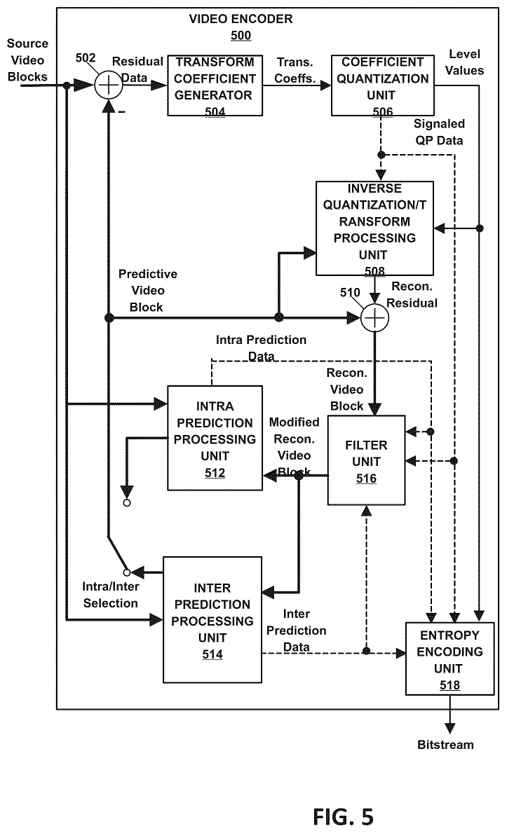

When generating a compliant bitstream video encoder 106 may compress video data. Compression may be lossy (discernible or indiscernible to a viewer) or lossless. FIG. 5 is a block diagram illustrating an example of video encoder 500 that may implement the techniques for encoding video data described herein. It should be noted that although example video encoder 500 is illustrated as having distinct functional blocks, such an illustration is for descriptive purposes and does not limit video encoder 500 and/or sub-components thereof to a particular hardware or software architecture. Functions of video encoder 500 may be realized using any combination of hardware, firmware, and/or software implementations.

Video encoder 500 may perform intra prediction coding and inter prediction coding of picture areas, and, as such, may be referred to as a hybrid video encoder. In the example illustrated in FIG. 5, video encoder 500 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder 500 may be configured to perform additional sub-divisions of source video blocks. It should be noted that the techniques described herein are generally applicable to video coding, regardless of how source video data is partitioned prior to and/or during encoding. In the example illustrated in FIG. 5, video encoder 500 includes summer 502, transform coefficient generator 504, coefficient quantization unit 506, inverse quantization and transform coefficient processing unit 508, summer 510, intra prediction processing unit 512, inter prediction processing unit 514, filter unit 516, and entropy encoding unit 518. As illustrated in FIG. 5, video encoder 500 receives source video blocks and outputs a bitstream.

In the example illustrated in FIG. 5, video encoder 500 may generate residual data by subtracting a predictive video block from a source video block. The selection of a predictive video block is described in detail below. Summer 502 represents a component configured to perform this subtraction operation. In one example, the subtraction of video blocks occurs in the pixel domain. Transform coefficient generator 504 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 504 may be configured to perform any and all combinations of the transforms included in the family of discrete trigonometric transforms, including approximations thereof. Transform coefficient generator 504 may output transform coefficients to coefficient quantization unit 506. Coefficient quantization unit 506 may be configured to perform quantization of the transform coefficients. The quantization process may reduce the bit depth associated with some or all of the coefficients. The degree of quantization may alter the rate-distortion (i.e., bit-rate vs. quality of video) of encoded video data. The degree of quantization may be modified by adjusting a quantization parameter (QP). A quantization parameter may be determined based on slice level values and/or CU level values (e.g., CU delta QP values). QP data may include any data used to determine a QP for quantizing a particular set of transform coefficients. As illustrated in FIG. 5, quantized transform coefficients (which may be referred to as level values) are output to inverse quantization and transform coefficient processing unit 508. Inverse quantization and transform coefficient processing unit 508 may be configured to apply an inverse quantization and an inverse transformation to generate reconstructed residual data. As illustrated in FIG. 5, at summer 510, reconstructed residual data may be added to a predictive video block. In this manner, an encoded video block may be reconstructed and the resulting reconstructed video block may be used to evaluate the encoding quality for a given prediction, transformation, and/or quantization. Video encoder 500 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

Referring again to FIG. 5, intra prediction processing unit 512 may be configured to select an intra prediction mode for a video block to be coded. Intra prediction processing unit 512 may be configured to evaluate a frame and determine an intra prediction mode to use to encode a current block. As described above, possible intra prediction modes may include planar prediction modes, DC prediction modes, and angular prediction modes. Further, it should be noted that in some examples, a prediction mode for a chroma component may be inferred from a prediction mode for a luma prediction mode. Intra prediction processing unit 512 may select an intra prediction mode after performing one or more coding passes. Further, in one example, intra prediction processing unit 512 may select a prediction mode based on a rate-distortion analysis. As illustrated in FIG. 5, intra prediction processing unit 512 outputs intra prediction data (e.g., syntax elements) to entropy encoding unit 518 and transform coefficient generator 504. As described above, a transform performed on residual data may be mode dependent (e.g., a secondary transform matrix may be determined based on a prediction mode).

Referring again to FIG. 5, inter prediction processing unit 514 may be configured to perform inter prediction coding for a current video block. Inter prediction processing unit 514 may be configured to receive source video blocks and calculate a motion vector for PUs of a video block. A motion vector may indicate the displacement of a prediction unit of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 514 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 514 may be configured to perform motion vector prediction, as described above. Inter prediction processing unit 514 may be configured to generate a predictive block using the motion prediction data. For example, inter prediction processing unit 514 may locate a predictive video block within a frame buffer (not shown in FIG. 5). It should be noted that inter prediction processing unit 514 may further be configured to apply one or more interpolation filters to a reconstructed residual block to calculate sub-integer pixel values for use in motion estimation. Inter prediction processing unit 514 may output motion prediction data for a calculated motion vector to entropy encoding unit 518.

Referring again to FIG. 5, filter unit 516 receives reconstructed video blocks and coding parameters and outputs modified reconstructed video data. Filter unit 516 may be configured to perform deblocking and/or Sample Adaptive Offset (SAO) filtering. SAO filtering is a non-linear amplitude mapping that may be used to improve reconstruction by adding an offset to reconstructed video data. It should be noted that as illustrated in FIG. 5, intra prediction processing unit 512 and inter prediction processing unit 514 may receive modified reconstructed video block via filter unit 216. Entropy encoding unit 518 receives quantized transform coefficients and predictive syntax data (i.e., intra prediction data and motion prediction data). It should be noted that in some examples, coefficient quantization unit 506 may perform a scan of a matrix including quantized transform coefficients before the coefficients are output to entropy encoding unit 518. In other examples, entropy encoding unit 518 may perform a scan. Entropy encoding unit 518 may be configured to perform entropy encoding according to one or more of the techniques described herein. In this manner, video encoder 500 represents an example of a device configured to generate encoded video data according to one or more techniques of this disclosure.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. Further, as described above, sub-bitstream extraction may refer to a process where a device receiving a compliant bitstream forms a new compliant bitstream by discarding and/or modifying data in the received bitstream. It should be noted that the term conforming bitstream may be used in place of the term compliant bitstream. In one example, data encapsulator 107 may be configured to generate syntax according to one or more techniques described herein. It should be noted that data encapsulator 107 need not necessary be located in the same physical device as video encoder 106. For example, functions described as being performed by video encoder 106 and data encapsulator 107 may be distributed among devices illustrated in FIG. 4.

As described above, in one example, according to the techniques herein, NN ILF filter parameters may be signaled in an APS, where in one example, a new APS type may be defined for NN ILF filter parameters. Table 11 illustrates example syntax of an adaptation parameter set according to the techniques herein.

TABLE 11

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| else if( aps_params_type = = NN_ILF_APS ) | |
| neural_network_ilf_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

With respect to Table 11, in one example, the semantics may be based on the semantics provided above with respect to Table 5, with, in one example, the following semantics for syntax element aps_params_type:

aps_params_type specifies the type of APS parameters carried in the APS as specified in Table 12. The value of aps_params_type shall be in the range of 0 to 3, inclusive, in bitstreams conforming to this version of this Specification. Other values of aps_params_type are reserved for future use by ITU-T|ISO/IEC. Decoders conforming to this version of this Specification shall ignore APS NAL units with reserved values of aps_params_type.

TABLE 12

| | Name of | |
|---|---|---|
| aps_params_type | aps_params_type | Type of APS parameters |
| 0 | ALF_APS | ALF parameters |
| 1 | LMCS_APS | LMCS parameters |
| 2 | SCALING_APS | Scaling list parameters |
| 3 | NN_ILF_APS | Neural network ILF |
| | | parameters |

All APS NAL units with a particular value of aps_params_type, regardless of the nuh_layer_id values and whether they are prefix or suffix APS NAL units, share the same value space for aps_adaptation_parameter_set_id. APS NAL units with different values of aps_params_type use separate values spaces for aps_adaptation_parameter_set_id.

As described above, in order to achieve coding improvements provided by super-resolution techniques, it may be necessary to signal NN SR filter parameters for use in an NN SR up-sampling process. NN SR filter parameters may include one or more of the following: neural network structure, a neural network's number of layers, activation functions, neural network coefficients/weights, etc. In one example, according to the techniques herein, NN SR filter parameters may be signaled in an APS, where in one example, a new APS type may be defined for NN SR filter parameters. Table 13 illustrates example syntax of an adaptation parameter set according to the techniques herein.

TABLE 13

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| else if( aps_params_type = = NN_SR_APS ) | |
| neural_network_super_resolution_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

With respect to Table 13, in one example, the semantics may be based on the semantics provided above with respect to Table 5, with, in one example, the following semantics for syntax element aps_params_type:

aps_params_type specifies the type of APS parameters carried in the APS as specified in Table 14. The value of aps_params_type shall be in the range of 0 to 3, inclusive, in bitstreams conforming to this version of this Specification. Other values of aps_params_type are reserved for future use by ITU-T|ISO/IEC. Decoders conforming to this version of this Specification shall ignore APS NAL units with reserved values of aps_params_type.

TABLE 14

| | Name of | |
|---|---|---|
| aps_params_type | aps_params_type | Type of APS parameters |
| 0 | ALF_APS | ALF parameters |
| 1 | LMCS_APS | LMCS parameters |
| 2 | SCALING_APS | Scaling list parameters |
| 3 | NN_SR_APS | Neural network super |
| | | resolution parameters |

All APS NAL units with a particular value of aps_params_type, regardless of the nuh_layer_id values and whether they are prefix or suffix APS NAL units, share the same value space for aps_adaptation_parameter_set_id. APS NAL units with different values of aps_params_type use separate values spaces for aps_adaptation_parameter_set_id.

As described above, in general, in order to implement an NN ILF, at a video decoder, one or more of the following may be required to be signaled: whether an NN ILF filter is on or off (at various level of video); whether scaling of NN filter residues is applied, and/or a filter model selection which may be dependent on a picture type (or slice type) and a QP type. Further, one or more of the following may also be required to be signaled: neural network structure, a neural network's number of layers, activation functions, neural network coefficients, etc. According to the techniques herein, the NN ILF filter parameters may be signaled in an neural_network_ilf_data( ) syntax structure. In one example, the syntax for the neural network data may be based on the syntax defined for a NNR bitstream as described in Table 15A illustrates an example of a neural_network_ilf_data( ) according to the techniques herein:

TABLE 15A

Descriptor

```
neural_network_ilf_data( ) {
  nnr_unit_size( )
  nnr_unit_header( )
  nnr_unit_payload( )
}
```

As described above, in general, in order to implement an NN SR filter, at a video decoder, one or more of the following may be required to be signaled: neural network structure, a neural network's number of layers, activation functions, neural network coefficients, etc. According to the techniques herein, the NN filter parameters may be signaled in an neural_network_super_resolution_data( ) syntax structure. Table 15B illustrates an example of a neural_network_super_resolution_data( ) according to the techniques herein:

TABLE 15B

Descriptor

```
neural_network_super_resolution_data( ) {
  nnr_unit_size( )
  nnr_unit_header( )
  nnr_unit_payload( )
}
```

With respect to Table 15A and Table 15B, in one example, the semantics may be based on following:

nnr_unit_size( ), nnr_unit_header, and nnr_unit_payload( ) are defined in ISO 15938-17: Compression of neural networks for multimedia content description and analysis.

It should be noted that although ISO 15938-17 syntax is used above for neural network data, in other cases, some other syntax may be used to describe neural network data. It should be noted that ISO 15938-17 provides where an NNR is a compressed neural network representation and where an NNR bitstream is composed of a sequence of NNR Units and provides the following definitions:

compressed neural network representation: Representation of a neural network with model parameters encoded using compression tools.
NNR unit: Data structure for carrying (compressed or uncompressed) neural network data and related metadata.

Thus, according to the techniques herein, NN ILF filter parameters may be signaled in an neural_network_ilf_data( ) syntax structure within an adaptation parameter set, wherein the NN ILF filter parameters are provided as sequence of neural network representation units. Thus, according to the techniques herein, NN SR filter parameters may be signaled in an neural_network_super_resolution_data( ) syntax structure within an adaptation parameter set, wherein the NN SR filter parameters are provided as sequence of neural network representation units.

Table 16 illustrates another example of neural_network_ilf_data( ) according to the techniques herein:

TABLE 16

| | Descriptor |
|---|---|
| neural_network_ilf_data( ) { | |
| num_nn_layers | ue(v) |
| for(i=0; i<num_nn_layers;i++){ | |
| num_nodes_in_layer[i] | ue(v) |
| num_dims_in_layer[i] | ue(v) |
| for( j=0; j<num_dims_in_layer[i]; j++){ | |
| dim_in_layer[j][i] | ue(v) |
| } | |
| num_biases_for_nodes_layer[i] | ue(v) |
| activation_function[i] | u(3) |
| } | |
| for(k=0; k<num_nn_layers−1;k++){ | |
| for(i=0; i< num_nodes_in_layer[k];i++){ | |
| for(j=0; j< num_nodes_in_layer[k+1];j++){ | |
| neural_weight[k][i][j] | ue(v) |
| } | |
| } | |
| } | |
| } | |

With respect to Table 16, in one example, the semantics may be based on following:

num_nn_layers specifies the number of layers, including input layer, output layer and hidden layers in the ILF neural network.
num_nodes_in_layer[i] specifies the number of nodes (or neurons) in the i-th layer. In one example, num_nodes_in_layer[i] shall be greater than 0.
num_dims_in_layer[i] specifies the number of dimensions in the i-th layer. In one example, num_dims_in_layer[i] shall be greater than 0.
dim_in_layer[j][i] specifies the j-th dimension of the i-th layer. In one example, the value of dim_in_layer[num_dims_in_layer[i]-1][i] is not signaled and instead inferred to be equal to the num_nodes_in_layer[i] divided by the product of the received values of dim_in_layer[j][i] for the i-th layer.
num_biases_for_nodes_in_layer[i] specifies the bias used by nodes in the i-th layer.
activation_function[i] specifies the type of activation function used by the i-th layer. In one example, the value activation_function[i] defines the type of activation function used as shown in Table 15.
neural_weight[k][i][j] specifies the weight connecting i-th neuron of k-th layer with j-th neuron of (k+1) th layer.

TABLE 17

| activation_function[i] | Type of activation function |
|---|---|
| 0 | Rectified Linear Unit (ReLU) |
| 1 | Sigmoid function |
| 3 | Leaky ReLU function |
| 4-7 | Reserved |

As described above, in JVET-T2001, an APS applies to zero or more slices. Further, in JVET-T2001, in some cases, a SPS and/or PPS level flag indicates whether a tool (e.g., SAO) having parameters in an APS is enabled and a corresponding APS ID is signaled in the PH and in some cases in the slice header. In one example, according to the techniques herein, NN ILF filter parameters presence/enabled control flags may be signaled in an SPS and/or PPS. For example, one or more control flags may be signaled in SPS and/or in PPS to indicate if NN ILF APS and/or NN ILF filter parameters are present in the bitstream. In one example, a flag may be signaled in an SPS specifying if NN ILF APS and/or NN ILF filter parameters are present/enabled in the bitstream. In one example, a flag may be signaled in a PPS specifying if NN ILF APS and/or NN ILF filter parameters are present/enabled in the picture header and/or slice header referring to this PPS. In one example, a flag may be signaled in an SPS indicating of signaling of NN ILF APS parameter set ID is in a picture header and/or slice header. When one or more slices of a coded picture use the NN ILF filter parameters, one or more NN ILF APS IDs may be signaled in picture header and/or slice header. In one example, one or more NN APS ID may be signaled only in a picture header or in a slice header (but not both). In one example, whether the picture header or the slice header includes NN ILF APS ID(s) may be specified by signaling a flag in a PPS. In one example, one or more NN ILF APS ID(s) may be signaled in picture header to enable a NN ILF tool for the picture and then if enabled, each slice header in the picture may signal a flag to turn the use of NN tool on or off.

In an example, some of the slice header data signaled for NN ILF filter information may be signaled in the ph_extra_bit[i] and/or in ph_extension_data_byte[i]. In an example, some of the slice header data signaled for NN ILF filter information may be signaled in the sh_extra_bit[i] and/or in sh_slice_header_extension_data_byte[i].

In an example, when NN ILF filter is used, deblocking filter may be disabled. In one example, an inference may be used to set one or more deblocking filter related syntax elements to “disabled” or “off” state when NN ILF filter is enabled. In another example, it may be a requirement of bitstream conformance that when NN ILF filter is enabled, the deblocking filter is disabled. In another example, it may be a requirement of bitstream conformance that when deblocking filter is enabled, the NN ILF is disabled. In one example, on a picture-by-picture basis or slice-by-slice basis or CTU-by-CTU basis, one of an NN ILF filter or a deblocking filter may be enabled.

As described above, in one example, a flag may be signaled in a SPS specifying if an NN ILF is enabled. That is, in one example, according to the techniques herein, the relevant portion of an SPS syntax structure may be as provided in Table 18.

TABLE 18

| | |
|---|---|
| seq_parameter_set_rbsp( ) { | |
| ... | |
| sps_nn_ilf_enabled_flag | u(1) |
| ... | |
| } | |

With respect to Table 18, in one example, the semantics may be based on following:

sps_nn_ilf_enabled_flag equal to 1 specifies that the ILF neural network tools are enabled for the CLVS. sps_nn_ilf_enabled_flag equal to 0 specifies that the neural network tools are disabled for the CLVS.
In one example when sps_nn_ilf_enabled_flag is not present, it is inferred to be equal to 0.

As described above, in one example, a flag may be signaled in a PPS specifying if an NN ILF is enabled. That is in one example, according to the techniques herein, the relevant portion of a PPS syntax structure may be as provided in Table 19.

TABLE 19

| | |
|---|---|
| pic_parameter_set_rbsp( ) { | |
| ... | |
| pps_nn_ilf_present_flag | u(1) |
| ... | |
| } | |

With respect to Table 19, in one example, the semantics may be based on following:

pps_nn_ilf_present_flag equal to 1 specifies that ILF neural network related parameters are present in slice headers and/or picture headers referring to the PPS. pps_nn_ilf_present_flag equal to 1 specifies that ILF neural network related parameters are not present in slice headers and/or picture headers referring to the PPS. In one example when pps_nn_ilf_present_flag is not present, it is inferred to be equal to 0.

As described above, in one example, a flag may be signaled in an PPS specifying if an NN ILF information is present. That is in one example, according to the techniques herein, the relevant portion of an PPS syntax structure may be as provided in Table 20.

TABLE 20

| | |
|---|---|
| pic_parameter_set_rbsp( ) { | |
| ... | |
| pps_nn_ilf_info_in_ph_flag | u(1) |
| ... | |
| } | |

With respect to Table 20, in one example, the semantics may be based on following:

pps_nn_ilf_info_in_ph_flag equal to 1 specifies that neural network ILF parameters information could be present in the PH syntax structure and not present in slice headers referring to the PPS that do not contain a PH syntax structure. pps_nn_ilf_info_in_ph_flag equal to 0 specifies that ILF neural network parameters information is not present in the PH syntax structure and could be present in slice headers referring to the PPS.

In one example, when not present, the value of pps_nn_ilf_info_in_ph_flag is inferred to be equal to 0.

As described above, in one example, one or more NN ILF APS IDs may be signaled in picture header. That is in one example, according to the techniques herein, the relevant portion of a PH syntax structure may be as provided in Table 21.

TABLE 21

| | Descriptor |
|---|---|
| picture_header_structure( ) { | |
| ... | |
| if( sps_nn_ilf_enabled_flag && | |
| pps_nn_ilf_info_in_ph_flag ) | |
| ph_nn_ilf_aps_id | u(3) |
| ... | |
| } | |

With respect to Table 21, in one example, the semantics may be based on following:

ph_nn_ilf_aps_id specifies the aps_adaptation_parameter_set_id of the neural network (NN) ILF APS that the slices in the current picture refers to.

As described above, in one example, one or more NN ILF APS IDs may be signaled in a slice header. That is, in one example, according to the techniques herein, the relevant portion of an SH syntax structure may be as provided in Table 22.

TABLE 22

| | Descriptor |
|---|---|
| slice_header_structure( ) { | |
| ... | |
| if( sps_nn_enabled_flag && | |
| !pps_nn_ilf_info_in_ph_flag ) | |
| sh_nn_ilf_aps_id | u(3) |
| ... | |
| } | |

With respect to Table 22, in one example, the semantics may be based on following:

sh_nn_ilf_aps_id specifies the aps_adaptation_parameter_set_id of the neural network (NN) ILF APS that the slice refers to.

As described above, in one example a flag may be signaled in a SPS specifying if an NN ILF is enabled, a PH level flag may indicate whether an NN ILF is enabled and whether a corresponding APS ID is signaled in the PH, a SH level flag may indicate whether an NN ILF is enabled. That is, in one example, according to the techniques herein, the relevant portion of PH and SH syntax structures may be as provided in Table 23 and Table 24.

TABLE 23

| | Descriptor |
|---|---|
| picture_header_structure( ) { | |
| ... | |
| if( sps_nn_ilf_enabled_flag) { | |
| ph_nn_ilf_enabled_flag | u(1) |
| if(ph_nn_ilf_enabled_flag) | |
| ph_nn_ilf_aps_id | u(3) |
| } | |
| ... | |
| } | |

TABLE 24

| | Descriptor |
|---|---|
| slice_header_structure( ) { | |
| ... | |
| if( ph_nn_ilf_enabled_flag ) | |
| sh_nn_ilf_enabled_flag | u(1) |
| ... | |
| } | |

With respect to Table 23 and Table 24, in one example, the semantics may be based on following:

ph_nn_ilf_enabled_flag equal to 1 specifies that the neural network ILF tools are enabled for the current picture. ph_nn_ilf_enabled_flag equal to 0 specifies that the neural network ILF tools are disabled for the picture.
ph_nn_ilf_aps_id specifies the aps_adaptation_parameter_set_id of the neural network (NN) ILF APS that the slices in the current picture refers to.
sh_nn_ilf_enabled_flag equal to 1 specifies that the neural network ILF tools are used when decoding the current slice. In this case, the ph_nn_ilf_aps_id is used by the current slice for neural network parameters. sh_nn_ilf_enabled_flag equal to 0 specifies that the neural network tools are not used when decoding the current slice.
In one example when not present, the value of sh_nn_ilf_enabled_flag is inferred to be equal to ph_nn_ilf_enabled_flag.

In one example a flag may be signaled in a SPS specifying if an NN ILF is enabled, a PH level flag may indicate whether an NN ILF is enabled and a SH level flag may indicate whether an NN ILF is enabled and whether a corresponding APS ID is signaled in the SH. That is, in one example, according to the techniques herein, the relevant portion of PH and SH syntax structures may be as provided in Table 25 and Table 26.

TABLE 25

| | Descriptor |
|---|---|
| picture_header_structure( ) { | |
| ... | |
| if( sps_nn_ilf_enabled_flag) | |
| ph_nn_ilf_enabled_flag | u(1) |
| ... | |
| } | |

TABLE 26

| | Descriptor |
|---|---|
| slice_header_structure( ) { | |
| ... | |
| if( ph_nn_ilf_enabled_flag ) { | |
| sh_nn_ilf_enabled_flag | u(1) |
| if(sh_nn_ilf_enabled_flag) | |
| sh_nn_ilf_aps_id | u(3) |
| ... | |
| } | |

With respect to Table 25 and Table 26, in one example, the semantics may be based on following:

ph_nn_ilf_enabled_flag equal to 1 specifies that the neural network ILF tools are enabled for the current picture. ph_nn_ilf_enabled_flag equal to 0 specifies that the neural network ILF tools are disabled for the picture.
sh_nn_ilf_enabled_flag equal to 1 specifies that the neural network ILF tools are used when decoding the current slice. In this case, the ph_nn_ilf_aps_id is used by the current slice for neural network parameters. sh_nn_ilf_enabled_flag equal to 0 specifies that the neural network ILF tools are not used when decoding the current slice. In one example when not present, the value of sh_nn_ilf_enabled_flag is inferred to be equal to ph_nn_ilf_enabled_flag.
sh_nn_ilf_aps_id specifies the aps_adaptation_parameter_set_id of the neural network (NN) ILF APS that the current slice refers to.

It should be noted that, in one example, the syntax provided in Table 25 and 26 may be repeated as needed for any number of types of APS parameters, including, for example, additional types of neural network parameters.

In one example, according to the techniques herein, a separate override flag may be signaled in slice header to override the NN APS signaled in picture header. That is, in one example, according to the techniques herein, the relevant portion of a PH syntax structure may be as provided, for example, in Table 23 and the relevant portion of a SH syntax structure may be as provided in Table 27.

TABLE 27

| | Descriptor |
|---|---|
| slice_header_structure( ) { | |
| ... | |
| if( ph_nn_ilf_enabled_flag ) { | |
| sh_nn_ilf_enabled_flag | u(1) |
| if(sh_nn_ilf_enabled_flag) | |
| sh_nn_ilf_override_flag | u(1) |
| if(sh_nn_ilf_override_flag) | |
| sh_nn_ilf_aps_id | u(3) |
| } | |
| ... | |
| } | |

With respect to Table 27, in one example, the semantics may be based on the semantics provided above and on the following:

sh_nn_ilf_enabled_flag equal to 1 specifies that the neural network ILF tools are used when decoding the current slice. sh_nn_ilf_enabled_flag equal to 0 specifies that the neural network ILF tools are not used when decoding the current slice. In one example when not present, the value of sh_nn_ilf_enabled_flag is inferred to be equal to ph_nn_ilf_enabled_flag.
sh_nn_ilf_override_flag equal to 1 specifies that the neural network ILF tools are used when decoding the current slice and the NN ILF APS ID used for the slice is signaled in sh_nn_ilf_aps_id. sh_nn_ilf_override_flag equal to 0 specifies that the neural network ILF tools are used when decoding the current slice and the NN ILF APS ID used for the slice is signaled in ph_nn_ilf_aps_id.
In one example when not present, the value of sh_nn_ilf_override_flag is inferred to be equal to 0.
sh_nn_ilf_aps_id specifies the aps_adaptation_parameter_set_id of the neural network (NN) ILF APS that the current slice refers to. When not present and when sh_nn_ilf_enabled_flag is equal to 1, sh_nn_ilf_aps_id is inferred to be equal to ph_nn_ilf_aps_id.

It should be noted that, in one example, the syntax provided in Table 23 and 27 may be repeated as needed for any number of types of APS parameters, including, for example, additional types of neural network parameters.

In one example, according to the techniques herein, multiple NN ILF APS IDs may be signaled in a picture header. That is, in Table 21 and Table 23, syntax element ph_nn_ilf_aps_id specifying a single aps_adaptation_parameter_set_id may be replaced with the following syntax in Table 28:

TABLE 28

| | |
|---|---|
| ph_num_nn_ilf_aps_ids_minus1 | ue(v) |
| for(i=0; i<=ph_num_nn_ilf_aps_ids_minus1; i++) | |
| ph_nn_ilf_aps_id[ i ] | u(3) |

With respect to Table 28, in one example, the semantics may be based on the following:

ph_num_nn_ilf_aps_ids_minus1 plus 1 specifies the number of NN ILF APS identifiers signaled.
ph_nn_ilf_aps_id[i] specifies the aps_adaptation_parameter_set_id of the i-th neural network (NN) ILF APS that the current picture refers to.

In one example, according to the techniques herein, multiple NN ILF APS IDs may be signaled in a slice header. That is, in Table 22, Table 26, and Table 27, syntax element sh_nn_ilf_aps_id specifying a single aps_adaptation_parameter_set_id may be replaced with the following syntax in Table 29:

TABLE 29

| | |
|---|---|
| sh_num_nn_ilf_aps_ids_minus1 | ue(v) |
| for(i=0; i<=sh_num_nn_ilf_aps_ids_minus1; i++) | |
| sh_nn_ilf_aps_id[ i ] | u(3) |

With respect to Table 29, in one example, the semantics may be based on the following:

sh_num_nn_ilf_aps_ids_minus1 plus 1 specifies the number of NN ILF APS identifiers signaled. In one example, when not present sh_num_nn_ilf_aps_ids_minus1 is inferred to be equal to ph_num_nn_ilf_aps_ids_minus1.
sh_nn_ilf_aps_id[i] specifies the aps_adaptation_parameter_set_id of the i-th neural network (NN) ILF APS that the current slice refers to.
In one example, when not present sh_nn_ilf_aps_id[i] is inferred to be equal to ph_nn_ilf_aps_id[i].

In example, in the case where multiple NN APS identifiers are signaled in a PH or SH, each CTU NN APS tool may be turned on or off at the CTU level and if turned on, an index into the list of NN APS identifiers signaled in PH or SH may be signaled. In one example, this may be signaled as shown in Table 30.

TABLE 30

| | |
|---|---|
| coding_tree_unit( ) { | |
| ... | |
| xCtb = CtbAddrX << CtbLog2SizeY | |
| yCtb = CtbAddrY << CtbLog2SizeY | |
| ... | |
| if(sh_nn_ilf_enabled_flag ){ | |
| ilf_ctb_flag[ CtbAddrX ][ CtbAddrY ] | ae(v) |
| if( ilf_ctb_flag[ CtbAddrX ][ CtbAddrY ] ) | |
| if(sh_num_nn_ilf_aps_ids_minus1> 0 ) | |
| ilf_filter_idx | ae(v) |
| } | |
| ... | |
| } | |

With respect to Table 30, in one example, the semantics may be based on the following:

ilf_ctb_flag[xCtb>>CtbLog2SizeY][yCtb>>CtbLog2SizeY] equal to 1 specifies that the NN ILF is applied to the coding tree block of the coding tree unit at location (xCtb, yCtb). ilf_ctb_flag [xCtb>>CtbLog2SizeY][yCtb>>CtbLog2SizeY] equal to 0 specifies that the NN ILF is not applied to the coding tree block of the coding tree unit at location (xCtb, yCtb).
When ilf_ctb_flag[xCtb>>CtbLog2SizeY][yCtb>>CtbLog2SizeY] is not present, it is inferred to be equal to 0.
ilf_filter_idx specifies the index in the APS ID list in the slice header of this CTU, identifying the NN ILF APS that is used for the NN ILF for this CTB. The value of ilf_filter_idx shall be in a range of 0 to sh_num_nn_ilf_aps_ids_minus1, inclusive. When ilf_filter_idx is not present, it is inferred to be equal to 0.

The above example uses a single flag (ilf_ctb_flag[CtbAddrX][CtbAddrY]) for luma and chroma. In another example separate flags may be used at CTU level for luma and two chroma components to turn on or ILF for them individually.

It should be noted that, in one example, the syntax provided in Table 28, Table 29, and Table 30 may be repeated as needed for any number of types of APS parameters, including, for example, additional types of neural network parameters.

Table 31 illustrates another example of neural_network_super_resolution_data( ) according to the techniques herein. In this example, multiple neural network super resolution filters are specified. For each specified neural network filter, a list of upsampling ratios is specified. The list indicates different upsampling ratios associated with the specific neural network super resolution filter. A decoder receiving neural_network_super_resolution_data( ) may select and implement a filtering process corresponding to a specified filter based on an upsampling ratio associated with a specified filter. That is, a decoder may determine an upsampling ratio for a particular use case and implement an associated filter process, i.e, based on the determined upsampling ratio the appropriate neural network super resolution filter may be selected and implemented based on the information in neural_network_super_resolution_data( ) structure. In one example, a decoder can determine an upsampling ratio based on the resolution of the current picture or current block compared to the resolution of the reference picture or reference block. In another example, a decoder may determine an upsampling ratio depending upon desired output resolution and current picture resolution. It should be noted that determining an upsampling ratio may include determining a closest match of a desired upsampling ratio for a use case to an upsampling filter associated with a specific neural network super resolution filter (e.g., match 1.75 to 2.0).

TABLE 31

| | Descriptor |
|---|---|
| neural_network_super_resolution_data( ) { | |
| num_sr_filters_minus1 | ue(v) |
| for(m=0; m<=num_sr_filters_minus1;m++){ | |
| num_upsampling_ratios_minus1[m] | ue(v) |
| for(i=0; i<=num_upsampling_ratios_minus1[m];i++) | |
| upsampling_ratio[m][i] | u(32) |
| num_nn_layers[m] | ue(v) |
| for(i=0; i<num_nn_layers[m];i++){ | |
| num_nodes_in_layer[m][i] | ue(v) |
| num_dims_in_layer[m][i] | ue(v) |
| For( j=0; j<num_dims_in_layer[m][i]; j++){ | |
| dim_in_layer[m][j][i] | ue(v) |
| } | |
| num_biases_for_nodes_layer[m][i] | ue(v) |
| activation_function[m][i] | u(3) |
| } | |
| for(k=0; k<num_nn_layers[m]−1;k++){ | |
| for(i=0; i< num_nodes_in_layer[m][k];i++){ | |
| for(j=0; j< num_nodes_in_layer[m][k+1];j++){ | |
| neural_weight[m][k][i][j] | ue(v) |
| } | |
| } | |
| } | |
| } | |
| } | |

With respect to Table 31, in one example, the semantics may be based on following:

num_sr_filters_minus1 specifies the number of super resolution filters specified in this data structure.
num_upsamplings_ratios_minus1[m] specifies the number of upsampling ratios signalled for the m-th super resolution filter.
upsampling_ratio[m][i] specifies the i-th upsampling ratio as a 16.16 fixed-point number that can utilize the signalled information for the m-th super resolution filter. In another example u(v) coded syntax element could be signalled for upsampling_ratio[m][i], with various values corresponding to supported upsampling ratios listed in a lookup table.
num_nn_layers[m] specifies the number of layers, including input layer, output layer and hidden layers in the super resolution neural network for the m-th super resolution filter.
num_nodes_in_layer[m][i] specifies the number of nodes (or neurons) in the i-th layer for the m-th super resolution filter. In one example, num_nodes_in_layer[m][i] shall be greater than 0.
num_dims_in_layer[m][i] specifies the number of dimensions in the i-th layer for the m-th super resolution filter. In one example, num_dims_in_layer[m][i] shall be greater than 0.
dim_in_layer[m][j][i] specifies the j-th dimension of the i-th layer for the m-th super resolution filter. In one example, the value of dim_in_layer[num_dims_in_layer[m][i]-1][i] is not signaled and instead inferred to be equal to the num_nodes_in_layer[m][i] divided by the product of the received values of dim_in_layer[m][j][i] for the i-th layer for the m-th super resolution filter.
num_biases_for_nodes_in_layer[m][i] specifies the bias used by nodes in the i-th layer for the m-th super resolution filter.
activation_function[m][i] specifies the type of activation function used by the i-th layer for the m-th super resolution filter. In one example, the value activation_function[m][i] defines the type of activation function used as shown in Table 32.
neural_weight[m][k][i][j] specifies the weight connecting i-th neuron of k-th layer with j-th neuron of (k+1) th layer for the m-th super resolution filter.

TABLE 32

| activation_function[m][i] | Type of activation function |
|---|---|
| 0 | Rectified Linear Unit (ReLU) |
| 1 | Sigmoid function |
| 3 | Leaky ReLU function |
| 4-7 | Reserved |

As described above, in JVET-T2001, an APS applies to zero or more slices. Further, in JVET-T2001, in some cases, a SPS and/or PPS level flag indicates whether a tool (e.g., ALF) having parameters in an APS is enabled and a corresponding APS ID is signaled in the PH and in some cases in the slice header.

Signaling of NN parameters presence/enabled control flag in SPS and/or PPS. One or more control flags may be signaled in an SPS and/or in an PPS to indicate if NN APS and/or NN parameters are present in the bitstream. In one example, a flag may be signaled in an SPS specifying if NN APS and/or NN parameters are present/enabled in the bitstream. In one example, a flag may be signaled in a PPS specifying if NN APS and/or NN parameters are present/enabled in the picture header and/or slice header referring to this PPS. In one example, a flag may be signaled in an SPS indicating of signaling of NN APS parameter set ID in picture header and/or slice header. When one or more slices of a coded picture use the NN parameters, one or more NN APS IDs may be signaled in picture header and/or slice header. In one example, one or more NN APS ID may be signaled only in a picture header or in a slice header (but not both). In one example, whether the picture header or the slice header includes NN APS ID(s) may be specified by signaling a flag in a PPS. In one example, one or more NN APS ID(s) may be signaled in picture header to enable a NN tool for the picture and then if enabled, each slice header in the picture may signal a flag to turn the use of NN tool on or off.

In one example, some of the slice header data signaled for NN SR filter information may be signaled in the ph_extra_bit[i] and/or in ph_extension_data_byte[i]. In one example some of the slice header data signaled for NN SR filter information may be signaled in the sh_extra_bit[i] and/or in sh_slice_header_extension_data_byte[i].

In an example, when NN SR filter is used, deblocking filter may be disabled. In one example an inference may be used to set one or more deblocking filter related syntax elements to “disabled” or “off” state when NN SR filter is enabled. In another example, it may be a requirement of bitstream conformance that when NN SR filter is enabled, the deblocking filter is disabled. In another example, it may be a requirement of bitstream conformance that when deblocking filter is enabled, the NN SR is disabled. In one example, on a picture by picture basis or slice by slice basis or CTU by CTU basis, one of NN SR filter or deblocking filter may be enabled.

As described above, in one example, a flag may be signaled in a SPS specifying if an NN SR is enabled. That is, in one example, according to the techniques herein, the relevant portion of an SPS syntax structure may be as provided in Table 33.

TABLE 33

| | |
|---|---|
| seq_parameter_set_rbsp( ) { | |
| ... | |
| sps_nn_sr_enabled_flag | u(1) |
| ... | |
| } | |

With respect to Table 33, in one example, the semantics may be based on following:

sps_nn_sr_enabled_flag equal to 1 specifies that the super-resolution neural network tools are enabled for the CLVS. sps_nn_sr_enabled_flag equal to 0 specifies that the neural network tools are disabled for the CLVS.
In one example when sps_nn_sr_enabled_flag is not present, it is inferred to be equal to 0.

As described above, in one example, a flag may be signaled in a PPS specifying if an NN SR is enabled. That is, in one example, according to the techniques herein, the relevant portion of an PPS syntax structure may be as provided in Table 34.

TABLE 34

| | |
|---|---|
| pic_parameter_set_rbsp( ) { | |
| ... | |
| pps_nn_sr_present_flag | u(1) |
| ... | |
| } | |

With respect to Table 34, in one example, the semantics may be based on following:

pps_nn_sr_present_flag equal to 1 specifies that SR neural network related parameters are present in slice headers and/or picture headers referring to the PPS. pps_nn_sr_present_flag equal to 1 specifies that SR neural network related parameters are not present in slice headers and/or picture headers referring to the PPS.
In one example when pps_nn_sr_present_flag is not present, it is inferred to be equal to 0.

As described above, in one example, a flag may be signaled in an PPS specifying if an NN SR information is present. In one example, according to the techniques herein, the relevant portion of an PPS syntax structure may be as provided in Table 35.

TABLE 35

| | |
|---|---|
| pic_parameter_set_rbsp( ) { | |
| ... | |
| pps_nn_sr_info_in_ph_flag | u(1) |
| ... | |
| } | |

With respect to Table 35, in one example, the semantics may be based on following:

pps_nn_sr_info_in_ph_flag equal to 1 specifies that neural network super resolution parameters information could be present in the PH syntax structure and not present in slice headers referring to the PPS that do not contain a PH syntax structure. pps_nn_sr_info_in_ph_flag equal to 0 specifies that neural network parameters information is not present in the PH syntax structure and could be present in slice headers referring to the PPS.
In one example, when not present, the value of pps_nn_sr_info_in_ph_flag is inferred to be equal to 0.

As described above, in one example, one or more NN SR APS IDs may be signaled in picture header. That is, in one example, according to the techniques herein, the relevant portion of an PH syntax structure may be as provided in Table 36.

TABLE 36

| | Descriptor |
|---|---|
| picture_header_structure( ) { | |
| ... | |
| if( sps_nn_sr_enabled_flag && | |
| pps_nn_sr_info_in_ph_flag ) | |
| ph_nn_sr_aps_id | u(3) |
| ... | |
| } | |

With respect to Table 36, in one example, the semantics may be based on following:

ph_nn_sr_aps_id specifies the aps_adaptation_parameter_set_id of the neural network (NN) SR APS that the slices in the current picture refers to.

As described above, in one example, one or more NN SR APS IDs may be signaled in a slice header. That is, in one example, according to the techniques herein, the relevant portion of an SH syntax structure may be as provided in Table 37.

TABLE 37

| | Descriptor |
|---|---|
| slice_header_structure( ) { | |
| ... | |
| if( sps_nn_enabled_flag && | |
| !pps_nn_sr_info_in_ph_flag ) | |
| sh_nn_sr_aps_id | u(3) |
| ... | |
| } | |

With respect to Table 37, in one example, the semantics may be based on following:

sh_nn_sr_aps_id specifies the aps_adaptation_parameter_set_id of the neural network (NN) SR APS that the slice refers to.

As described above, in one example a flag may be signaled in a SPS specifying if an NN SR is enabled, a PH level flag may indicate whether an NN SR is enabled and whether a corresponding APS ID is signaled in the PH, a SH level flag may indicate whether an NN SR is enabled. That is, in one example, according to the techniques herein, the relevant portion of PH and SH syntax structures may be as provided in Table 38 and Table 39.

TABLE 38

| | Descriptor |
|---|---|
| picture_header_structure( ) { | |
| ... | |
| if( sps_nn_sr_enabled_flag) { | |
| ph_nn_sr_enabled_flag | u(1) |
| if(ph_nn_sr_enabled_flag) | |
| ph_nn_sr_aps_id | u(3) |
| } | |
| ... | |
| } | |

TABLE 39

| | Descriptor |
|---|---|
| slice_header_structure( ) { | |
| ... | |
| if( ph_nn_sr_enabled_flag ) | |
| sh_nn_sr_enabled_flag | u(1) |
| ... | |
| } | |

With respect to Table 38 and Table 39, in one example, the semantics may be based on following:

ph_nn_sr_enabled_flag equal to 1 specifies that the neural network SR tools are enabled for the current picture. ph_nn_sr_enabled_flag equal to 0 specifies that the neural network SR tools are disabled for the picture.
ph_nn_sr_aps_id specifies the aps_adaptation_parameter_set_id of the neural network (NN) SR APS that the slices in the current picture refers to.
sh_nn_sr_enabled_flag equal to 1 specifies that the neural network SR tools are used when decoding the current slice. In this case, the ph_nn_sr_aps_id is used by the current slice for neural network parameters. sh_nn_sr_enabled_flag equal to 0 specifies that the neural network tools SR are not used when decoding the current slice.
In one example, when not present, the value of sh_nn_sr_enabled_flag is inferred to be equal to ph_nn_sr_enabled_flag.

In one example a flag may be signaled in a SPS specifying if an NN SR is enabled, a PH level flag may indicate whether an NN SR is enabled and a SH level flag may indicate whether an NN SR is enabled and whether a corresponding APS ID is signaled in the SH. That is, in one example, according to the techniques herein, the relevant portion of PH and SH syntax structures may be as provided in Table 40 and Table 41.

TABLE 40

| | Descriptor |
|---|---|
| picture_header_structure( ) { | |
| ... | |
| if( sps_nn_sr_enabled_flag) | |
| ph_nn_sr_enabled_flag | u(1) |
| ... | |
| } | |

TABLE 41

| | Descriptor |
|---|---|
| slice_header_structure( ) { | |
| ... | |
| if( ph_nn_sr_enabled_flag ) { | |
| sh_nn_sr_enabled_flag | u(1) |
| if(sh_nn_sr_enabled_flag) | |
| sh_nn_sr_aps_id | u(3) |
| ... | |
| } | |

With respect to Table 40 and Table 41, in one example, the semantics may be based on following:

ph_nn_sr_enabled_flag equal to 1 specifies that the neural network SR tools are enabled for the current picture. ph_nn_sr_enabled_flag equal to 0 specifies that the neural network SR tools are disabled for the picture.
sh_nn_sr_enabled_flag equal to 1 specifies that the neural network SR tools are used when decoding the current slice. sh_nn_sr_enabled_flag equal to 0 specifies that the neural network SR tools are not used when decoding the current slice. In one example when not present, the value of sh_nn_sr_enabled_flag is inferred to be equal to ph_nn_sr_enabled_flag.
sh_nn_sr_aps_id specifies the aps_adaptation_parameter_set_id of the neural network (NN) SR APS that the current slice refers to.

It should be noted that, in one example, the syntax provided in Table 40 and 41 may be repeated as needed for any number of types of APS parameters, including, for example, additional types of neural network parameters.

In one example, according to the techniques herein, a separate override flag may be signaled in slice header to override the NN APS signaled in picture header. That is, in one example, according to the techniques herein, the relevant portion of a PH syntax structure may be as provided, for example, in Table 38 and the relevant portion of a SH syntax structure may be as provided in Table 42.

TABLE 42

| | Descriptor |
|---|---|
| slice_header_structure( ) { | |
| ... | |
| if( ph_nn_sr_enabled_flag ) { | |
| sh_nn_sr_enabled_flag | u(1) |
| if(sh_nn_sr_enabled_flag) | |
| sh_nn_sr_override_flag | u(1) |
| if(sh_nn_sr_override_flag) | |
| sh_nn_sr_aps_id | u(3) |
| } | |
| ... | |
| } | |

With respect to Table 42, in one example, the semantics may be based on the semantics provided above and on the following:

sh_nn_sr_enabled_flag equal to 1 specifies that the neural network SR tools are used when decoding the current slice. sh_nn_sr_enabled_flag equal to 0 specifies that the neural network SR tools are not used when decoding the current slice. In one example when not present, the value of sh_nn_sr_enabled_flag is inferred to be equal to ph_nn_sr_enabled_flag.
sh_nn_sr_override_flag equal to 1 specifies that the neural network SR tools are used when decoding the current slice and the NN SR APS ID used for the slice is signaled in sh_nn_sr_aps_id. sh_nn_sr_override_flag equal to 0 specifies that the neural network SR tools are used when decoding the current slice and the NN SR APS ID used for the slice is signaled in ph_nn_sr_aps_id. In one example when not present, the value of sh_nn_sr_override_flag is inferred to be equal to 0.
sh_nn_sr_aps_id specifies the aps_adaptation_parameter_set_id of the neural network (NN) SR APS that the current slice refers to. When not present and when sh_nn_sr_enabled_flag is equal to 1, sh_nn_sr_aps_id is inferred to be equal to ph_nn_sr_aps_id.

It should be noted that, in one example, the syntax provided in Table 38 and 42 may be repeated as needed for any number of types of APS parameters, including, for example, additional types of neural network parameters.

In one example, according to the techniques herein, multiple NN SR APS IDs may be signaled in a picture header. That is, in Table 36 and Table 38, syntax element ph_nn_sr_aps_id specifying a single aps_adaptation_parameter_set_id may be replaced with the following syntax in Table 43:

TABLE 43

| | |
|---|---|
| ph_num_nn_sr_aps_ids_minus1 | ue(v) |
| for(i=0; i<=ph_num_nn_sr_aps_ids_minus1; i++) | |
| ph_nn_sr_aps_id[ i ] | u(3) |

With respect to Table 43, in one example, the semantics may be based on the following:

ph_num_sr_nn_aps_ids_minus1 plus 1 specifies the number of NN SR APS identifiers signaled.
ph_nn_sr_aps_id[i] specifies the aps_adaptation_parameter_set_id of the i-th neural network (NN) SR APS that the current picture refers to.

In one example, according to the techniques herein, multiple NN APS IDs may be signaled in a slice header. That is, in Table 37, Table 41, and Table 42, syntax element sh_nn_sr_aps_id specifying a single aps_adaptation_parameter_set_id may be replaced with the following syntax in Table 44:

TABLE 44

| | |
|---|---|
| sh_num_nn_sr_aps_ids_minus1 | ue(v) |
| for(i=0; i<=sh_num_nn_sr_aps_ids_minus1; i++) | |
| sh_nn_sr_aps_id[ i ] | u(3) |

With respect to Table 44, in one example, the semantics may be based on the following:

sh_num_nn_sr_aps_ids_minus1 plus 1 specifies the number of NN SR APS identifiers signaled. In one example, when not present sh_num_nn_sr_aps_ids_minus1 is inferred to be equal to ph_num_nn_sr_aps_ids_minus1.
sh_nn_sr_aps_id[i] specifies the aps_adaptation_parameter_set_id of the i-th neural network (NN) SR APS that the current picture refers to.
In one example, when not present sh_nn_sr_aps_id[i] is inferred to be equal to ph_nn_sr_aps_id[i].

In example, in the case where multiple NN APS identifiers are signaled in a PH or SH, each CTU NN APS tool may be turned on or off at the CTU level and if turned on, an index into the list of NN APS identifiers signaled in PH or SH may be signaled. In one example, this may be signaled as shown in Table 45.

TABLE 45

| | |
|---|---|
| coding_tree_unit( ) { | |
| ... | |
| xCtb = CtbAddrX << CtbLog2SizeY | |
| yCtb = CtbAddrY << CtbLog2SizeY | |
| ... | |
| if(sh_nn_sr_enabled_flag ){ | |
| sr_ctb_flag[ CtbAddrX ][ CtbAddrY ] | ae(v) |
| if( sr_ctb_flag[ CtbAddrX ][ CtbAddrY ] ) | |
| if(sh_num_nn_sr_aps_ids_minus1> 0 ) | |
| sr_filter_idx | ae(v) |
| } | |
| ... | |
| } | |

With respect to Table 45, in one example, the semantics may be based on the following:

sr_ctb_flag[xCtb>>CtbLog2SizeY][yCtb>>CtbLog2SizeY] equal to 1 specifies that the NN SR is applied to the coding tree block of the coding tree unit at location (xCtb, yCtb). sr_ctb_flag [xCtb>>CtbLog2SizeY][yCtb>>CtbLog2SizeY] equal to 0 specifies that the NN SR is not applied to the coding tree block of the coding tree unit at location (xCtb, yCtb).
When sr_ctb_flag[xCtb>>CtbLog2SizeY][yCtb>>CtbLog2SizeY] is not present, it is inferred to be equal to 0.
sr_filter_idx specifies the index in the APS ID list in the slice header of this CTU, identifying the NN SR APS that is used for the NN SR for this CTB. The value of sr_filter_idx shall be in a range of 0 to sh_num_nn_sr_aps_ids_minus1, inclusive. When sr_filter_idx is not present, it is inferred to be equal to 0.

The above example uses a single flag (sr_ctb_flag[CtbAddrX][CtbAddrY]) for luma and chroma. In another example, separate flags may be used at the CTU level for luma and two chroma components to turn on or SR for them individually.

It should be noted that, in one example, the syntax provided in Table 43, Table 44, and Table 45 may be repeated as needed for any number of types of APS parameters, including, for example, additional types of neural network parameters.

As described above, super resolution filtering can be done inside the coding loop utilizing the RPR mechanism in JVET-T2001. As described above, in JVET-T2001, the full-pel location is used to fetch the reference block patch from the reference picture and the fractional-pel location is used to select the proper interpolation filter. In particular, JVET-T2001 provides where a selected reference picture sample array, refPicLX, is input into a defined fractional sample interpolation filtering process. Thus, in one example, according to the techniques herein, a reference picture sample array may be input into a NN SR filter process, the NN SR filter process may be performed according to parameters received in an APS, and the modified reference picture sample array may be input into the fractional sample interpolation filtering process.

JVET-T2001 further provides where an array of predicted sample values, predSampleLX, is output from the defined fractional sample interpolation filtering process. Thus, in one example, according to the techniques herein, an array of predicted sample values may be input into a NN SR filter process, the NN SR filter process may be performed according to parameters received in an APS, and the modified array of predicted sample values may be used as the prediction.

JVET-T2001 further provides tables including defined interpolation filter coefficients for each fractional sample position. Thus, in one example, according to the techniques herein, the defined interpolation filter coefficients may be input into a NN SR filter process, the NN SR filtering process may be performed according to parameters received in an APS, and the modified interpolation filter coefficients may be used as part of an interpolation process to generate the prediction.

It should be noted that the above steps may be performed on luma and/or on the chroma blocks or samples.

In this manner, video encoder 500 represents an example of a device configured to signal one or more syntax elements providing neural network in-loop filter information in an adaptation parameter set syntax structure.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Data decapsulator 123 may be configured to receive and parse any of the example syntax structures described herein.

Video decoder 124 may include any device configured to receive a bitstream (e.g., a sub-bitstream extraction) and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

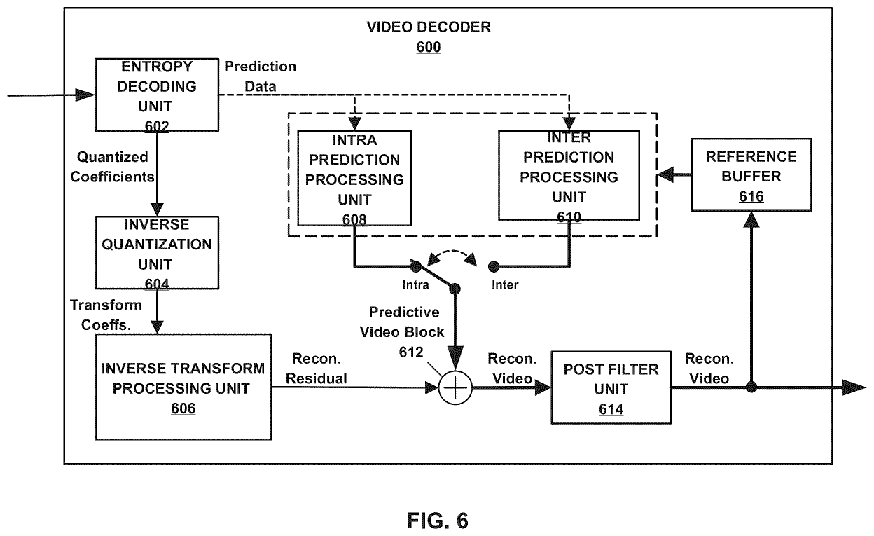

FIG. 6 is a block diagram illustrating an example of a video decoder that may be configured to decode video data according to one or more techniques of this disclosure (e.g., the decoding process for reference-picture list construction described above). In one example, video decoder 600 may be configured to decode transform data and reconstruct residual data from transform coefficients based on decoded transform data. Video decoder 600 may be configured to perform intra prediction decoding and inter prediction decoding and, as such, may be referred to as a hybrid decoder. Video decoder 600 may be configured to parse any combination of the syntax elements described above in Tables 1-45. Video decoder 600 may decode a picture based on or according to the processes described above, and further based on parsed values in Tables 1-45.

In the example illustrated in FIG. 6, video decoder 600 includes an entropy decoding unit 602, inverse quantization unit 604, inverse transform coefficient processing unit 606, intra prediction processing unit 608, inter prediction processing unit 610, summer 612, post filter unit 614, and reference buffer 616. Video decoder 600 may be configured to decode video data in a manner consistent with a video coding system. It should be noted that although example video decoder 600 is illustrated as having distinct functional blocks, such an illustration is for descriptive purposes and does not limit video decoder 600 and/or sub-components thereof to a particular hardware or software architecture. Functions of video decoder 600 may be realized using any combination of hardware, firmware, and/or software implementations.

As illustrated in FIG. 6, entropy decoding unit 602 receives an entropy encoded bitstream. Entropy decoding unit 602 may be configured to decode syntax elements and quantized coefficients from the bitstream according to a process reciprocal to an entropy encoding process. Entropy decoding unit 602 may be configured to perform entropy decoding according any of the entropy coding techniques described above. Entropy decoding unit 602 may determine values for syntax elements in an encoded bitstream in a manner consistent with a video coding standard. As illustrated in FIG. 6, entropy decoding unit 602 may determine a quantization parameter, quantized coefficient values, transform data, and prediction data from a bitstream. In the example, illustrated in FIG. 6, inverse quantization unit 604 and inverse transform coefficient processing unit 606 receive quantized coefficient values from entropy decoding unit 602 and output reconstructed residual data.

Referring again to FIG. 6, reconstructed residual data may be provided to summer 612. Summer 612 may add reconstructed residual data to a predictive video block and generate reconstructed video data. A predictive video block may be determined according to a predictive video technique (i.e., intra prediction and inter frame prediction). Intra prediction processing unit 608 may be configured to receive intra prediction syntax elements and retrieve a predictive video block from reference buffer 616. Reference buffer 616 may include a memory device configured to store one or more frames of video data. Intra prediction syntax elements may identify an intra prediction mode, such as the intra prediction modes described above. Inter prediction processing unit 610 may receive inter prediction syntax elements and generate motion vectors to identify a prediction block in one or more reference frames stored in reference buffer 616. Inter prediction processing unit 610 may produce motion compensated blocks, possibly performing interpolation based on interpolation filters. Identifiers for interpolation filters to be used for motion estimation with sub-pixel precision may be included in the syntax elements. Inter prediction processing unit 610 may use interpolation filters to calculate interpolated values for sub-integer pixels of a reference block. Post filter unit 614 may be configured to perform filtering on reconstructed video data. For example, post filter unit 614 may be configured to perform deblocking and/or Sample Adaptive Offset (SAO) filtering, e.g., based on parameters specified in a bitstream. Further, it should be noted that in some examples, post filter unit 614 may be configured to perform proprietary discretionary filtering (e.g., visual enhancements, such as, mosquito noise reduction). As illustrated in FIG. 6, a reconstructed video block may be output by video decoder 600. In this manner, video decoder 600 represents an example of a device configured to receive an adaptation parameter set syntax structure, parse one or more syntax elements providing neural network in-loop filter information from the adaptation parameter set syntax structure, determine one or more neural network in-loop filter parameters based on the parsed syntax elements, and apply a neural network in-loop filter based on the determined neural network in-loop filter parameters.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

What is claimed is:

1. A method of applying a neural network in-loop filter to reconstructed video, the method comprising:
receiving a sequence parameter set;
parsing a first syntax element in the sequence parameter set specifying whether neural network in-loop filtering is enabled for a sequence;
receiving a picture header;
conditionally parsing a second syntax element in the picture header based on whether the first syntax element indicates that neural network in-loop filtering is enabled, wherein the second syntax element specifies an adaptation parameter set identifier of an adaptation parameter set specifying a neural network in-loop filter; and
applying a neural network in-loop filter corresponding to the adaptation parameter set identifier.

2. A device comprising one or more processors configured to:
receive a sequence parameter set;
parse a first syntax element in the sequence parameter set specifying whether neural network in-loop filtering is enabled for a sequence;
receive a picture header;
conditionally parse a second syntax element in the picture header based on whether the first syntax element indicates that neural network in-loop filtering is enabled, wherein the second syntax element specifies an adaptation parameter set identifier of an adaptation parameter set specifying a neural network in-loop filter; and
apply a neural network in-loop filter corresponding to the adaptation parameter set identifier.

3. The device of claim 2, wherein the device includes a video decoder.
